(19) United States
(12) Patent Application Publication
(10) Pub. No.: US 2025/0225478 A1
(43) Pub. Date: Jul. 10, 2025

(54) SYSTEM, METHOD, AND APPARATUS FOR SUPPLY CHAIN MANAGEMENT

(71) Applicant: ParkourSC, Inc., Santa Clara, CA (US)

(72) Inventors: Alok Bhanot, Hillsborough, CA (US); Munimohanreddy Pathakota, Cupertino, CA (US)

(21) Appl. No.: 19/089,627

(22) Filed: Mar. 25, 2025

Related U.S. Application Data
(63) Continuation of application No. PCT/US2023/075258, filed on Sep. 27, 2023.
Application No. PCT/US2023/075258 is a continuation of application No. 63/410,551, filed on Sep. 27, 2022.

(51) Int. Cl. G06Q 10/087; G06F 3/0482; G06F 3/0486; G06F 8/34; G06F 8/38; G06Q 10/067

(52) U.S. Cl. CPC G06Q 10/087; G06F 3/0482; G06F 3/0486; G06F 8/34; G06F 8/38; G06Q 10/067

(57) ABSTRACT

A device may include an interface manager configured to implement a build interface, and to build a visual model in response to user operations on the build interface. A device may include a supply chain model creation component configured to determine a supply chain model in response to the visual model. A device may include a supply chain model execution component configured to operate the supply chain model as a digital twin of at least a portion of a physical supply chain, to interpret at least one physical supply chain execution value, and to provide a notification to a user of the supply chain command platform in response to a comparison of the supply chain model and the at least one physical supply chain execution value.

### CROSS-REFERENCE TO RELATED APPLICATIONS

This application is a bypass continuation of International Application Serial No. PCT/US2023/075258, filed on 27 Sep. 2023, published as WO 2024/073505 on 4 Apr. 2024. International Application Serial No. PCT/US2023/075258 is related to, claims priority to, and incorporates herein by reference for all purposes U.S. Provisional Patent Application No. 63/410,551, filed on 27 Sep. 2022, and entitled “SYSTEM, METHOD, AND APPARATUS FOR SUPPLY CHAIN MANAGEMENT” (PARK-0007-P01).

### BACKGROUND

Supply chain management is critical to modern business practices. Supply chain management has been critical to a number of successes for the global economy over recent years, including increases to productivity, reduction of inventory, just in time inventory management, reductions in storage of goods and materials, improvements in return on capital investment, and the like. At the same time, a number of trends have made supply chain management more difficult and sensitive to disruption, for example with manufacturing and purchasing involving a number of countries within a given supply ecosystem, increased specialization and compartmentalization of competencies, increased complexity of manufacturing cycles between raw materials and finished products, and the like. These sensitivities have surfaced as disruptions affecting almost every supplier as seen in recent events. For example, referencing FIG. 52, a few recent disruptions are depicted, for example the Suez canal blockage, the 2008 recession, COVID-19, and other events. The example of FIG. 52 schematically depicts illustrative data demonstrating the severity of disruption events (top portion of FIG. 52) and the degradation (bottom portion of FIG. 52) of supply chain operations for a given disruptive event. In the modern business environment, a disruption anywhere has the potential to effect supply chains anywhere else in the world, or everywhere else in the world. Thus, the increased fine tuning and reliance on supply chain execution is meeting a more complex and disruptive environment.

### SUMMARY

In some aspects, the techniques described herein relate to a system, including: a supply chain command platform, including: an interface manager configured to implement a build interface, and to build a visual model in response to user operations on the build interface; a supply chain model creation component configured to determine a supply chain model in response to the visual model; and a supply chain model execution component configured to operate the supply chain model as a digital twin of at least a portion of a physical supply chain, to interpret at least one physical supply chain execution value, and to provide a notification to a user of the supply chain command platform in response to a comparison of the supply chain model and the at least one physical supply chain execution value.

In some aspects, the techniques described herein relate to a system, including: a supply chain command platform, including: an interface manager configured to implement a build interface, and to build a visual model in response to user operations on the build interface; a supply chain model creation component configured to determine a supply chain model in response to the visual model; and a supply chain model execution component configured to operate the supply chain model as a digital twin of at least a portion of a physical supply chain, to interpret at least one physical supply chain execution value, and to determine an off-nominal event value in response to a comparison of the supply chain model and the at least one physical supply chain execution value.

In some aspects, the techniques described herein relate to a system, including: a supply chain command platform, including: an interface manager configured to implement a build interface, and to build a visual model in response to user operations on the build interface; a supply chain model creation component configured to determine a supply chain model in response to the visual model; a supply chain model execution component configured to operate the supply chain model as a digital twin of at least a portion of a physical supply chain, to interpret at least one physical supply chain execution value, and to determine an off-nominal event value in response to a comparison of the supply chain model and the at least one physical supply chain execution value; and a supply chain management component configured to perform a supply chain response action in response to the off-nominal event value.

In some aspects, the techniques described herein relate to a system, including: a supply chain command platform, including: an interface manager configured to implement a build interface, and to build a visual model in response to user operations on the build interface; a supply chain model creation component configured to determine a supply chain model in response to the visual model; a supply chain model execution component configured to operate the supply chain model as a digital twin of at least a portion of a physical supply chain, to interpret at least one physical supply chain execution value, and to determine a supply chain performance value in response to a comparison of the supply chain model and the at least one physical supply chain execution value; wherein the interface manager is further configured to provide the supply chain performance value to at least one of the build interface or a user of the supply chain command platform, and to update the visual model in response to further user operations on the build interface; wherein the supply chain model creation component is further configured to update the supply chain model in response to the updated visual model; and wherein the supply chain model execution component is further configured to determine the supply chain performance value in response to a comparison of the updated supply chain model and the at least one physical supply chain execution value.

In some aspects, the techniques described herein relate to a system, including: a supply chain command platform, including: an interface manager configured to implement a build interface, and to build a visual model in response to user operations on the build interface; a supply chain model creation component configured to determine a supply chain model in response to the visual model; and a supply chain model execution component configured to operate the supply chain model as a layered digital twin of at least a portion of a physical supply chain, to interpret at least one physical supply chain execution value, and to provide a notification to a user of the supply chain command platform in response to a comparison of the supply chain model and the at least one physical supply chain execution value, wherein the layered digital twin includes a process layer and a discrete layer.

In some aspects, the techniques described herein relate to a system, including: a supply chain command platform, including: an interface manager configured to implement a build interface, and to build a visual model in response to user operations on the build interface; a supply chain model creation component configured to determine a supply chain model in response to the visual model; and a supply chain model execution component configured to: operate the supply chain model as a digital twin of at least a portion of a physical supply chain, the digital twin including a plurality of objects interrelated by a plurality of links; interpret at least one physical supply chain execution value; and provide a notification to a user of the supply chain command platform in response to a comparison of the supply chain model and the at least one physical supply chain execution value.

In some aspects, the techniques described herein relate to a system, including: a supply chain command platform, including: an interface manager configured to implement a build interface, and to build a visual model in response to user operations on the build interface; a supply chain model creation component configured to determine a supply chain model in response to the visual model; and a supply chain model execution component configured to: operate the supply chain model as a plurality of digital twins (DTs), each modeling at least a portion of a physical supply chain; interpret at least one physical supply chain execution value; provide a notification to a user of the supply chain command platform in response to a comparison of the supply chain model and the at least one physical supply chain execution value; and wherein each DT includes: a plurality of objects having a behavior, and each object of the plurality of objects having a link to at least one other object of the plurality of objects; and a DT type selected from: a physical discrete DT, a logical discrete DT, a discrete process DT, or a logical process DT.

In some aspects, the techniques described herein relate to a system, including: a supply chain command platform, including: an interface manager configured to implement a build interface, the build interface at least partially including an application programming interface (API), and to build a visual model in response to user operations on the build interface; a supply chain model creation component configured to determine a supply chain model in response to the visual model; and a supply chain model execution component configured to operate the supply chain model as a digital twin of at least a portion of a physical supply chain, to interpret at least one physical supply chain execution value, and to provide a notification to the build interface in response to a comparison of the supply chain model and the at least one physical supply chain execution value.

### BRIEF DESCRIPTION OF THE FIGURES

FIG. 1 depicts an example system including a supply chain command platform.

FIG. 2 depicts an example system including a supply chain command platform.

FIG. 3 is a schematic depiction of a digital twin according to embodiments of the present disclosure.

FIG. 4 depicts an example entity according to embodiments of the present disclosure.

FIG. 5 depicts an example system including a supply chain command platform.

FIG. 6 depicts example behaviors of an entity according to embodiments of the present disclosure.

FIG. 7 depicts an illustrative code section of an example behavior.

FIG. 8 depicts illustrative attributes of an example entity.

FIG. 9 depicts an example API reference according to embodiments of the present disclosure.

FIG. 10 depicts an example menu for a user interface according to embodiments of the present disclosure.

FIG. 11 depicts an illustrative catalog according to embodiments of the present disclosure.

FIG. 12 depicts an illustrative catalog according to embodiments of the present disclosure.

FIG. 13 depicts an illustrative catalog according to embodiments of the present disclosure.

FIG. 14 depicts an illustrative interface according to embodiments of the present disclosure.

FIG. 15 depicts an illustrative interface according to embodiments of the present disclosure.

FIG. 16 depicts an illustrative interface according to embodiments of the present disclosure.

FIG. 17 depicts an illustrative overview of an operating platform according to embodiments of the present disclosure.

FIG. 18 depicts an illustrative system level overview according to embodiments of the present disclosure.

FIG. 19 depicts an illustrative deployment architecture according to embodiments of the present disclosure.

FIG. 20 depicts an illustrative system level architecture according to embodiments of the present disclosure.

FIG. 21 depicts an illustrative system level architecture according to embodiments of the present disclosure.

FIG. 22 depicts an example DT core module according to embodiments of the present disclosure.

FIG. 23 depicts an example DT core module architecture according to embodiments of the present disclosure.

FIGS. 24-24B depict an example database abstraction for a DT core library according to embodiments of the present disclosure.

FIG. 25 depicts an example object class organization according to embodiments of the present disclosure.

FIG. 26 depicts an example link class organization according to embodiments of the present disclosure.

FIGS. 27-27B depict an example common data model according to embodiments of the present disclosure.

FIG. 28 depicts an illustrate DT according to embodiments of the present disclosure.

FIG. 29 depicts an example schema abstraction according to embodiments of the present disclosure.

FIG. 30 depicts an example schema model according to embodiments of the present disclosure.

FIGS. 31-31B graphically depict an example schema model according to embodiments of the present disclosure.

FIG. 32 depicts an illustrative shipment flow according to embodiments of the present disclosure.

FIG. 33 depicts an example data feed for the shipment flow of FIG. 32.

FIG. 34 depicts an example business event analysis for the shipment flow of FIG. 32.

FIG. 35 depicts illustrative examples of DT types according to embodiments of the present disclosure.

FIG. 36 depicts an example layered DT according to embodiments of the present disclosure.

FIG. 37 depicts a schematic overview of example operations of a supply chain command platform.

FIG. 38 depicts an illustrative physical supply chain layout.

FIG. 39 depicts an illustrative physical supply chain ecosystem.

FIG. 40 schematically depicts benefits to a physical supply chain according to embodiments of the present disclosure.

FIG. 41 schematically depicts elements of a DT according to embodiments of the present disclosure.

FIG. 42 depicts a schematic view of a DT of a physical supply chain according to embodiments of the present disclosure.

FIGS. 43-43D depicts an example dashboard according to embodiments of the present disclosure.

FIG. 44 depicts a schematic view of features of a dashboard according to embodiments of the present disclosure.

FIG. 45 is a schematic depiction of aspects of a dashboard according to embodiments of the present disclosure.

FIG. 46 is a schematic depiction of aspects of a dashboard according to embodiments of the present disclosure.

FIG. 47 depicts an illustrative network of DTs according to embodiments of the present disclosure.

FIG. 48 is a schematic depiction of available functions of an example supply chain command platform according to embodiments of the present disclosure.

FIG. 49 is a schematic depiction of capabilities a supply chain command platform according to embodiments of the present disclosure.

FIG. 50 is a schematic depiction of capabilities a supply chain command platform according to embodiments of the present disclosure.

FIG. 51 is a schematic depiction of a capability matrix for a supply chain command platform according to embodiments of the present disclosure.

FIG. 52 is an illustrative depiction of a number of historical supply chain disruptions.

FIG. 53 is an illustrative depiction of response behavior to a supply chain disruption.

FIG. 54 depicts an example menu for a user interface according to embodiments of the present disclosure.

FIG. 55 depicts an example system including a supply chain command platform.

FIG. 56 depicts an example system including a supply chain command platform.

FIG. 57 depicts example supply chain execution values according to embodiments of the present disclosure.

FIG. 58 depicts example off-nominal event values according to embodiments of the present disclosure.

FIG. 59 depicts example functions of a supply chain command platform according to embodiments of the present disclosure.

### DETAILED DESCRIPTION

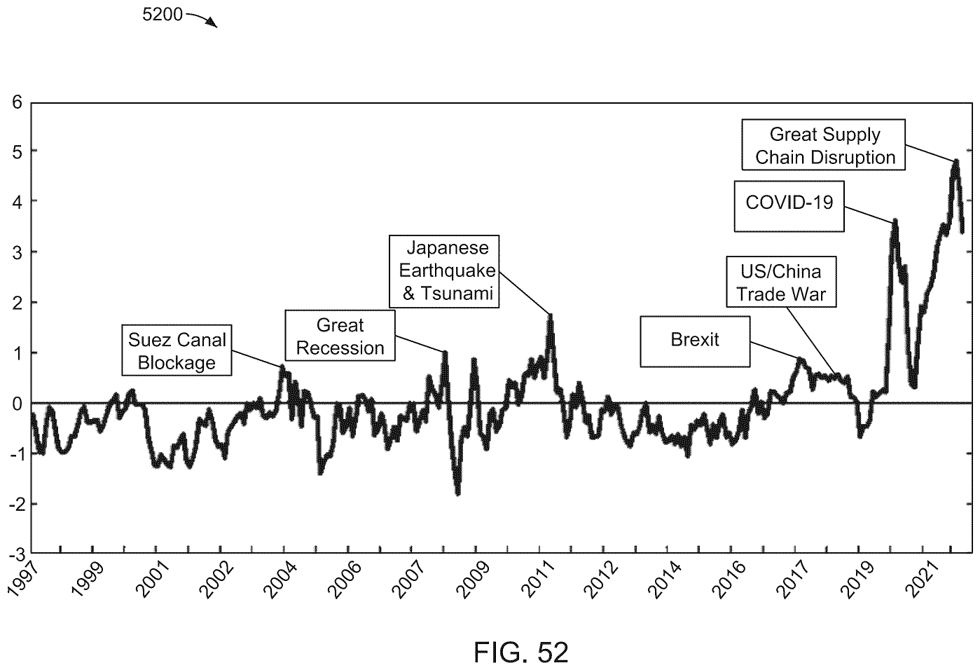

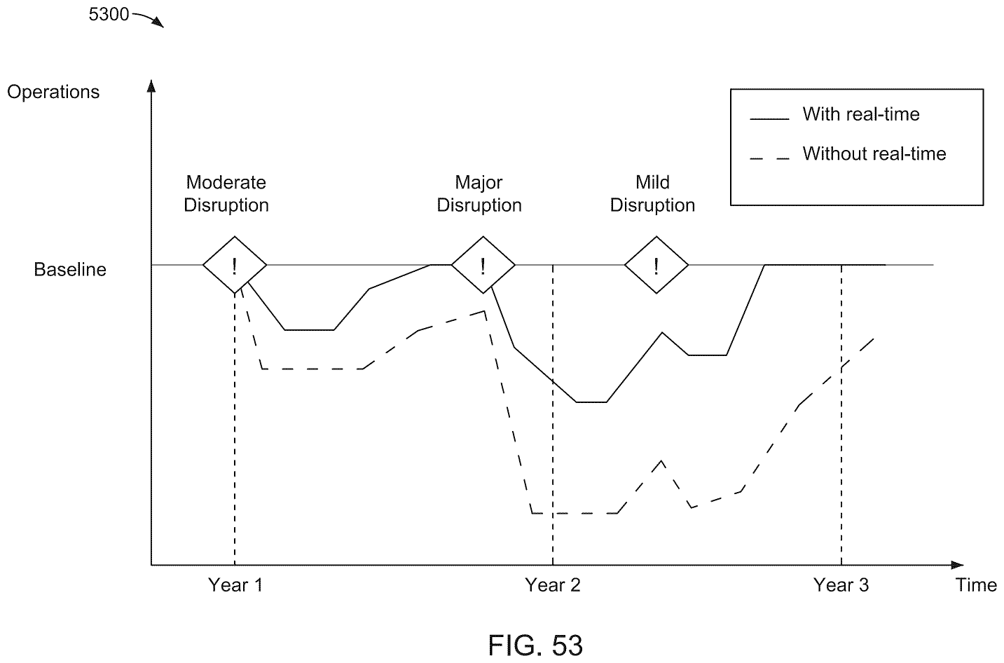

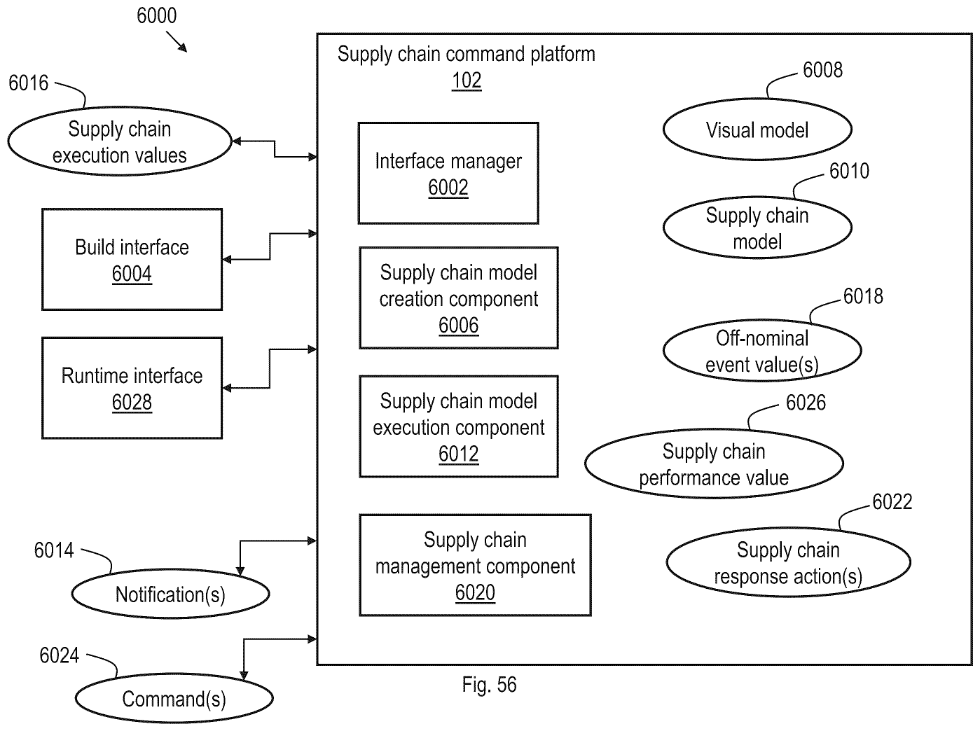

Embodiments herein include a system, method, and apparatus for supply chain management that is more robust than previously known systems, allowing for improved response times to a disruption, improved response quality (e.g., ensuring that a corrective action is beneficial), improved mitigation to disruption, and/or improved ability to avoid disruptions. Embodiments herein are beneficial to making supply chain execution more robust to disruptions, but also to supply chain planning. Supply chain planning in previously known systems is highly sophisticated, and is largely where efforts to protect the supply chain have been dedicated. However, embodiments herein allow supply chain planners to utilize more granular and realistic models for planning, to make more sophisticated determinations of how disruptive events affect the entire supply chain ecosystem, and to build responses to disruption into the supply chain plan allowing for faster response to the disruption. Referencing FIG. 52, a number of historical supply chain disruptions are depicted schematically against a dimensionless supply chain disruption level, illustrating a number of recent events that historically have disrupted supply chain operations. Referencing FIG. 53, illustrative data depicting response behavior to a supply chain disruption is depicted. The area of the curve between the response curve and the baseline provides a rough indication of the total losses to the system due to the supply chain disruption. Embodiments herein, including embodiments configured to perform automated and/or rapidly implemented pre-planned supply chain response actions 6022 (e.g., reference FIG. 56 and the related description) will experience a lower magnitude of total disruption, and rebound to nominal operations more quickly than previously known supply chain management systems, resulting in a significant first order impact and/or loss reduction to a supply chain disruption event. Additionally, second order effects will be reduced, for example losses due to impacts on customer satisfaction, loss of market share, and/or entity failure in the marketplace due to revenue losses and/or increased costs for emergency response activities (e.g., due to a lack of planned response and/or delayed response) to supply chain disruptions.

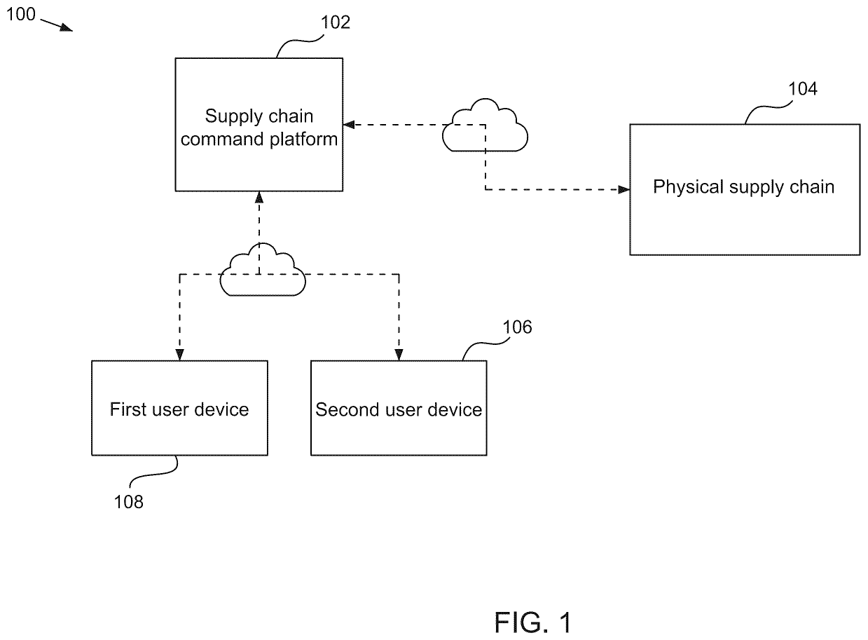

Referencing FIG. 1, an example system 100 includes a supply chain command platform 102. The example supply chain command platform 102 is depicted as a single device, but may be a distributed device, a cloud-based server configured to execute operations of the platform 102, or the like. In certain embodiments, elements of the supply chain command platform 102 may be included on one or more other devices depicted, such as a user device 106, 108. The example supply chain command platform 102 may interface with user device(s) 106, 108 through a mobile application on the user device 106, 108, through a web portal, through an application programming interface (API), and/or combinations of these. In certain embodiments, aspects of the platform 102 are executed on one hardware device at a first time and/or operating condition, and executed on another hardware device at a second time and/or operating condition. In certain embodiments, aspects of the platform 102 are embodied as computer readable instructions configured to perform one or more operations of the platform when executed by a processor. The platform in the example is depicted as communicating with user devices 106, 108 (e.g., accessed by a supply chain planner, operator, administrator, etc.) through a cloud connection, but may communicate with user devices by any means, including for example using the internet, a WAN, a LAN, cellular communications, WiFi, and/or combinations of these. In certain embodiments, one or more aspects of the platform 102 and/or a user device 106, 108 may be embodied on a same hardware device (e.g., a dedicated application installed on the user device), where communications between the “platform” and the “user device” occur through normal operations of distinct components operating on the same hardware device.

The example supply chain command platform 102 includes an interface to allow for the creation of a Digital Twin (DT), which models one or more aspects of a physical supply chain 104, including for example shipping, storage, introduction of products into the supply chain, resolution of products out of the supply chain (e.g., through consumption, sale, delivery, leakage, incorporation, etc.), and/or changes to products within the supply chain (e.g., through aging, conversion due to chemical reactions, etc.). The scope of the physical supply chain 104 that is modeled in the DT is selectable, for example covering the aspects of the supply chain that are relevant to a particular user, company, country, facility, or the like. In certain embodiments, a physical supply chain 104 may be modeled using a networked group of DTs.

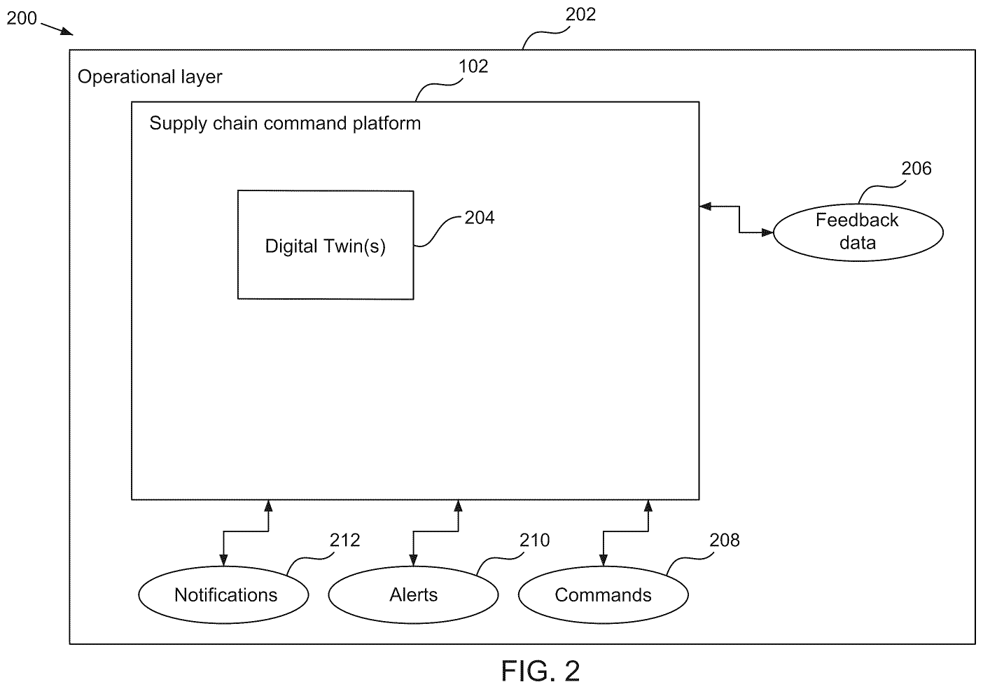

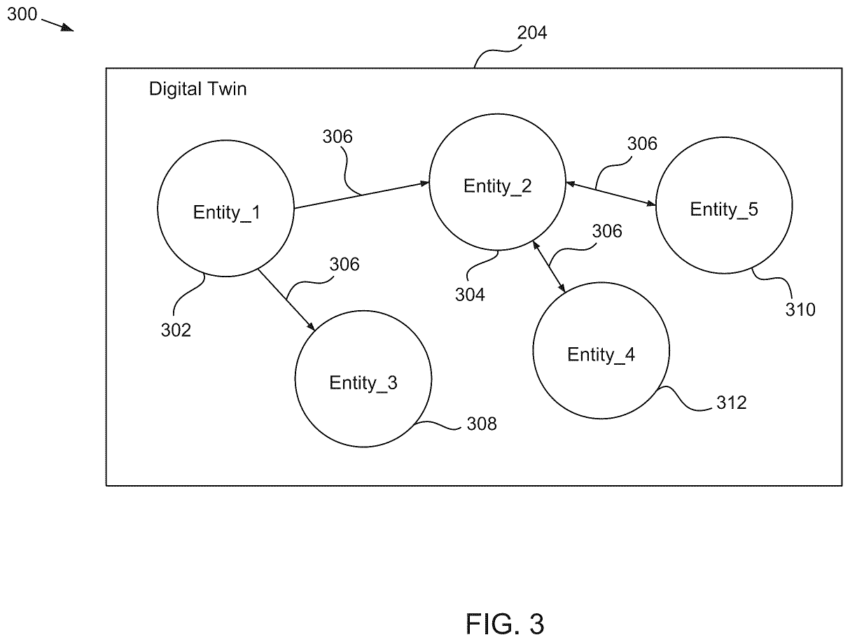

Referencing FIG. 2, an example system 200 includes a supply chain command platform 102 depicted in an operational layer 202, for example as the platform 102 may be utilized during runtime operations of the physical supply chain 104. In certain embodiments, the example of FIG. 2 may relate to execution of the platform 102 modeling a supply chain that may be a speculative supply chain, for example operating the platform 102 to test scenarios of the speculative supply chain. The example platform 102 interacts with users to provide notifications 212 (e.g., confirmation of events, reports, status values, etc.), to provide alerts 210 (e.g., alerting a user that an event has occurred, such as a delivery interruption, compliance variance, etc.), and/or to exchange commands 208 (e.g., allowing the user to make changes to the operations of the supply chain 104—whether a physical supply chain 104 or a speculative supply chain, for example to respond to a disruption, to test a response in a scenario, or the like, and/or providing commands to implement response plans, mitigating actions, or the like). The classification of communications into notifications 212, alerts 210, and/or commands 208 is provided for clarity of the present description, and is not limiting. For example, a given communication may be a notification 212 or an alert 210, which may depend upon the purpose of the communication and/or the perspective of the user being notified. In certain embodiments, a user may provide a confirmation to the platform (e.g., acknowledging that an alert was received), which may be considered a command 208 to the platform or a feedback value (e.g., feedback data 206). The platform 102 is capable to provide any outgoing information to selected users or user devices, and is capable to receive communications and/or data from selected users, devices, sensors, or the like, without limitation to the specific implementation depicted in FIG. 2.

The example platform 102 is further configured to receive feedback data 206, which may be from any device that is at least selectively communicatively coupled to the platform 102. For example, feedback data may be received from a sensor (e.g., a temperature sensor thermally coupled to a set of goods that are temperature sensitive), from a database (e.g., shipping data from a port terminal), from external sources (e.g., weather or news reports), and/or from a user (e.g., a user responding to a request from the platform, entering data as a part of supply chain operation, etc.). The example feedback data 206 may be from any source, and links the DT to the physical supply chain 104.

Referencing FIG. 3, an example system 300 includes a DT 204 schematically depicted. The example DT includes a number of entities 302, 304, 308, 310, 312 (e.g., Entity_1), each representing a physical part (e.g., a component, hardware device, facility, etc.) of the physical supply chain 104, and/or a logical part (e.g., a process operation, state value, confirmation value, etc.) of the physical supply chain 104. For example, and without limitation, an entity may represent a storage facility, a warehouse, a shipment type, a location, an asset, a package, a product, an order, a supply agreement, or the like. The entities in the DT are related with relationships 306, allowing for data passing between entities, permissions to be applied between entities, development of dependencies between entities, or the like. The entities in the DT are separate from entities having an interest in the platform, for example a company using the platform 102 to manage their supply chain or aspects thereof. In certain embodiments, entities having an interest in the platform may be referenced as tenants and/or users. In certain embodiments, a tenant/user may be represented by an entity 302, 304, 308, 310, 312 within the DT, for example a logical entity allowing for operations relevant to the tenant/user as such (e.g., tracking custody and/or liability for products as they pass through the supply chain). The relationships depicted between entities in FIG. 2 are simplified and depicted schematically for illustration, but a given entity may have any number of relationships with any number of other entities, and/or more than one relationship with another entity.

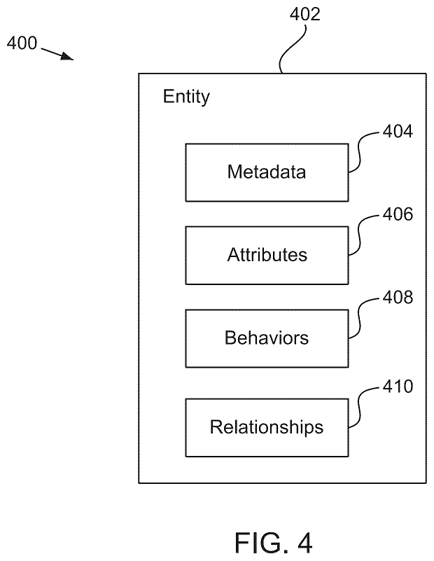

Referencing FIG. 4, an example entity 402 is schematically depicted, having a number of aspects consistent with embodiments of the present disclosure. The example entity 402 includes metadata 404, for example data utilized to manage the platform but that may not correlate to aspects of the modeled supply chain, for example identifiers, permissions, time stamps, etc. The example entity 402 further includes attributes 406 (and/or properties), which may correlate to aspects of the modeled supply chain, such as quantities, addresses, locations, distances, time values, or the like, which tend to be static or slow changing parameters, and/or parameters selected by a user. The organization of entity aspects into attributes 406 and metadata 404 is for clarity of the present description, but is not limiting to embodiments of the present disclosure. For example, an entity may have only attributes 406 and no aspects that are “metadata” 404, and/or a given data value may be metadata 404 for some purposes, and an attribute 406 for other purposes (e.g., a company name for an entity corresponding to a tenant/user, which may serve as an identifier and have a function within the platform 102 itself).

The example entity 402 further includes behaviors 408, for example including models related to the entity 402 (e.g., a temperature model of goods associated with the entity, estimating losses such as venting operations for compressed gas, etc.), event detections related to the entity 402 (e.g., determining if a delivery is delayed, if goods are out of compliance, etc.), event responses (e.g., notifications or alerts to be provided in response to the event, communications to other entities such as ordering replacement or substitute goods, adjusting delivery schedules, etc.), and/or any other operational functions of the entity 402. In certain embodiments, without limitation to any other aspect of the present disclosure, the entity paradigm for the DT is analogous to entities as objects, metadata and/or attributes as properties of the objects, and behaviors as methods of the objects.

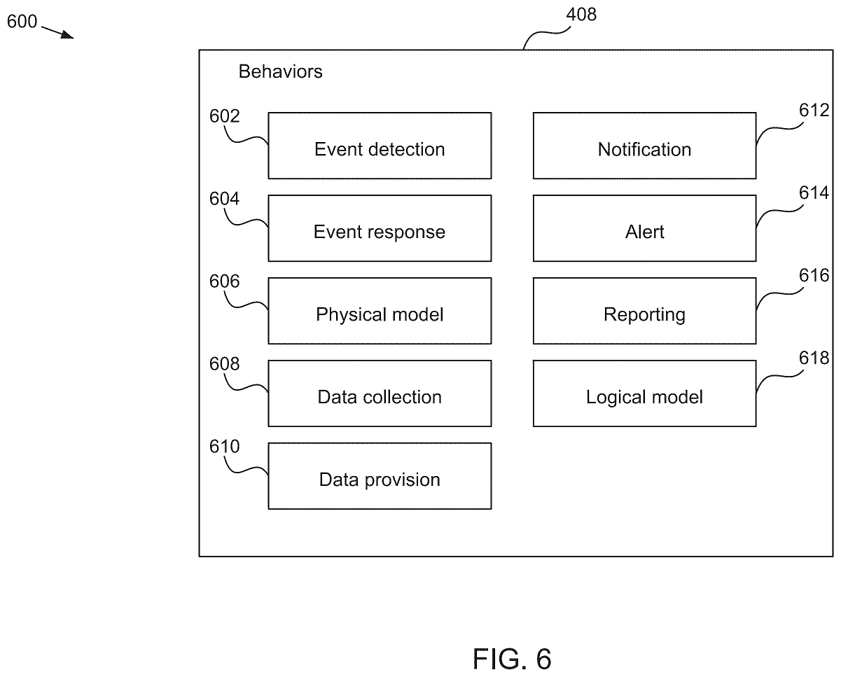

Referencing FIG. 6, an illustration 600 of behavior 408 options includes one or more of, without limitation, event detection value 602, event response value 604, a physical model 606 (e.g., a temperature model, pressure model, loss/leakage model, aging model, time delay model, etc.), data collection value 608 (e.g., data to be collected by the entity, for example from user interactions, feedback data, and/or from other entities), data provision value 610 (e.g., data to be made available, such as to other entities, to a user, etc.), notification value 612 (e.g., notification content, delivery location and/or method, timing, etc.), alert value 614, reporting value 616 (e.g., periodic data to be provided anywhere on the platform and/or to any device in communication with the platform), and/or a logical model 618 (e.g., a model for aspects that may not have a physical component, for example ordering status, compliance status, speculative parameters such as risk or likelihood parameters, etc.). The selected categories of behaviors 408 are provided for clarity of description, and a given behavior 408 may be attributable to more than one category, and/or may be an implemented behavior that does not correspond to any recited category.

The example entity further includes relationships, for example setting forth the dependencies between entities, pushing or pulling data between entities, making aspects of the entities available to each other, sequencing the entities within the supply chain (physically or logically), or the like. In certain embodiments, relationships may include checking for authorization, for example only allowing information sharing between entities based upon the permissions associated with one or both of the entities, with a user or organization associated with the entity, or the like.

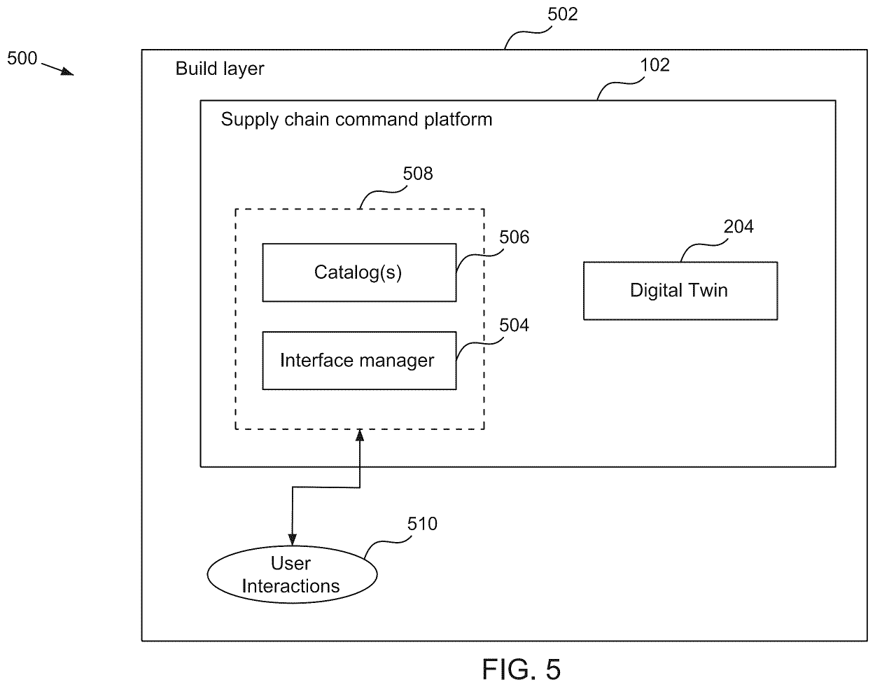

Referencing FIG. 5, an example system 500 schematically depicts a supply chain command platform 102 in a build layer 502, for example as the platform 102 may be utilized during operations to create and/or update the DT for a physical supply chain 104 and/or speculative supply chain. The present description divides the platform into the operational layer 202 (e.g., FIG. 2) and the build layer 502 for clarity of the present description, but it will be understood that, at least in certain embodiments, operations interfacing with the build layer 502 may be performed on the same platform 102 as operations interfacing with the operational layer 202, including at least in certain embodiments operations to interface with the build layer 502 simultaneously with operations to interface with the operational layer 202—e.g., allowing a user to make real-time adjustments to the DT, and/or allowing another user to update the DT while another user is receiving notifications or alerts, and/or providing commands to the DT. In certain embodiments, the build layer 502 implements a build interface 6004 (reference FIG. 56), and the operational layer 202 implements a runtime interface 6028 (reference FIG. 56).

The example platform 102 includes an interface 508, including a catalog 506 and implemented by an interface manager 504 (also reference FIG. 56, interface manager 6002), where user interactions with the interface 508 are utilized to build the DT. The user interactions include selecting entities from the catalog 506, creating or updating the attributes, behaviors, and/or relationships of the entities, and/or creating entities from scratch. The DT is created and implemented from the created and/or selected entities, according to the attributes, relationships, behaviors, etc. of those entities.

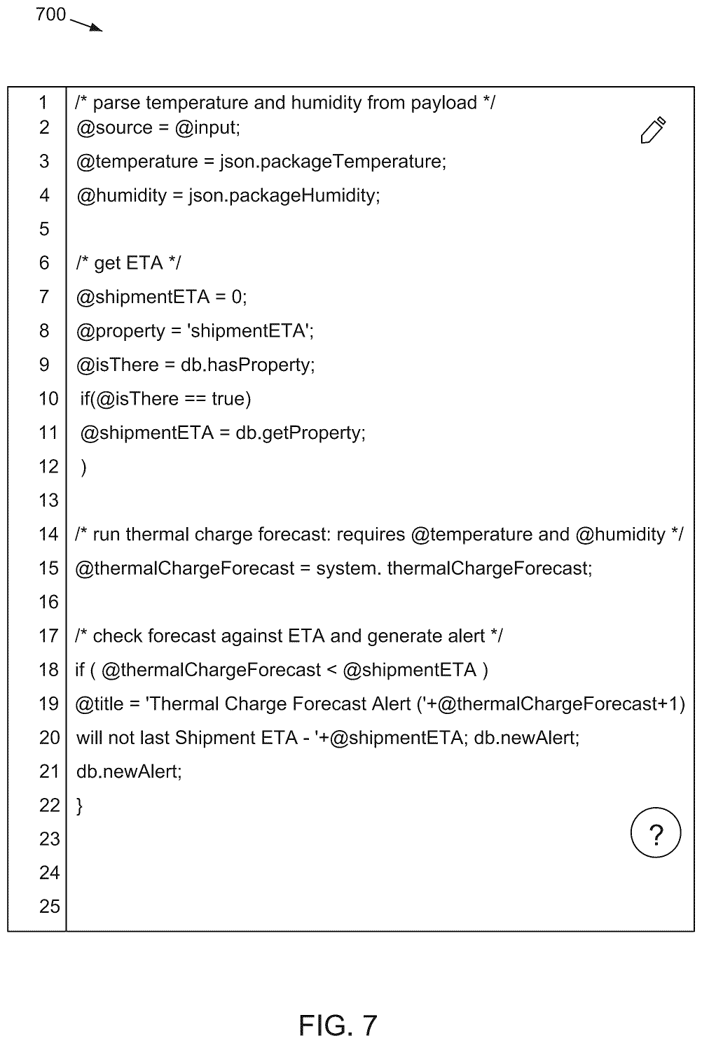

Referencing FIG. 7, an example behavior 700 for an entity is schematically depicted, which is implemented as a code based behavior. The example behavior of FIG. 7 depicts a portion of a temperature model, for example for goods that are passing through the physical supply chain.

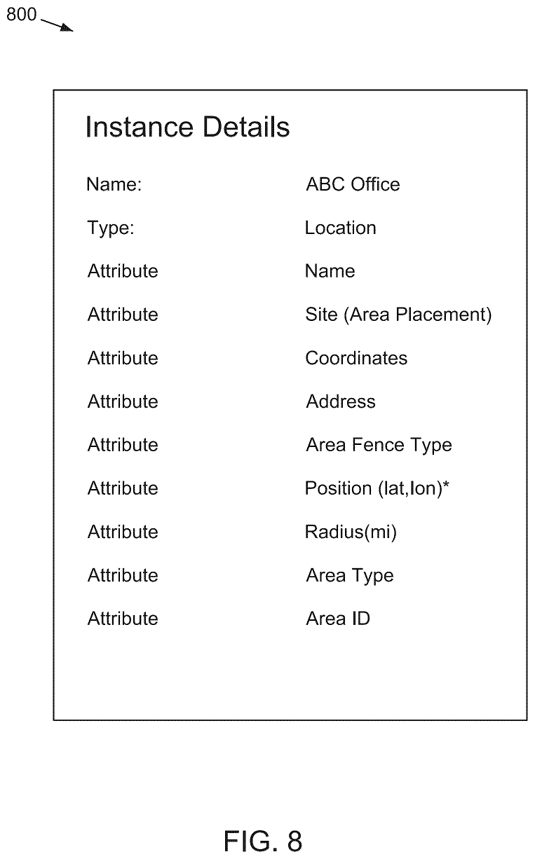

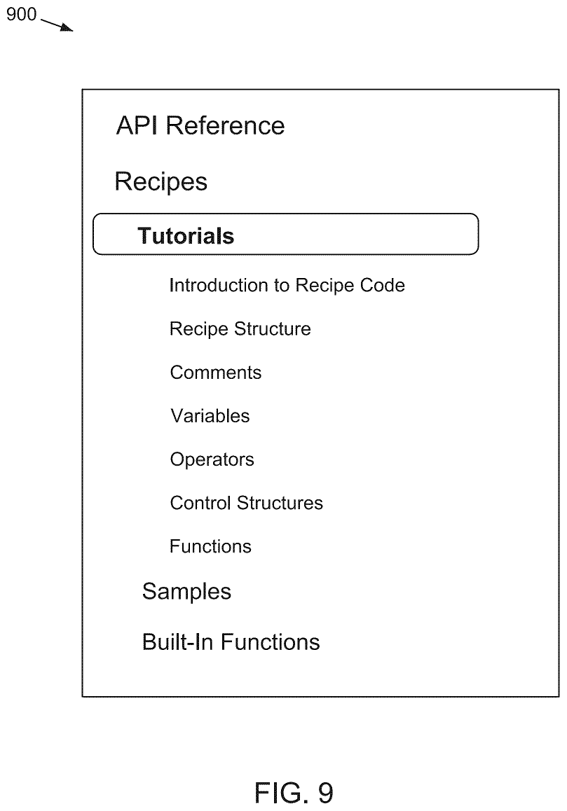

Referencing FIG. 8, an example attribute listing 800 for an entity is depicted schematically. The example attributes are illustrative and non-limiting. Referencing FIG. 9, an example API reference 900, for example implemented by the platform build layer 502 to assist tenant/users in creating entities using a user interface implemented with an API. The example API reference includes tutorial information and descriptions to assist the user, as well as examples, available built-in functions, or the like.

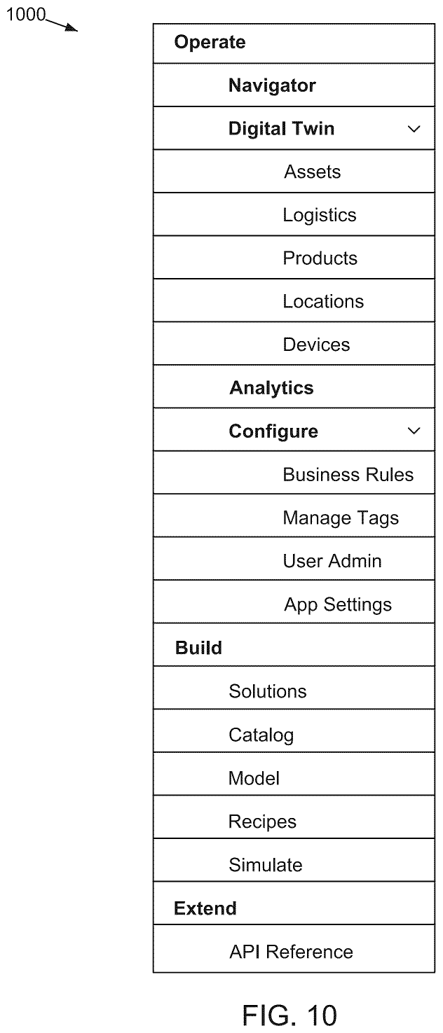

Referencing FIG. 10, an example menu 1000 of a user interface provided by the platform 102 is schematically depicted. The example of FIG. 10 includes elements that may be associated with the operational layer 202, with the build layer 502, or both. Throughout the present disclosure, the depicted interface elements, including which elements are available, content of sub-menus, features available in a catalog, built-in functions available, or the like, may be configured for the specific user, including according to user preferences, permissions, a tenant associated with the user, and/or a role of the user.

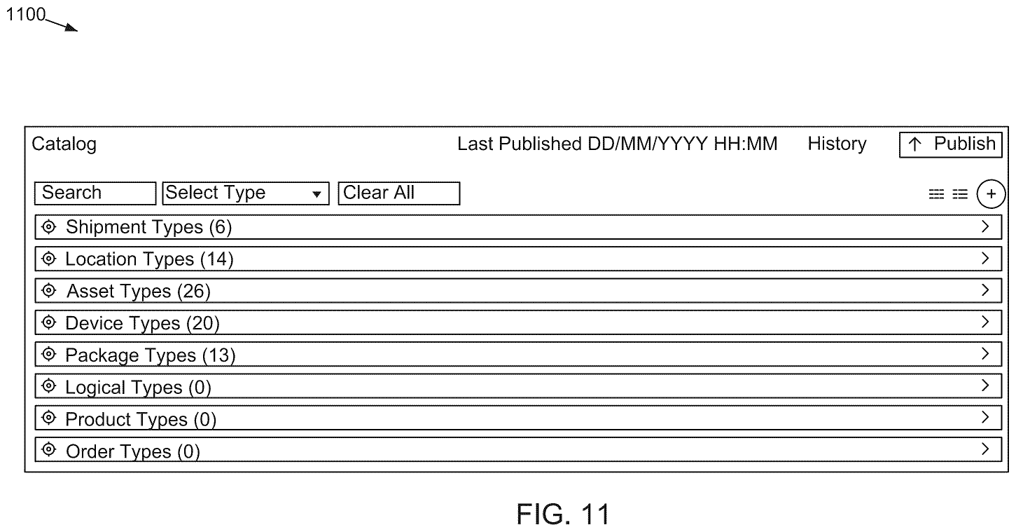

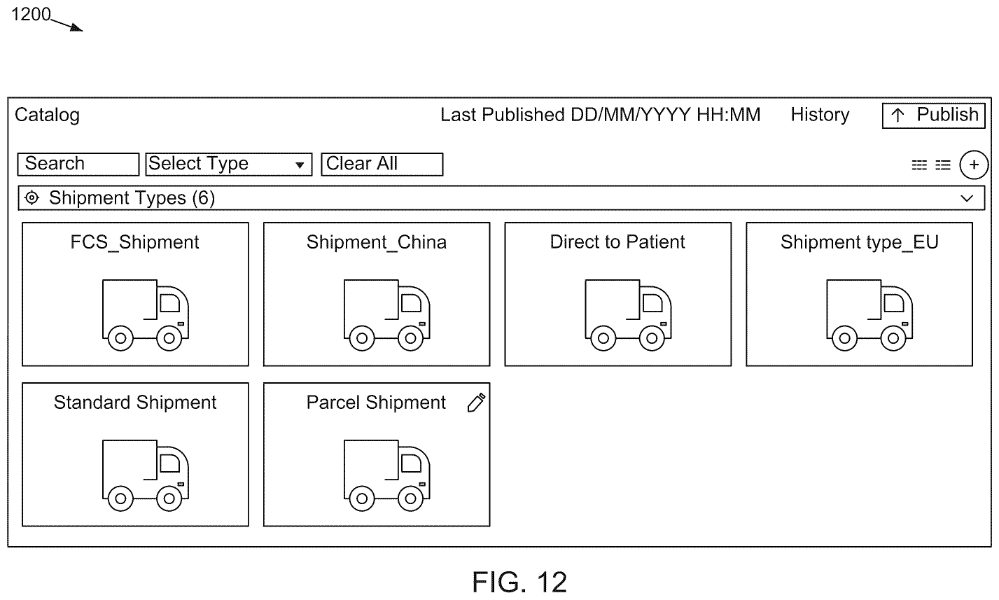

Referencing FIG. 11, an example menu 1100 of a user interface provided by the platform 102 is schematically depicted. The example of FIG. 11 depicts a number of example entities that may be provided in a catalog 506 available to the user, for example by the build layer 502 of the platform. The utilization of a catalog 506 provides for a convenient reference for the user to create instances of entities for building a DT, as well as pre-population of attributes, relationships, and/or behaviors relevant to the entity. The utilization of built-in functions, the catalog 506, and/or pre-population of entity aspects allows a user to quickly build a DT in a low coding environment, for example allowing a non-coding user to lay out the logistics of the physical supply chain (as the DT), which may be sufficient and/or which may be updated by a coding user, allowing users with multiple functions to participate in the creation, verification, and/or updating of the DT. The provision of allowing multiple users with varying skill levels for coding to access, create, and/or adjust the DT enhances the reliability of the DT, for example where a first user that is an expert in supply chain planning can evaluate the DT and ensure the proper connections and associations are made, which may not be fully understood by a supporting coding user.

Referencing FIG. 12, an example graphical menu 1200 of a number of entities, of “shipment types” in the example of FIG. 12, is schematically depicted. The example of FIG. 12 allows a user to create an instance of the selected entity, for example by selecting an entity, dragging the entity to a working surface, or through any other operations as implemented by the platform. The example of FIG. 12 is a graphical menu 1200 as a part of an example catalog 506.

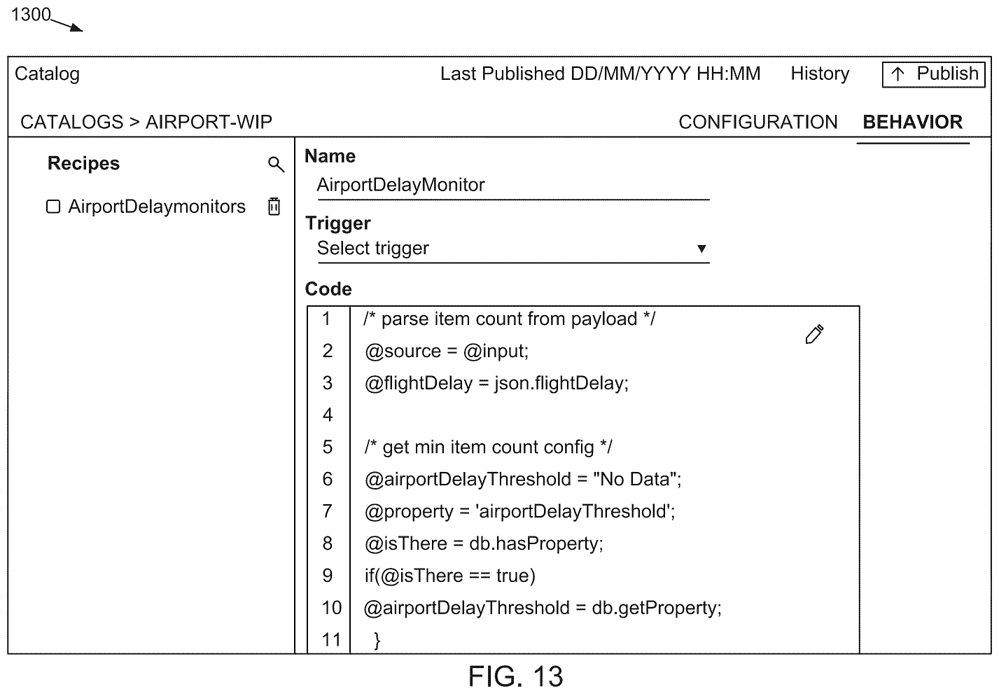

Referencing FIG. 13, an example interface 1300 for creating an entity is schematically depicted. The example of FIG. 13 includes a configuration tab (e.g., having metadata, attributes, and/or other configuration depicted thereupon, and/or editable thereupon) and a behavior tab. In the example of FIG. 13, the behavior tab is selected, and a code block visually depicts the code related to the behavior(s) for the entity. In certain embodiments, the code block may be omitted (e.g., with a label describing the behavior). The example of FIG. 13 may be implemented as a part of a catalog 506, for example in response to a selection by the user of a catalog 506 element.

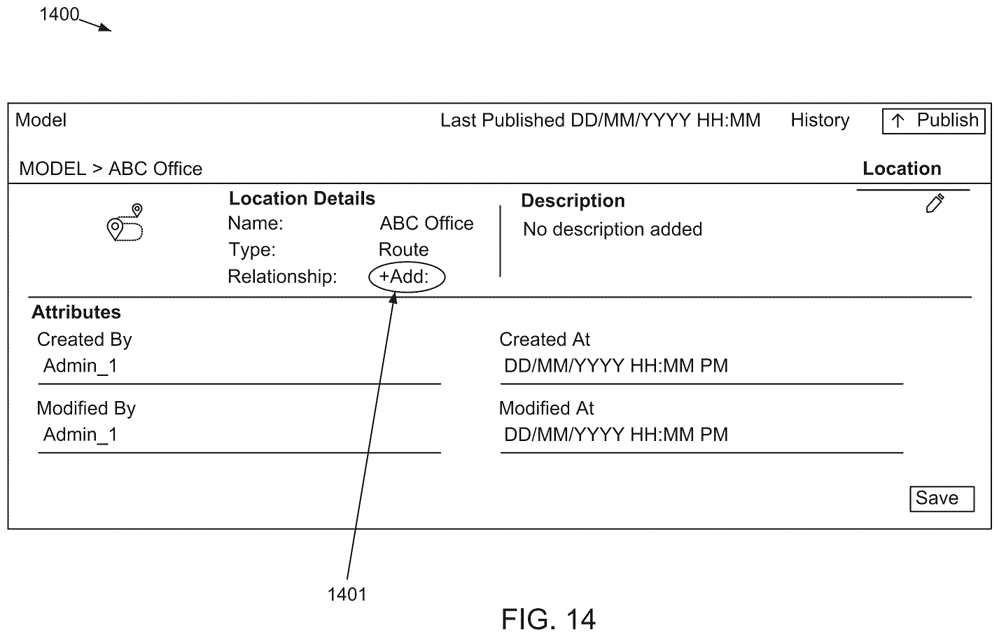

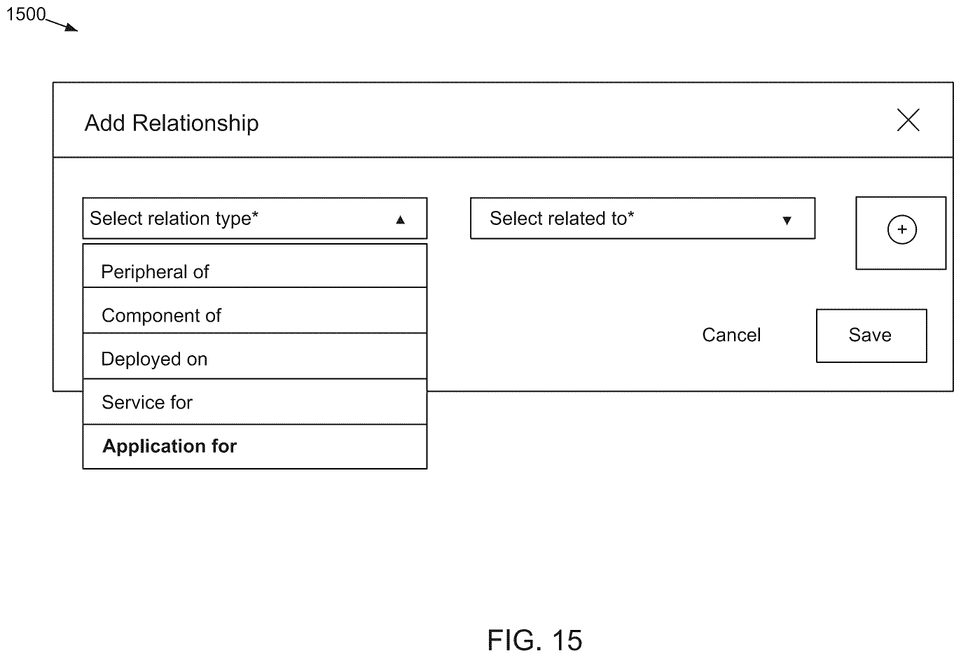

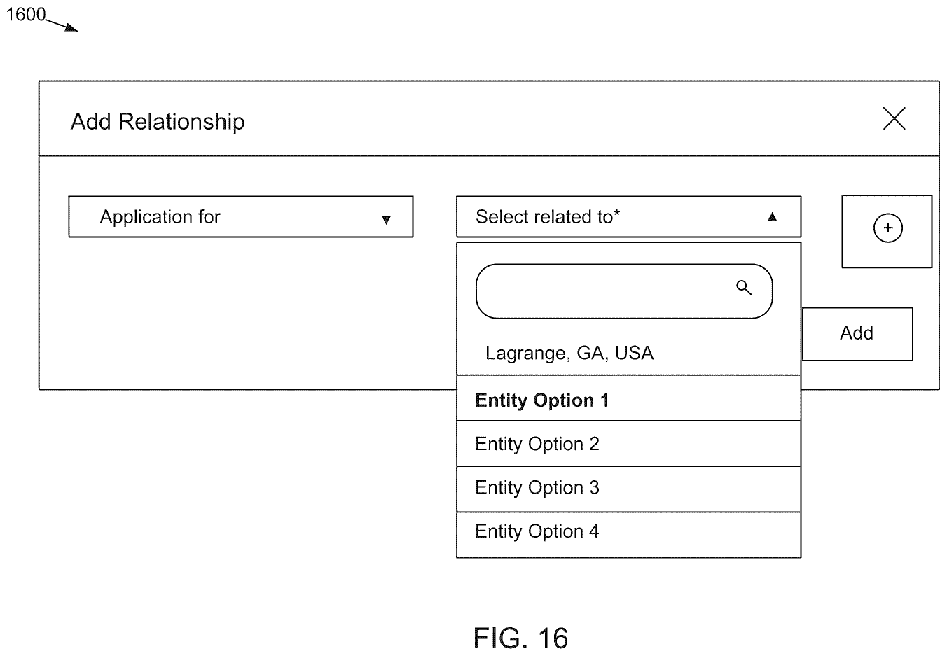

Referencing FIG. 14, an example interface 1400 for creating a relationship between entities is schematically depicted. The example interface 1400 includes a relationship creation element (e.g., a selectable+Add link in the example). In certain embodiments, links and/or relationships between entities on a visual model 6008 (reference FIG. 56 and the related description) may be performed graphically, or in any other manner. Referencing FIG. 15, an example drop-down menu 1500 providing an overview of available relationships between entities is schematically depicted, which may be provided in response to a user selection on the interface 1400 for creating a relationship. Referencing FIG. 16, an example drop-down menu 1600 providing an overview of entities available for a relationship is schematically depicted, which may be populated according to the entities present within the DT, permissions related to the user, and/or entities that are available based upon the relationship type selected. The example drop-down menu 1600 may be provided in response to a user selection on the interface 1400 to depict entities available for the relationship. The example of FIGS. 15-16 provides for the relationship type before the entity, but the order of these is not limiting, and the selection of one of these menus 1500, 1600 may affect the list that is populated in the other one of the menus 1500, 1600 upon selection.

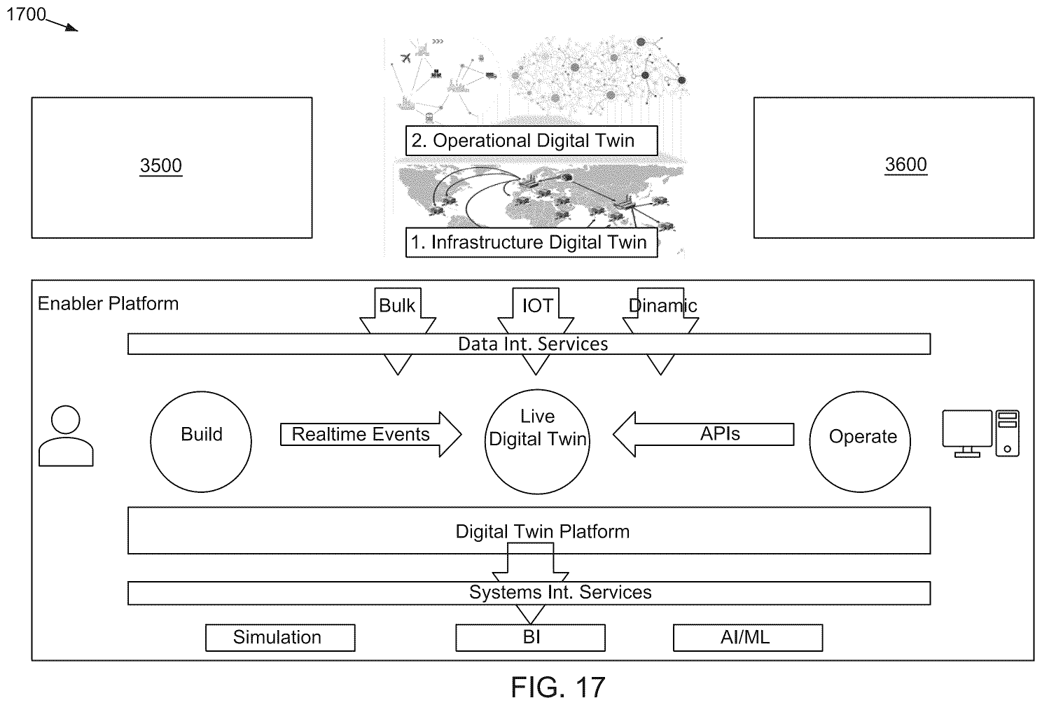

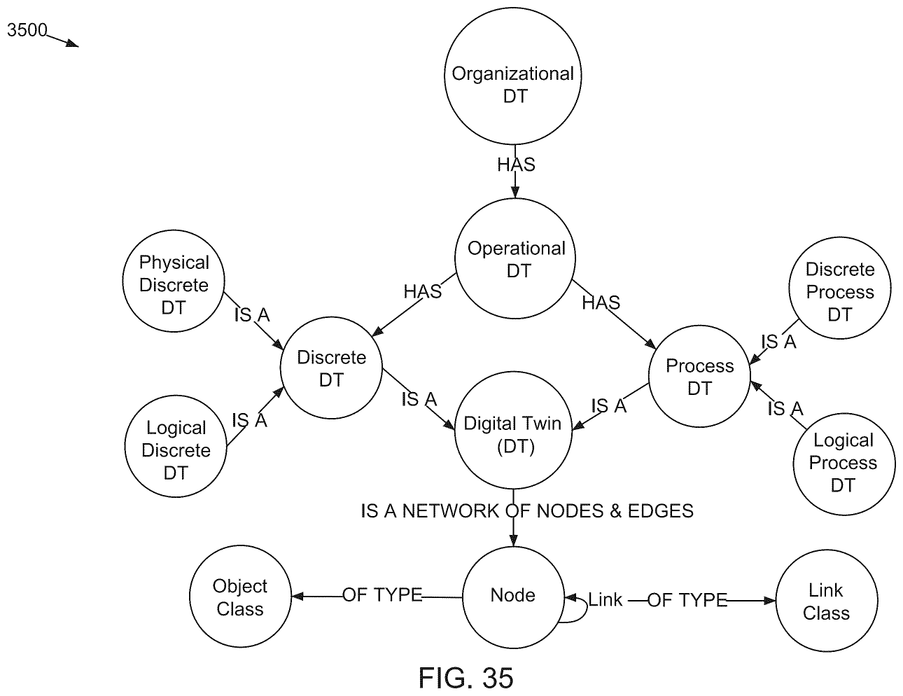

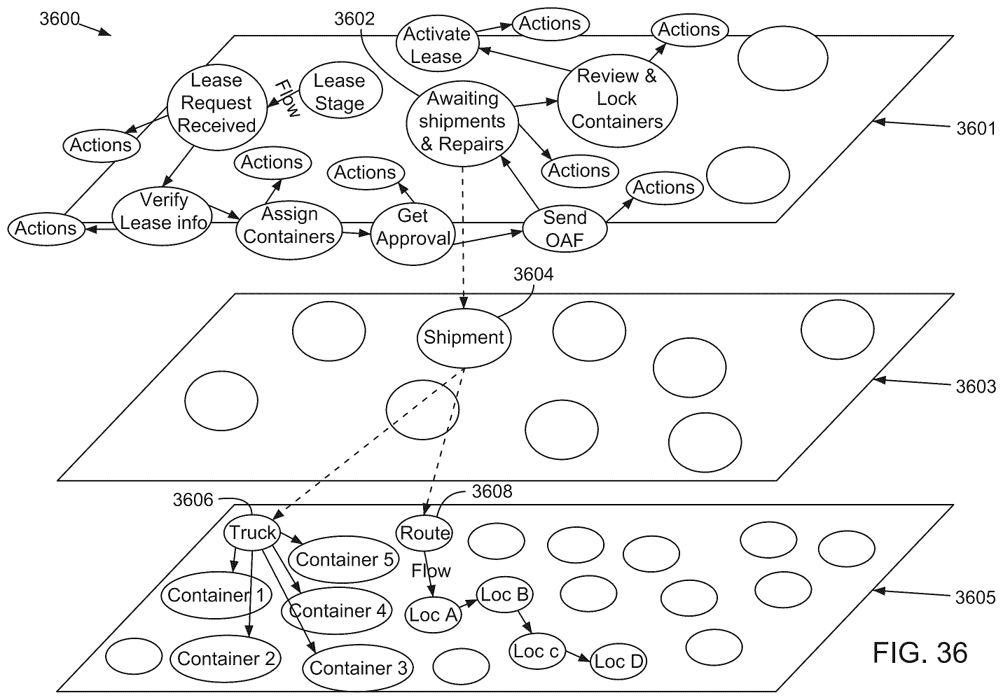

FIG. 17 is a schematic depiction of an overview 1700 of an operating platform 102, consistent with embodiments herein. The example of FIG. 17 depicts a schematic illustration of a DT 3500 (reference FIG. 35 and the related description) and of a layered DT 3600 (reference FIG. 36 and the related description), and an overview of an enabler platform schematically depicting the logical associations between users, the DT, and the platform 102, to depict a logical overview of the operating platform 102. In certain embodiments, the enabler platform may include the supply chain command platform 102, in whole or part. In the example, a first user utilizes a build interface to interact with the live DT, and a second user utilizes a runtime interface to interact with the live DT (through an API, in the example). The illustrations of the DT 3500 and layered DT 3600 represent the physical supply chain 104 operating, with data ingested (bulk, IoT, and dynamic, in the example) which may be supply chain execution values 6016 (reference FIG. 56). The DT platform performs operations to build models, adjust models, implement automated responses, detect events, build and/or execute scenarios and/or estimate values (Simulation), perform analytics and/or develop business intelligence (BI), implement iterative improvements (e.g., at the artificial intelligence/machine learning (AI/ML) block, or otherwise, and/or other operations as set forth throughout the present disclosure (e.g., including any operations performed by a supply chain command platform 102 as set forth throughout the present disclosure). The supply chain command platform 102 may include any or all elements of the enabler platform depicted in the example overview 1700 (except the user depicted for illustration), but is not limited to the elements depicted in the overview 1700.

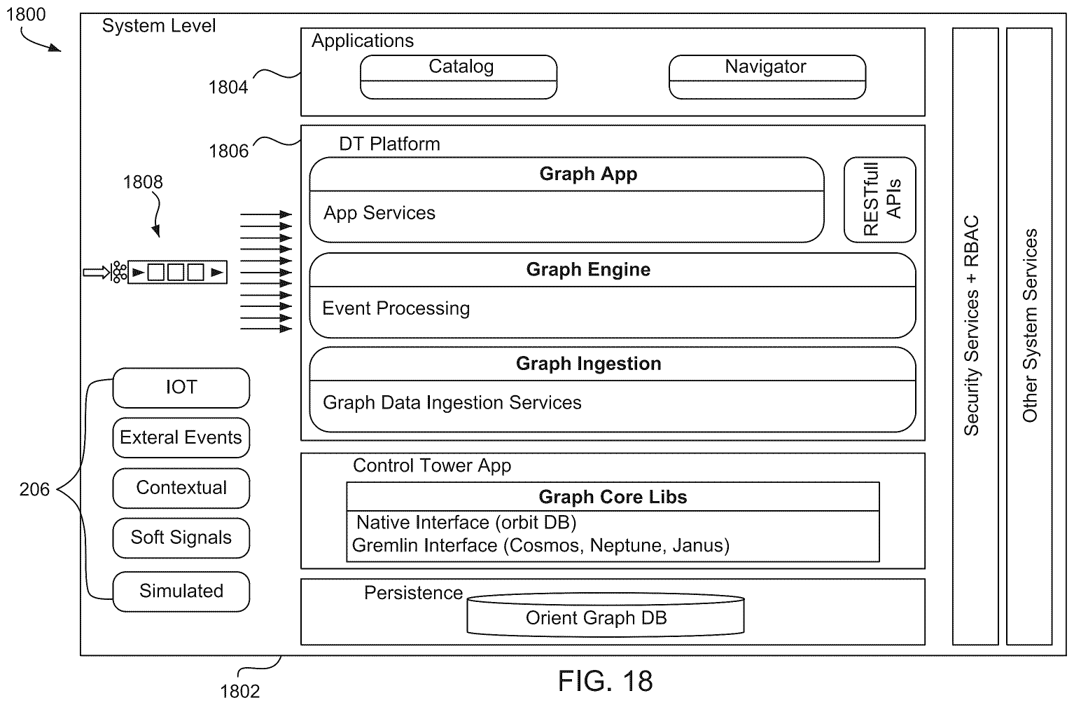

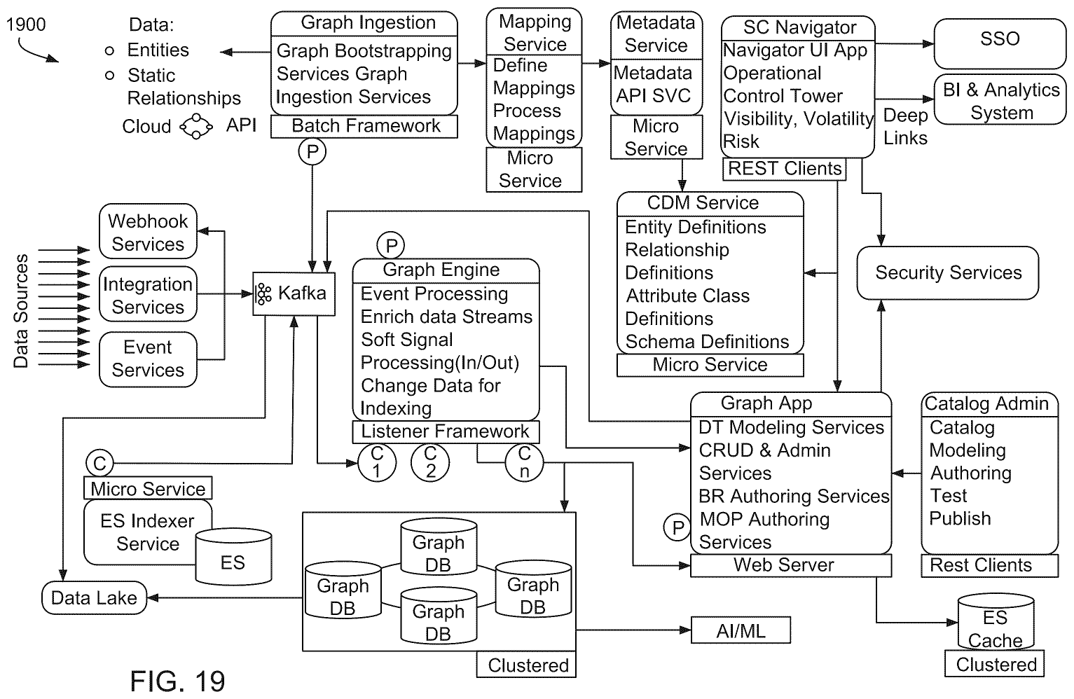

Referencing FIG. 18, an example illustration 1800 of a system level 1802 embodiment of the present disclosure is schematically depicted. The example illustration 1800 includes a data management layer 1806 that ingests and/or processes model inputs 1808, and feedback data 206, and an applications layer 1804 that operates features of the system, including a catalog and a DT navigator in the example. The supply chain command platform 102 may include any or all elements of the enabler platform depicted in the example illustration 1800, but is not limited to the elements depicted. Referencing FIG. 19, an example illustration 1900 of a deployment architecture for embodiments herein is schematically depicted and configured to support operations herein. In certain embodiments, aspects of a supply chain command platform 102 may be embodied in one or more elements of the illustration 1900.

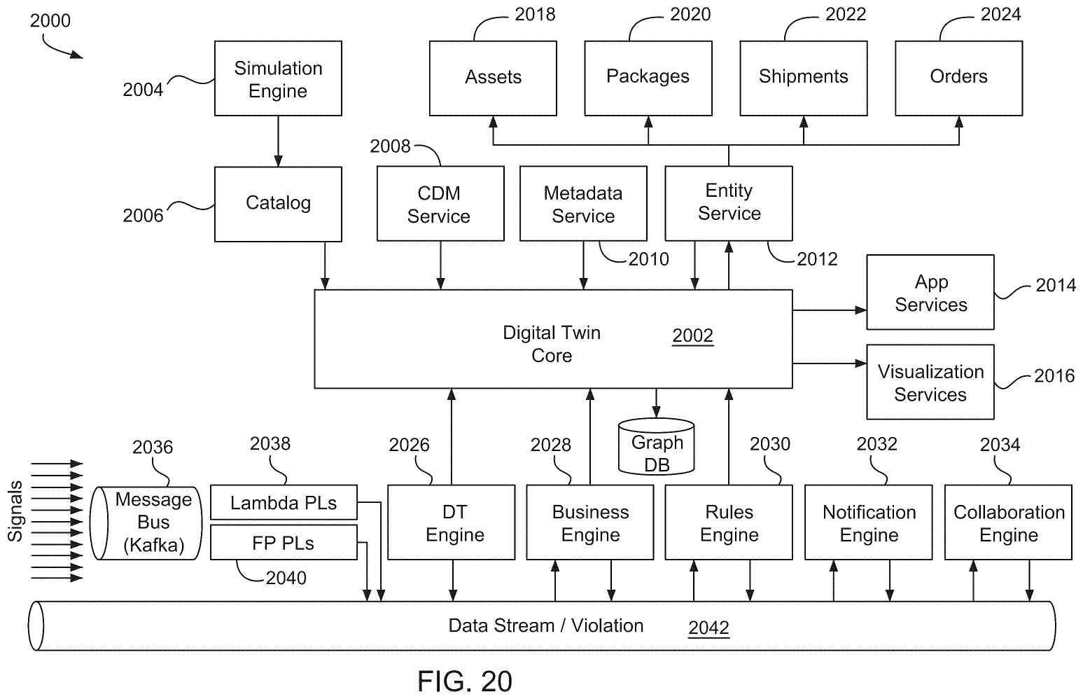

Referencing FIG. 20, an example illustration 2000 of a system level architecture for implementing DT core services is schematically depicted. The example of FIG. 20 includes a digital twin core 2002 (e.g., to coordinate DT build and/or run operations), a simulation engine 2004 (e.g., to allow operation of scenarios, estimate parameters, etc.), a catalog component 2006 (e.g., to provide catalog functions), a continuous diagnostics and mitigation (CDM) service 2008, a metadata service 2010, an entity service 2012 (e.g., managing entities or objects of the DT), an app services component 2014 (e.g., to implement user interfaces and/or applications), a visualization services component 2016 (e.g., to implement the runtime interface, dashboards, data illustrations, etc.), entity specific components (e.g., assets 2018, packages 2020, shipments 2022, and/or order 2024), a DT engine (e.g., to operate the DT at runtime, and/or to build the supply chain model 6010 from the visual model 6008, reference FIG. 56), a business engine 2028 (e.g., to determine convergence criteria, process business records or other data into usable information for the DT, etc.), a rules engine 2030 (e.g., to ingest, process, and/or coordinate supply chain response actions 6022), a notification engine 2032 (e.g., to perform notification and/or alert operations), a collaboration engine 2034 (e.g., to allow users to adjust, share, and/or work together to build DTs, monitor the physical supply chain 104, and/or otherwise coordinate on the supply chain command platform 102), a message bus 2036 (e.g., to interface with external devices, ingest supply chain execution values 6016, etc.), data processing managers 2038, 2040, and a data pipeline 2042. In certain embodiments, aspects of a supply chain command platform 102 may be embodied in one or more elements of the illustration 2000.

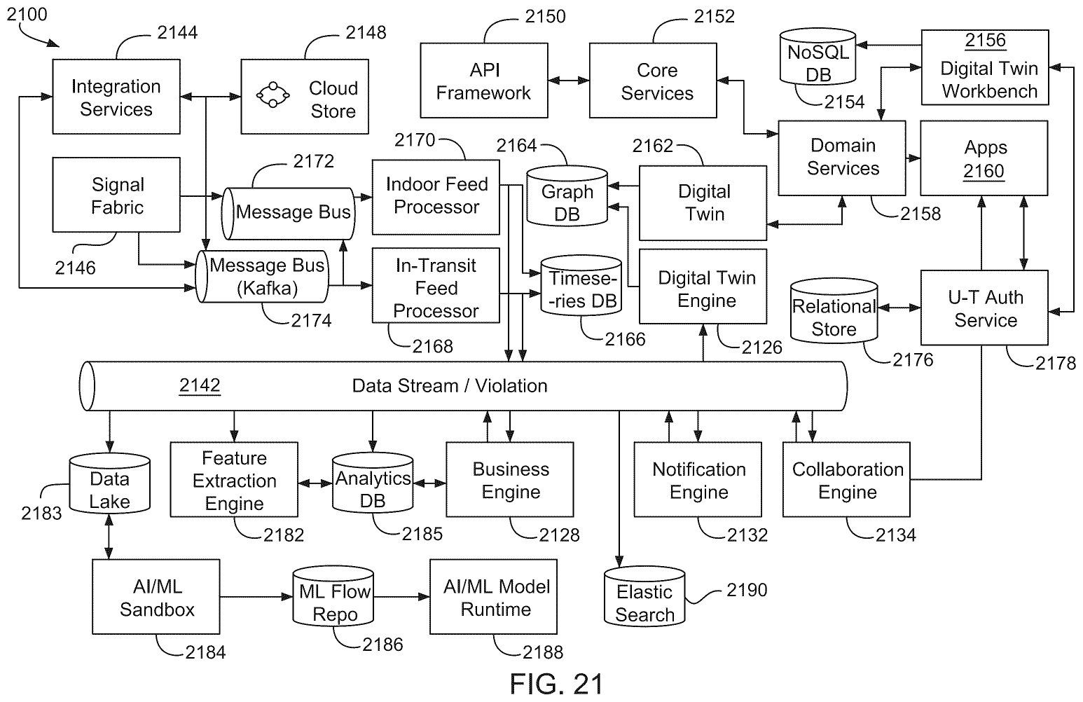

Referencing FIG. 21, an example illustration 2100 of a system level architecture for implementing DT data services is schematically depicted. The example of FIG. 21 includes an integration services component 2144, a cloud store 2148, a signal fabric 2146 (e.g., the hardware layer for external data and/or ingestion of supply chain execution values 6016), message busses 2172, 2174, an indoor feed processor 2170, an in-transit feed processor 2168, a graph database 2164, time series database 2166, DT storage 2162. DT engine 2126, a non SQL database 2154, a domain services component 2158, a DT workbench 2156, Application support component 2160, a user/tenant authorization service 2178, a relational store 2176 for user/tenant information, a collaboration engine 2134, a notification engine 2132, a data lake 218, an AI/ML sandbox 2184, an AI/ML flow repository 2186, an AI/ML model runtime component 2188, a feature extraction engine 2182, an analytics database, a business engine 2128, an elastic search component 2190, and/or a data backbone 2142. The operations of the DT data services as illustrated in FIG. 21 provide for data management and operational support for the DT core services (FIG. 20). In certain embodiments, aspects of a supply chain command platform 102 may be embodied in one or more elements of the illustration 2100.

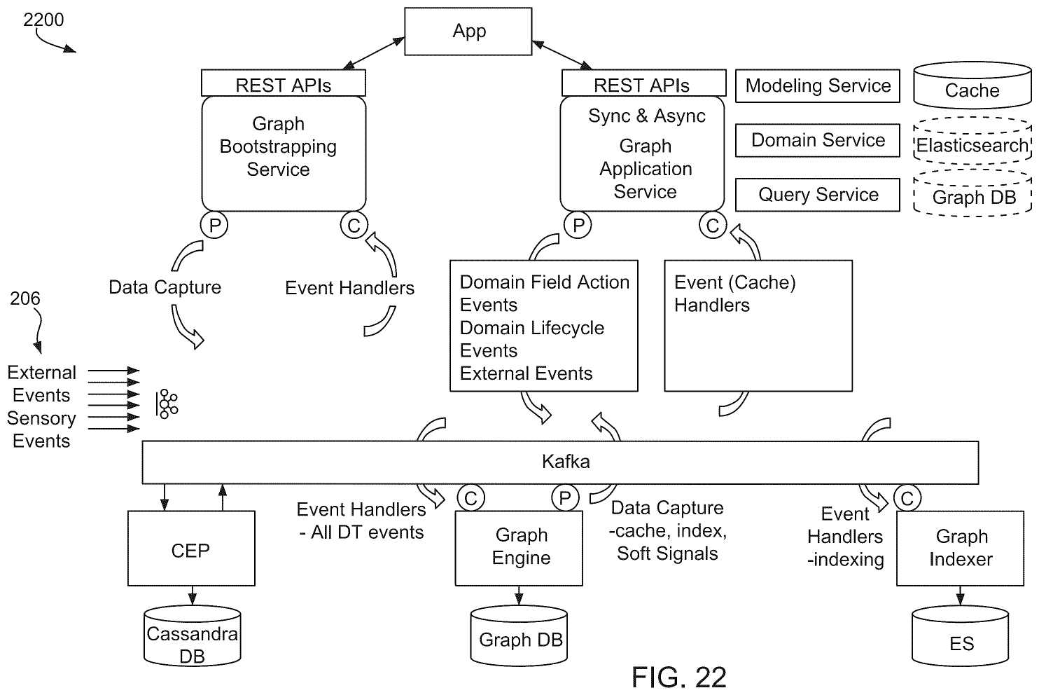

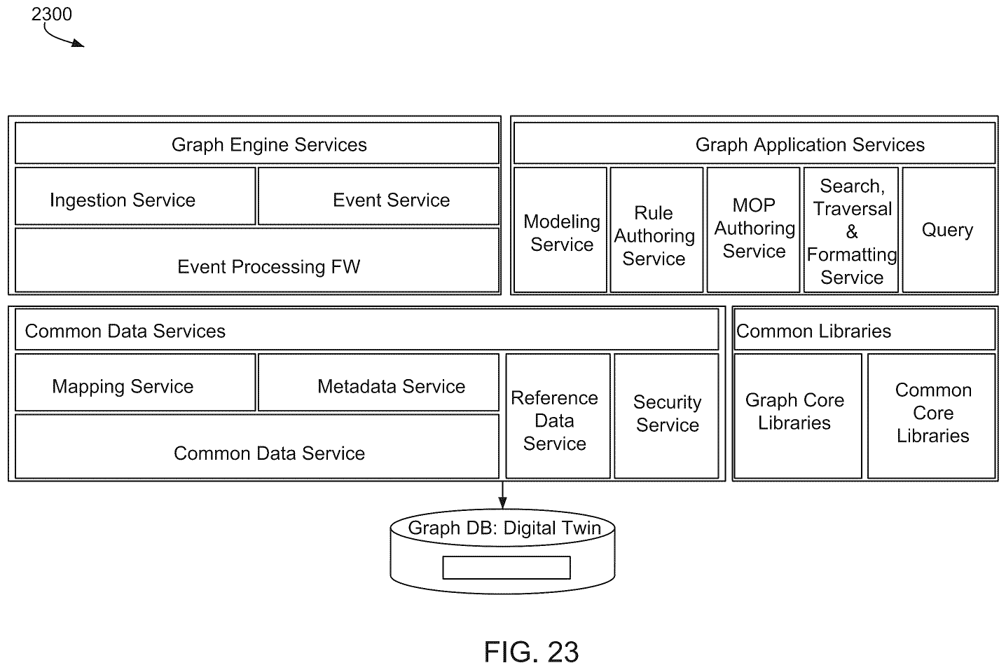

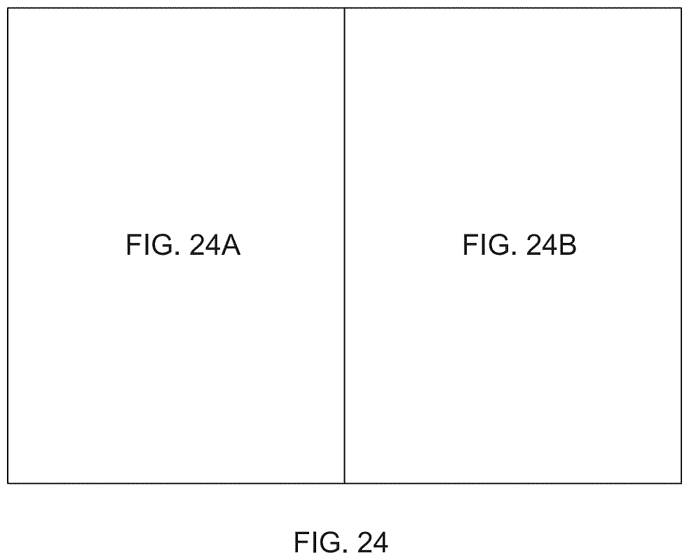

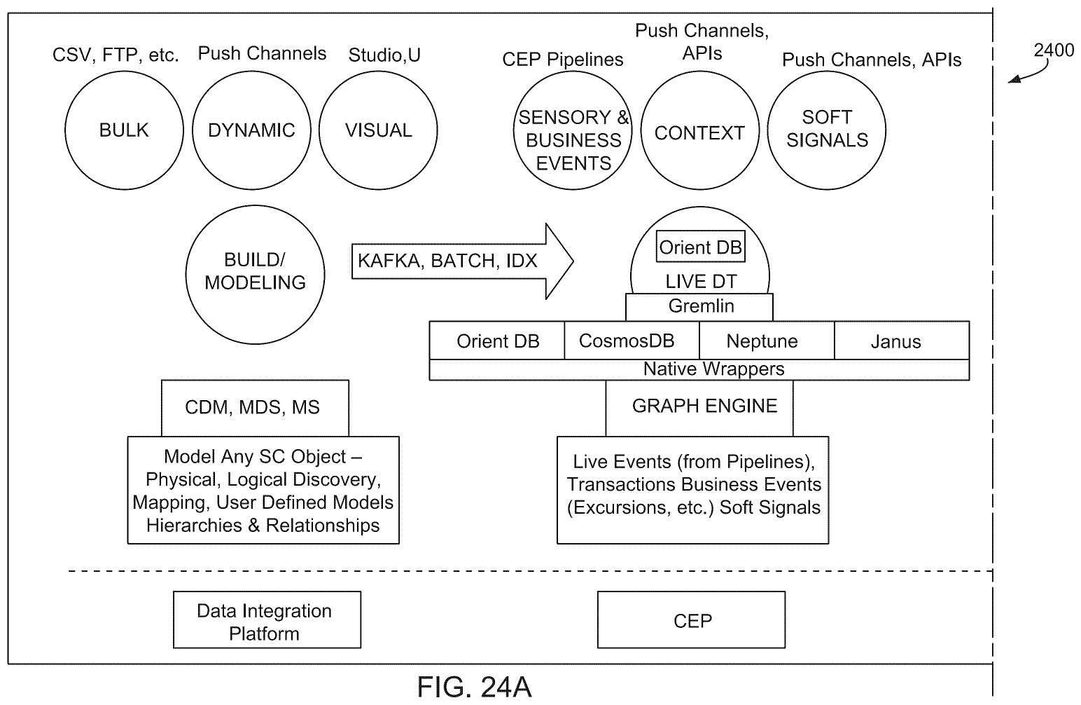

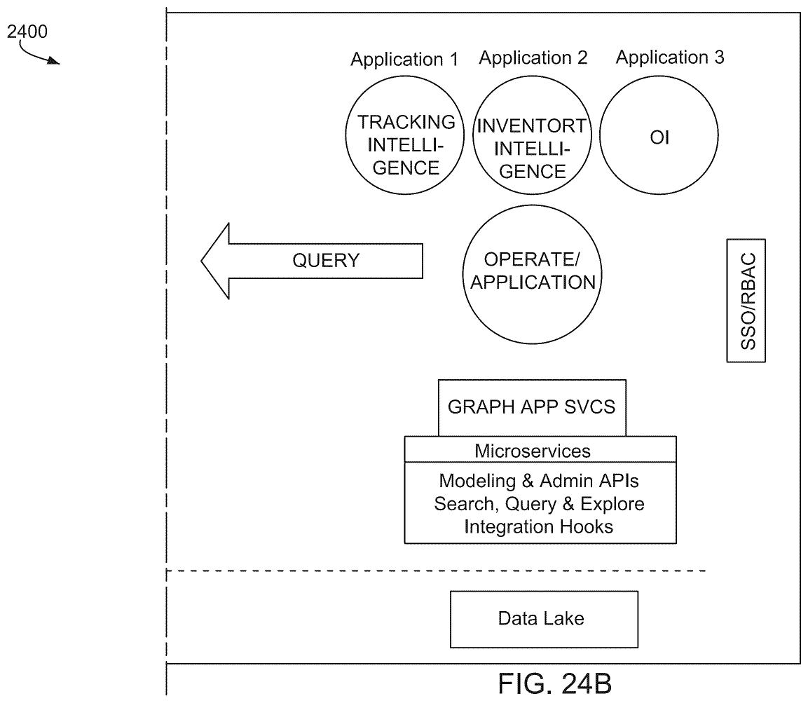

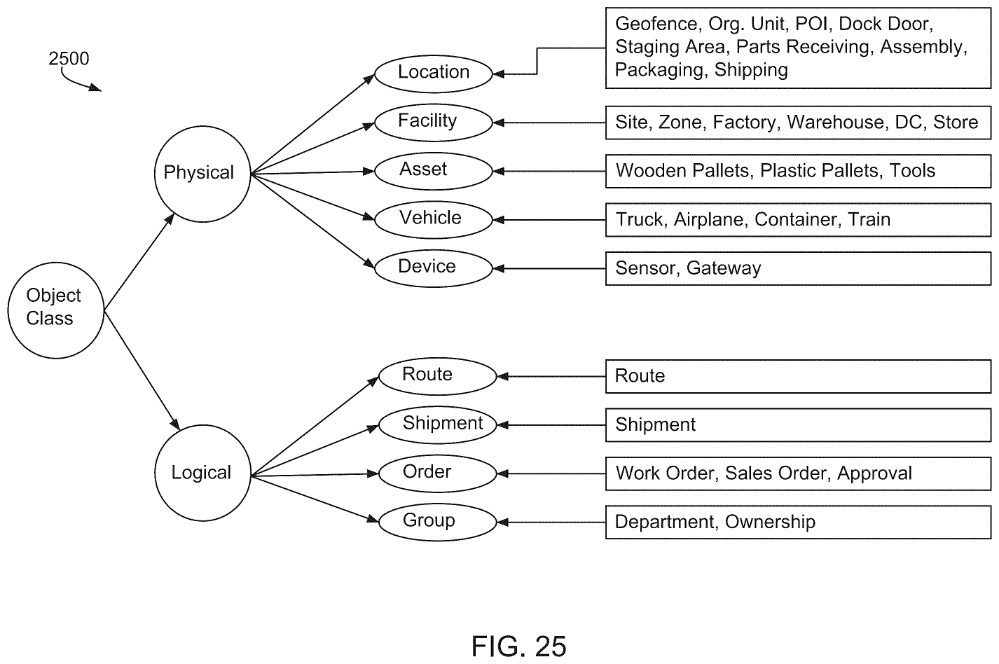

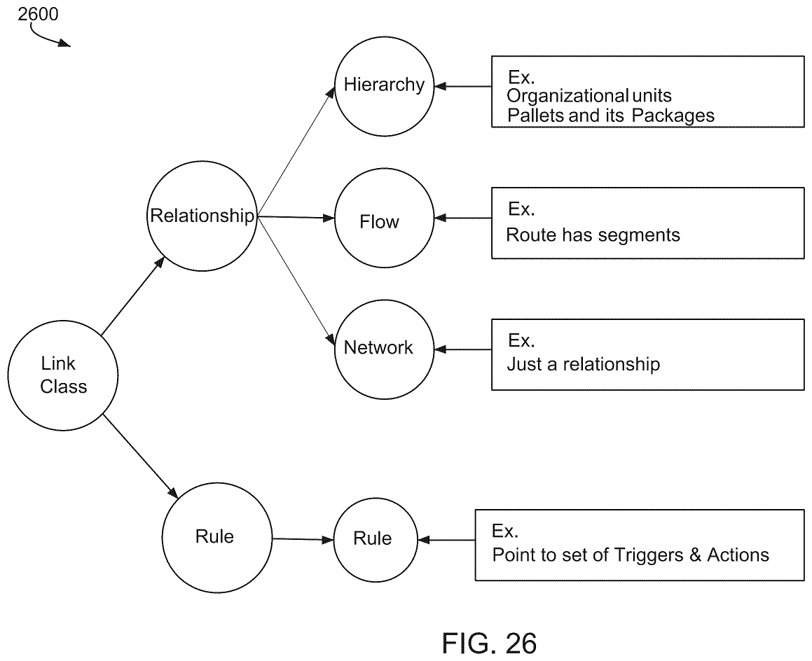

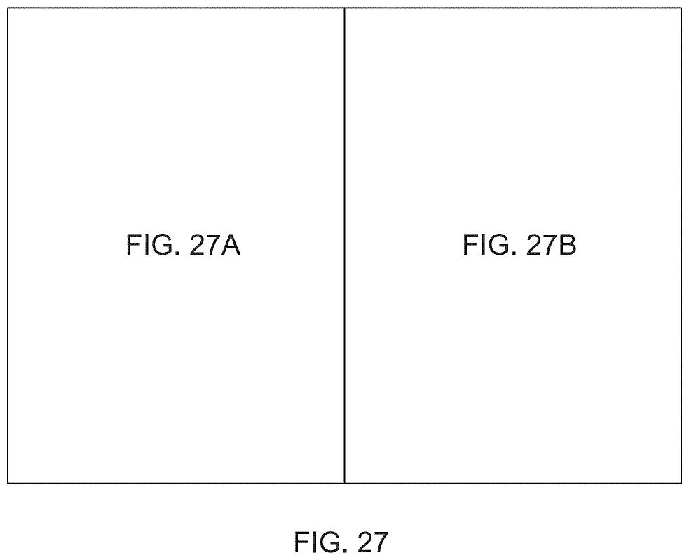

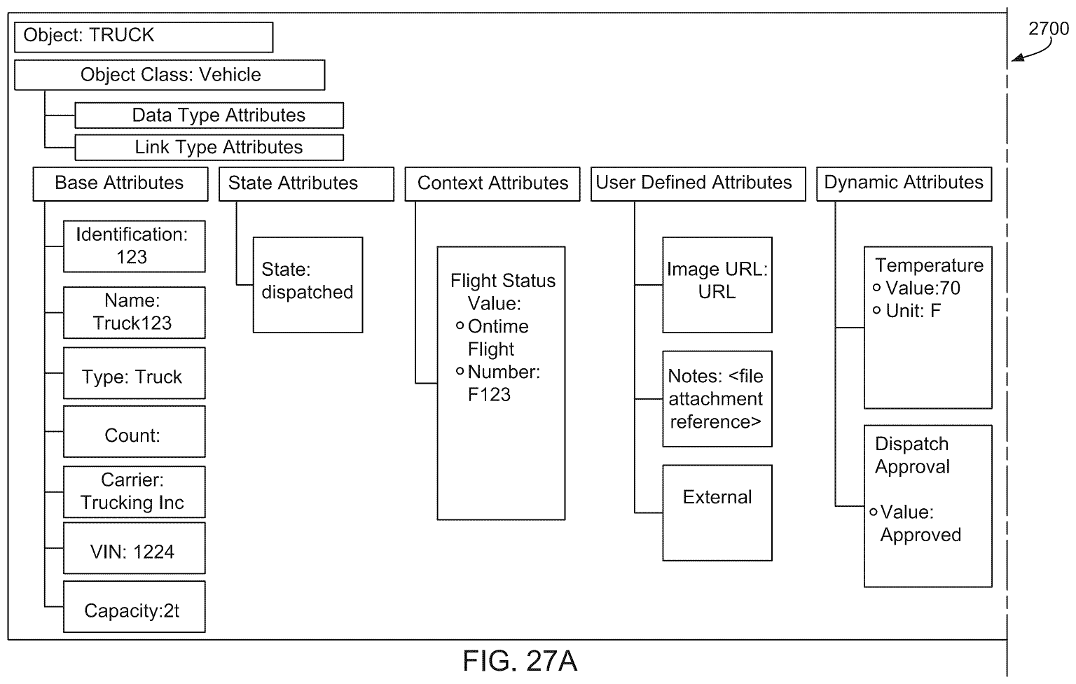

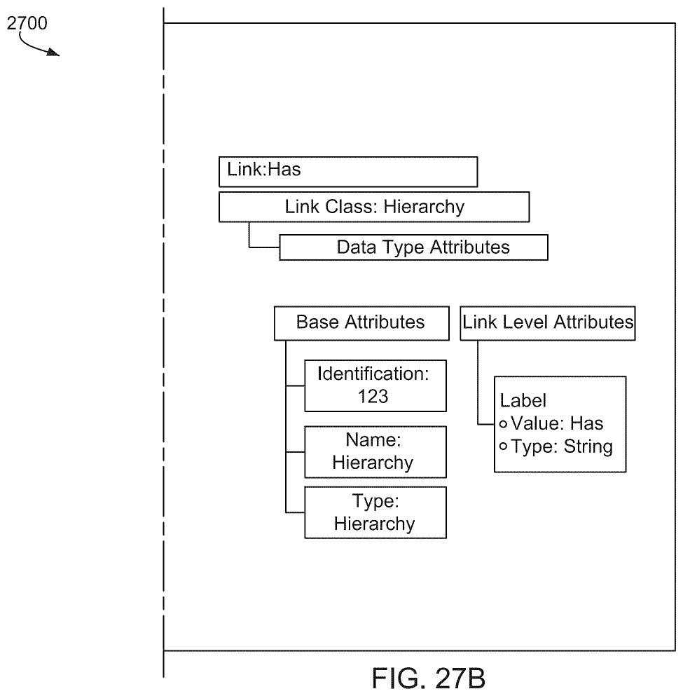

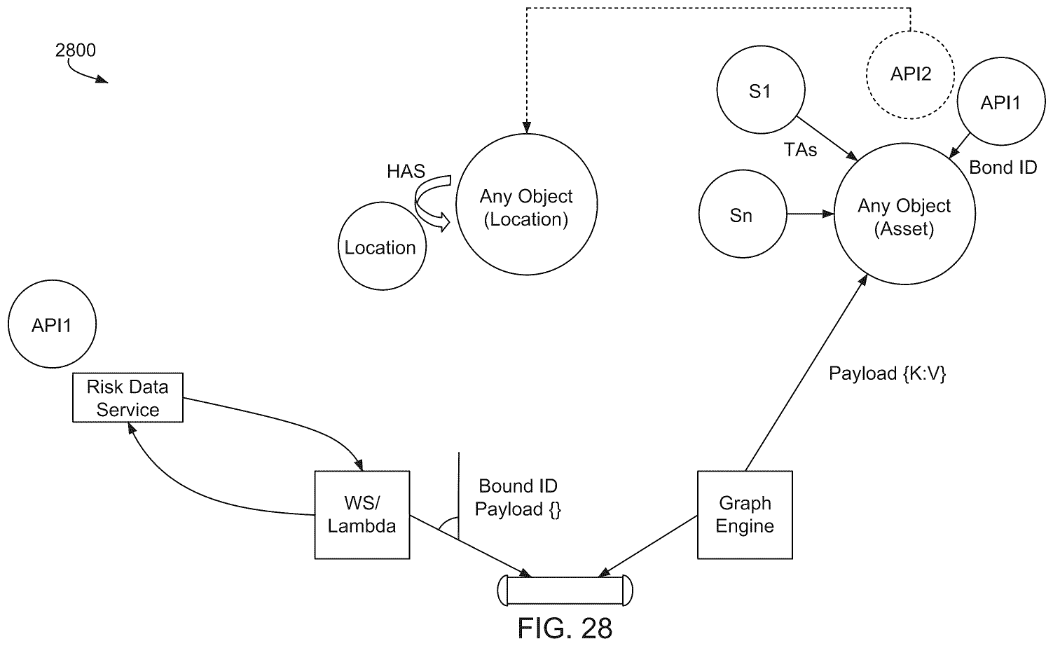

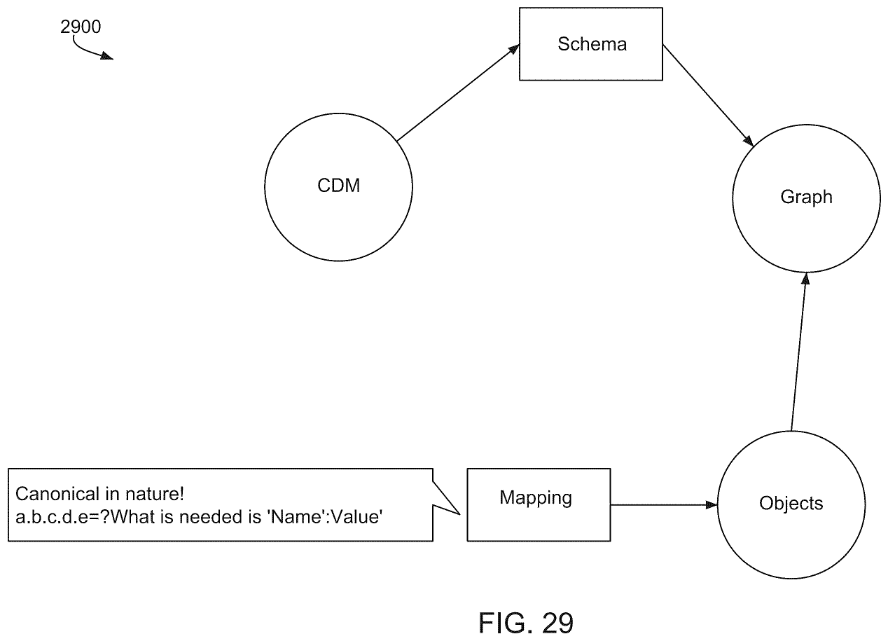

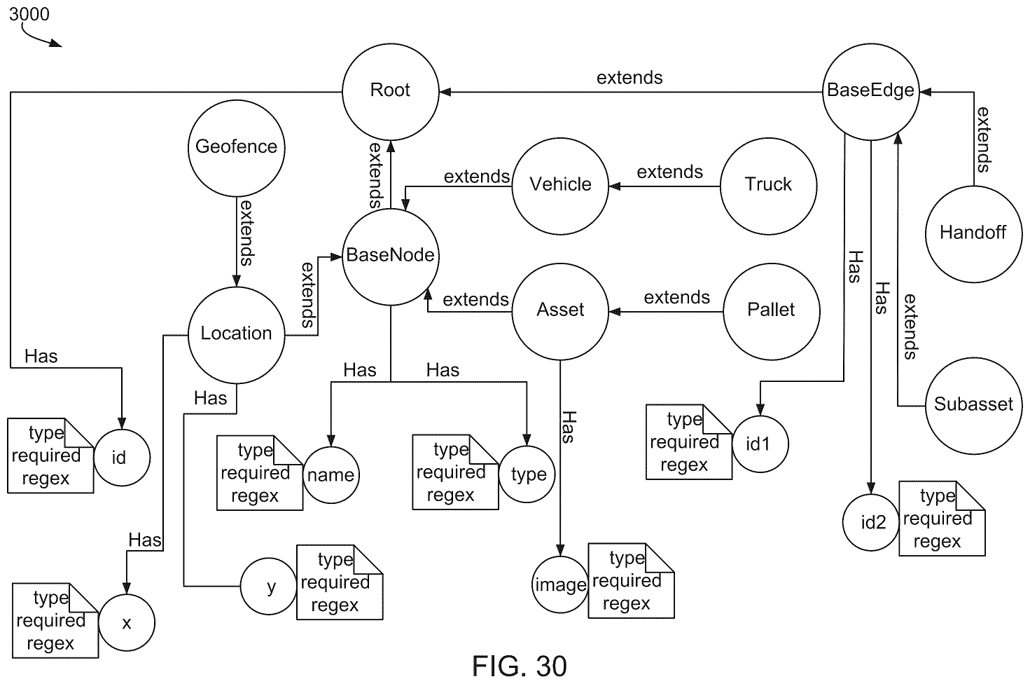

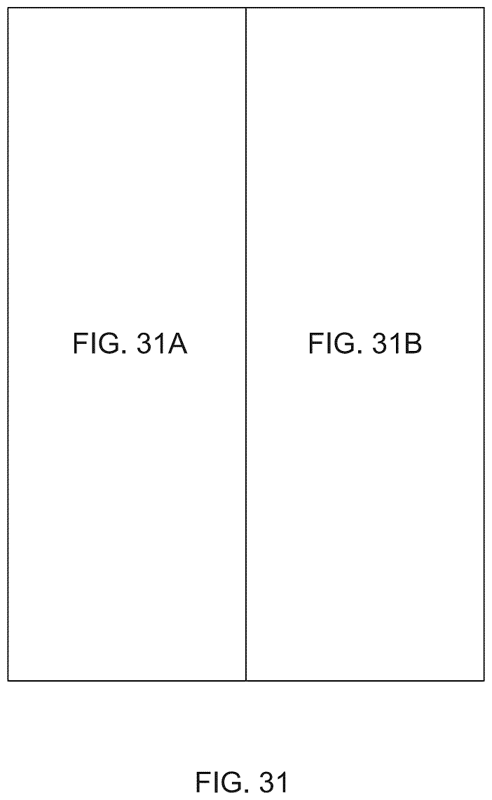

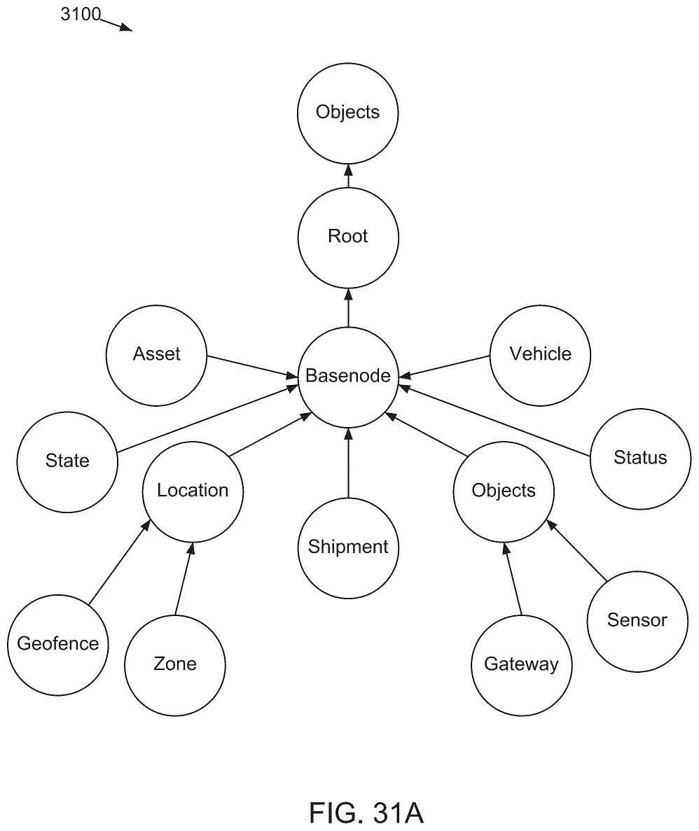

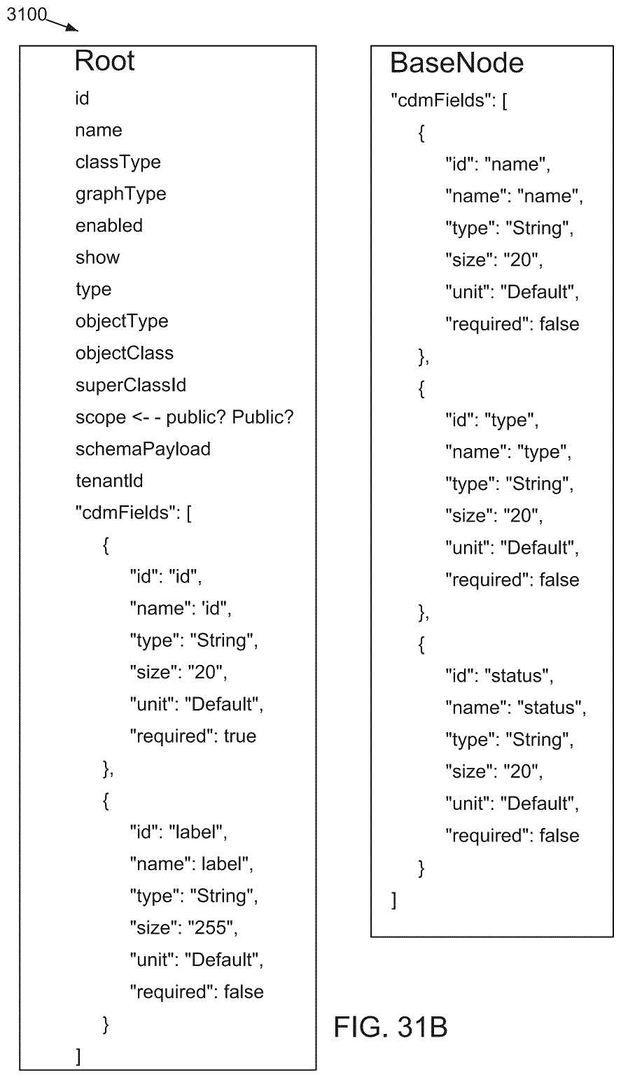

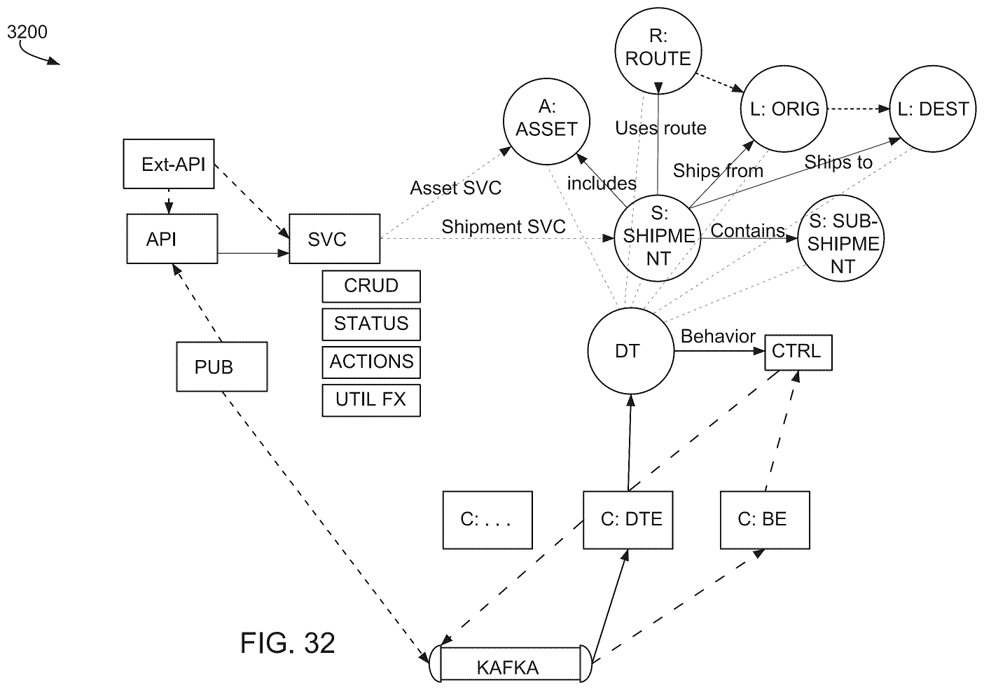

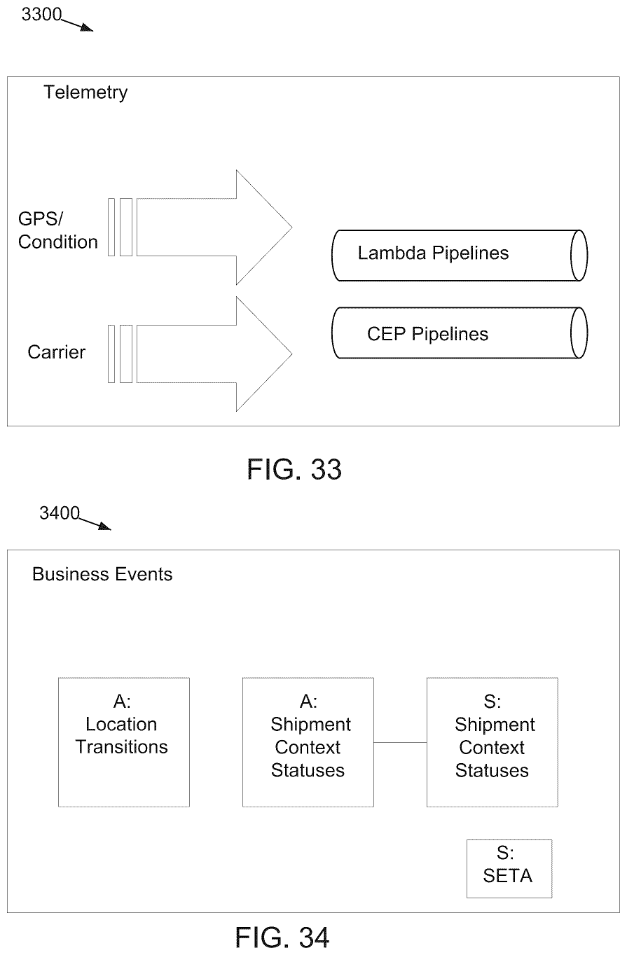

Referencing FIG. 22, an illustration 2200 schematically depicts a DT core module for implementing an application (App) on the platform 102. Referencing FIG. 23, an illustration 2300 depicts DT core module architecture. Referencing FIG. 24, which is divided into FIGS. 24A and 24B, an example illustration 2400 schematically depicts a database abstraction for a DT core library. Referencing FIG. 25, an illustration 2500 schematically depicts an object class organization. In certain embodiments, an object class is a blueprint for objects utilized in a DT, for example an object class may be a “vehicle,” where each object class is a physical or logical object, and where the object class supports a data structure to capture multiple dimensions of data of a supply chain object and relationships between the object and other objects in the DT. Referencing FIG. 26, an illustration 2600 schematically depicts a link class organization. In certain embodiments, a link class is a blueprint for relationships utilized in a DT, for example a link class may be “contains”, for example where a pallet object contains a package object. In certain embodiments, a link class may be a relationship (e.g., a hierarchy, flow, network, or location) or a rule. Referencing FIG. 27, which is divided into FIGS. 27A and 27B, an example illustration 2700 schematically depicts a common data model for an object class (e.g., FIG. 27A) or a link class (e.g., FIG. 27B). Referencing FIG. 28, an example illustration 2800 depicts a number of example objects, relationships, and/or proxies, which may be a part of a DT as set forth herein. Referencing FIG. 29, an example illustration 2900 depicts a schema abstraction for objects. Referencing FIG. 30, an example illustration 3000 depicts an example schema model, including a number objects and relationships that may form a part of a DT as set forth herein. Referencing FIG. 31, which is divided into FIGS. 31A and 31B, an example illustration 3100 depicts an example schema model graphically (FIG. 31A) and partial code implementation (FIG. 31B). Referencing FIG. 32, an example illustration 3200 depicts an example shipment flow, which may include ingestion of supply chain execution values 6016 (e.g., carrier data, GPS data, condition data-reference FIG. 33), and determines related business events (reference FIG. 34), for example to implement a shipment object in a DT as set forth herein.

Referencing FIG. 35, an example illustration of various DT 3500 types is schematically depicted. The example includes a DT embodied as a network of nodes and links, where each node in the network is an object belonging to an object class, and where each link in the network is a relationship belonging to a link class. In the illustration, a DT 3500 can be a discrete DT, including a physical discrete DT or a logical discrete DT (or process logical discrete DT), or a process DT, including a discrete process DT or a logical process DT. Certain DTs may be an operations DT (e.g., implementing operational aspects of a supply chain model) or an organizational DT (e.g., coordinating DTs to implement the supply chain model).

Referencing FIG. 36, an example illustration depicts a layered DT 3600. The example layered DT is a hierarchical layered DT, where upper layers provide commands to lower layers, and lower layers provide feedback to higher layers. In the example of FIG. 36, a first layer 3601 is a process logical DT, a middle layer 3603 is a discrete logical DT, and a lower layer 3605 is a discrete physical DT.

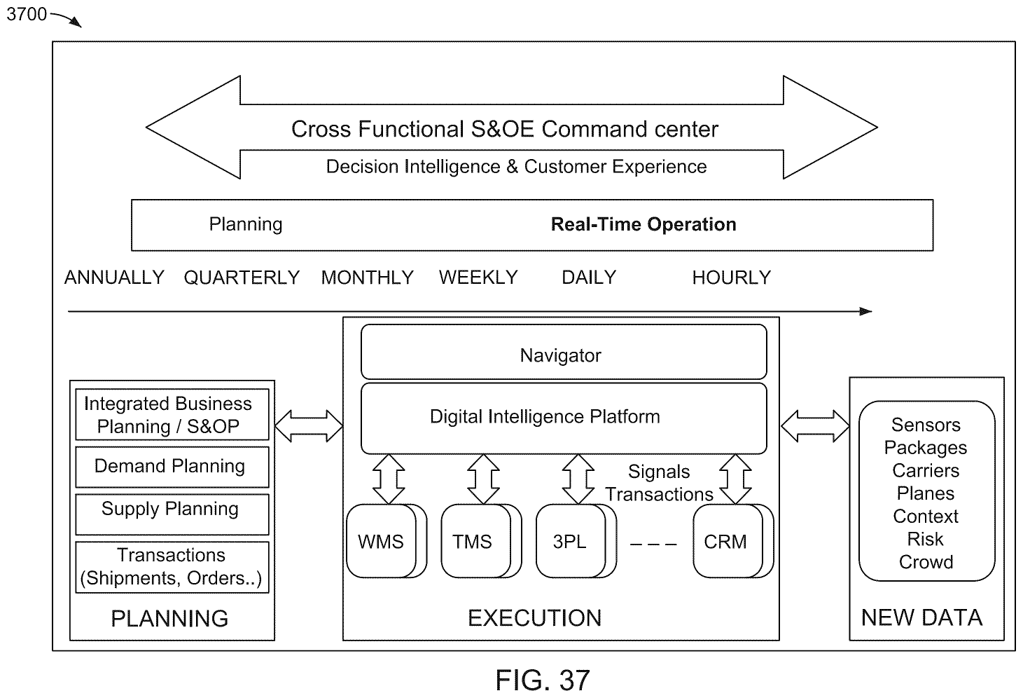

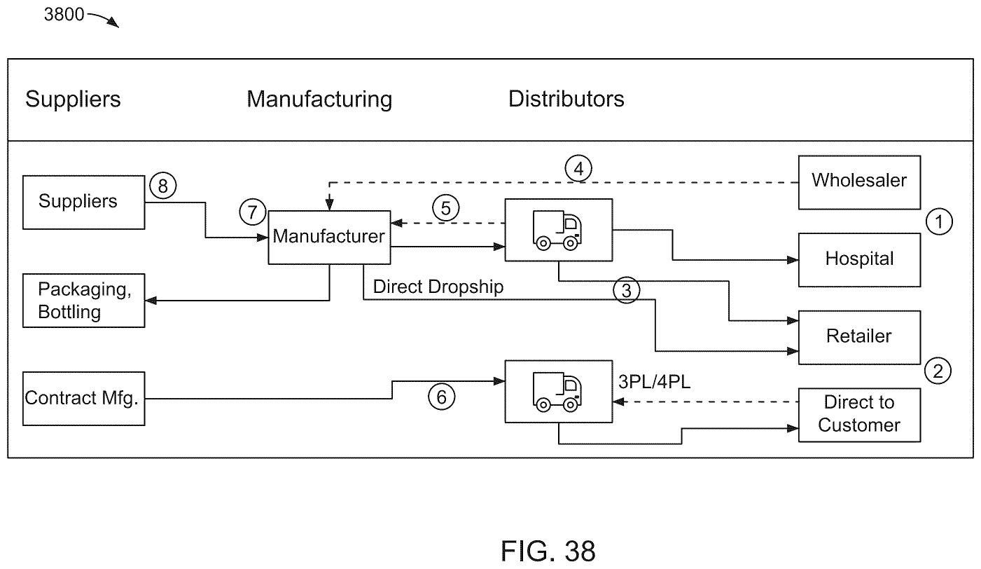

Referencing FIG. 37, an example illustration 3700 depicts a schematic overview of operations of a supply chain command platform 102, supporting operations for planning and real-time operations for a physical supply chain 104, organized into a planning section, an execution section, and a new data section. Referencing FIG. 38, an example illustration 3800 of a physical supply chain 104 layout, where the supply chain command platform 102 supports operations to improve service levels to wholesalers, improve patient outcomes (e.g., for a medical service related supply chain), to provide intelligence for carrier performance, service level agreements, route and/or lane intelligence, to provide iterative improvement and/or optimization for storage, overflow, quality, and compliance (e.g., regulatory, industry standard, and/or policy compliance), to provide iterative improvement and/or optimization for costs by improving visibility across nodes of the physical supply chain 104, reduction of expediting costs (e.g., for contract manufacturing and/or emergency shipments), to schedule and/or plan attainment with manufacturers, and/or to manage supplier risks and variability. In the example of FIG. 37, products and/or deliverables pass on the solid lines progressing to the right, and information (e.g., feedback values and/or supply chain execution values 6016) pass on the dashed lines progressing to the left.

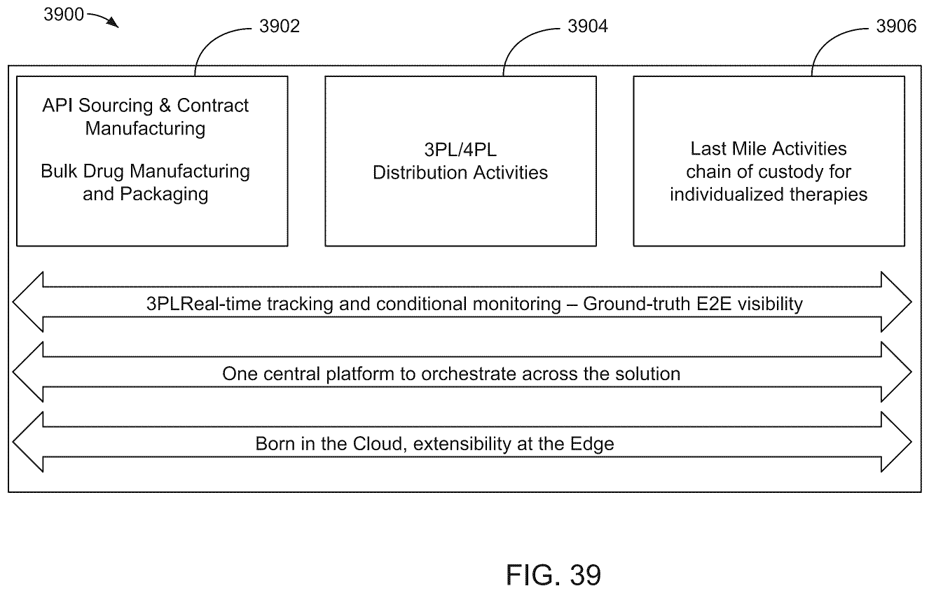

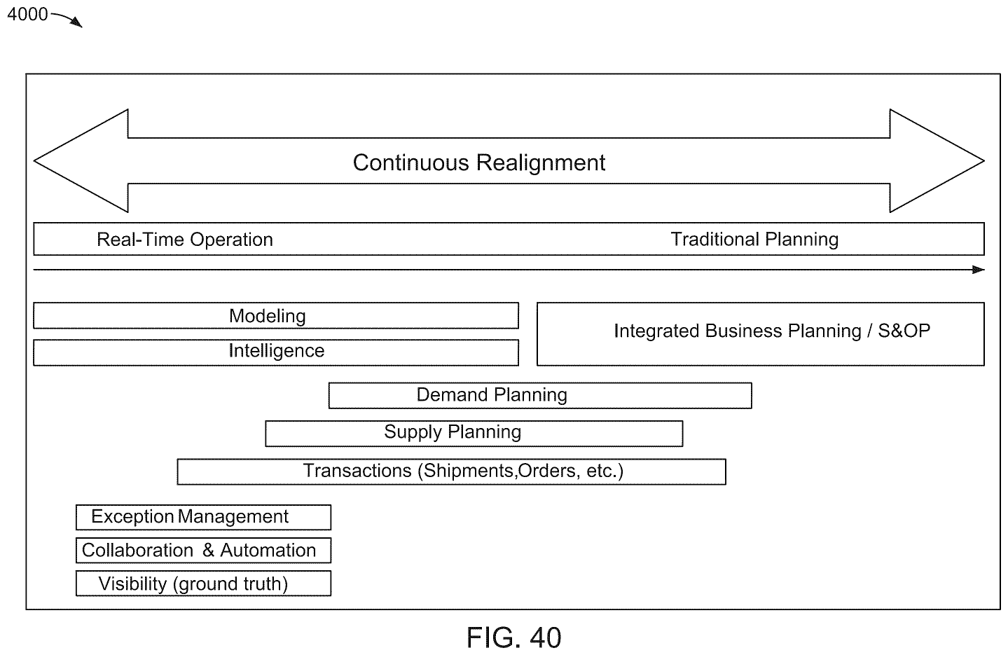

Referencing FIG. 39, an example illustration 3900 schematically depicts a physical supply chain 104 ecosystem, for example a pharmaceutical supply chain. The example illustration 3900 includes a logical arrangement having including sourcing and manufacturing 3902, distribution activities 3904, and last mile activities 3906. Example functions and benefits of the system, for example as managed by a supply chain command platform 102 as set forth herein, are depicted schematically, with visibility and coordination across the ecosystem. Referencing FIG. 40, an illustration 4000 includes a schematic depiction of benefits to a physical supply chain 104, including functions performed by the supply chain command platform 102.

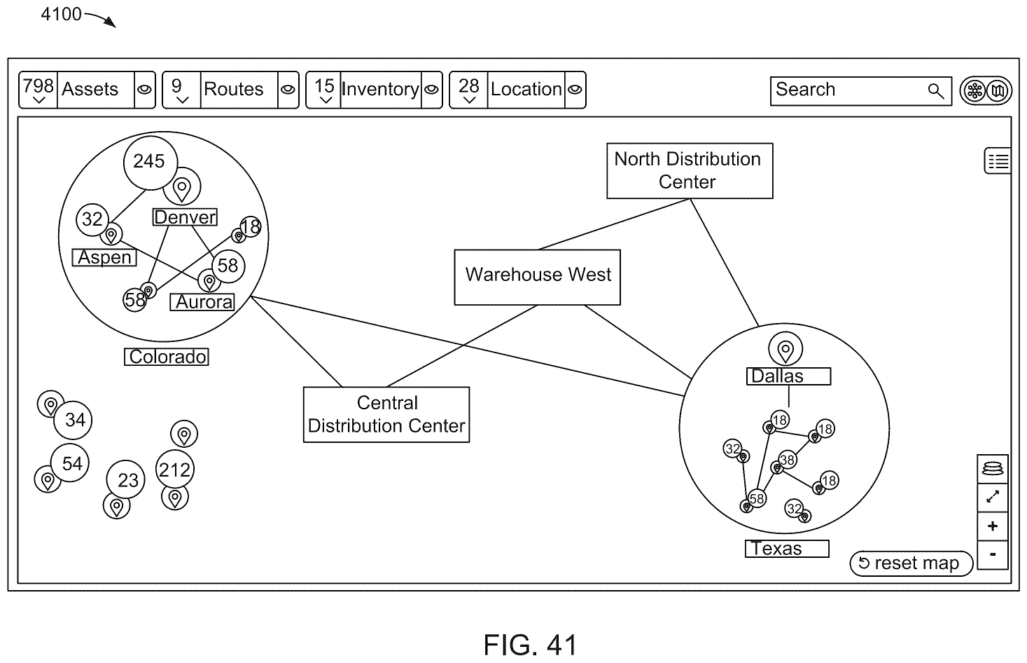

Referencing FIG. 41, an example illustration 4000 schematically depicts elements of a DT and/or supply chain model 6010 according to certain embodiments of the present disclosure. The example DT includes a virtual representation (e.g., a visual model 6008) that serves as a real-time counterpart of the physical objects and/or processes, providing the ability for analytics to understand current or past performance and predicting future performance. The DT, as implemented herein, allows for visualization of supply chain elements in real time, promotion of traceability and managing complexity by connecting disparate systems and providing insights into those connections, refinement of assumptions (and/or replacing assumptions with data where applicable) utilizing predictive analytics, and automating workflows (e.g., as supply chain response actions 6022) for rapid response to disruptions and/or off-nominal events, and to allow users to avoid sinking time into implementing response activity. An example DT includes a catalog (and/or is built utilizing a catalog), a topology (e.g., entities and links), signal integration (e.g., retrieving supply chain execution values 6016), and/or recipes (e.g., catalog elements, pre-built behaviors, pre-built relationships, user stored versions of these, etc.).

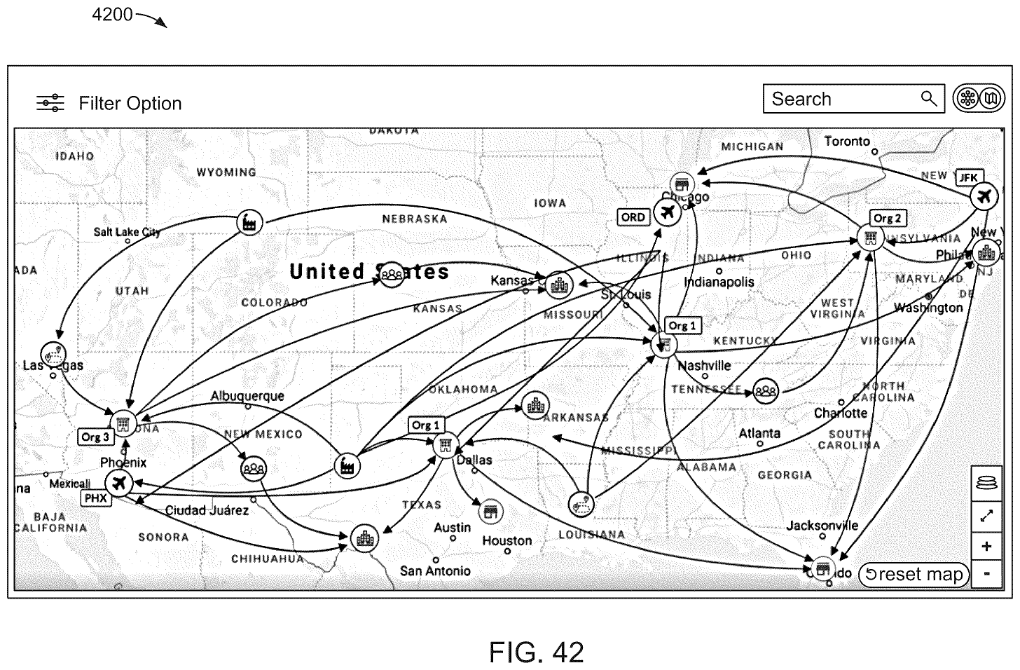

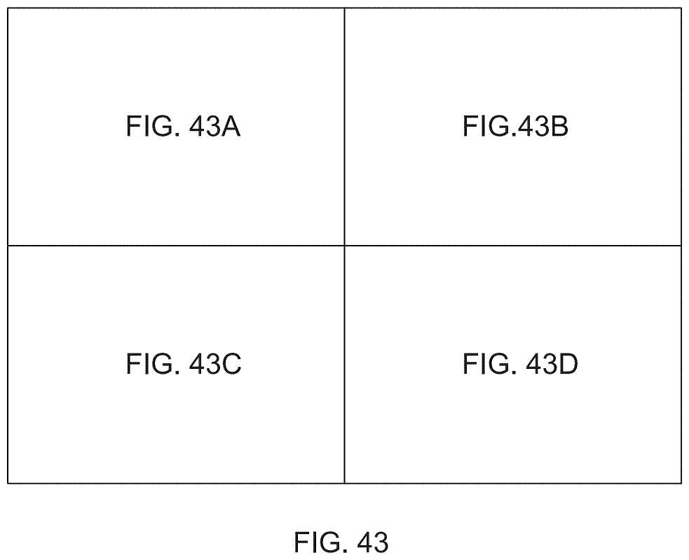

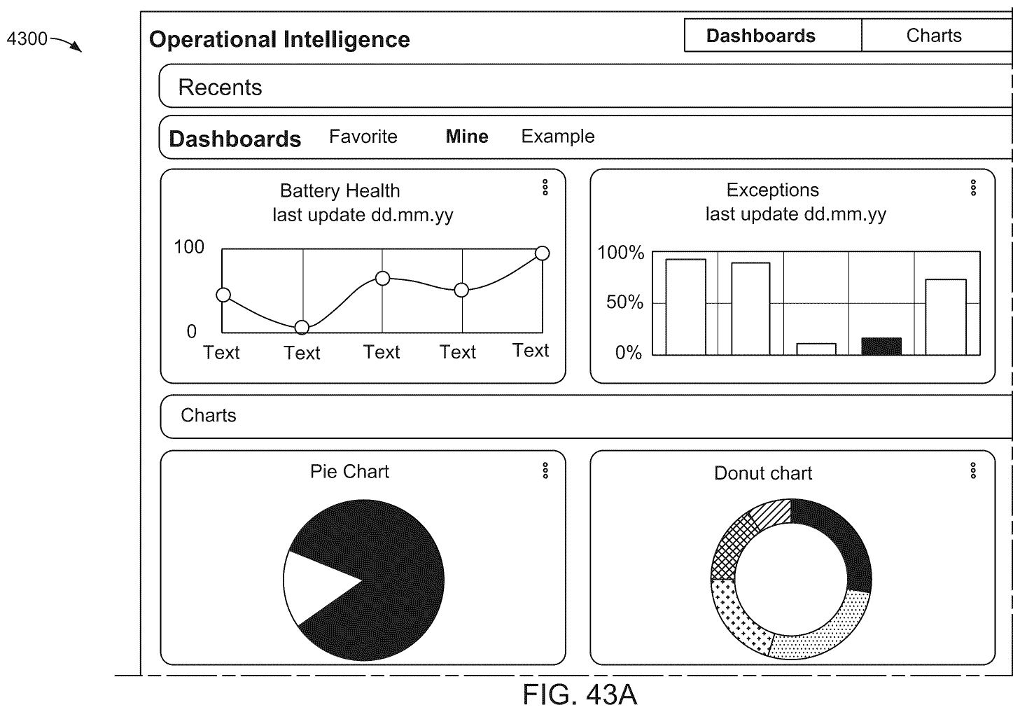

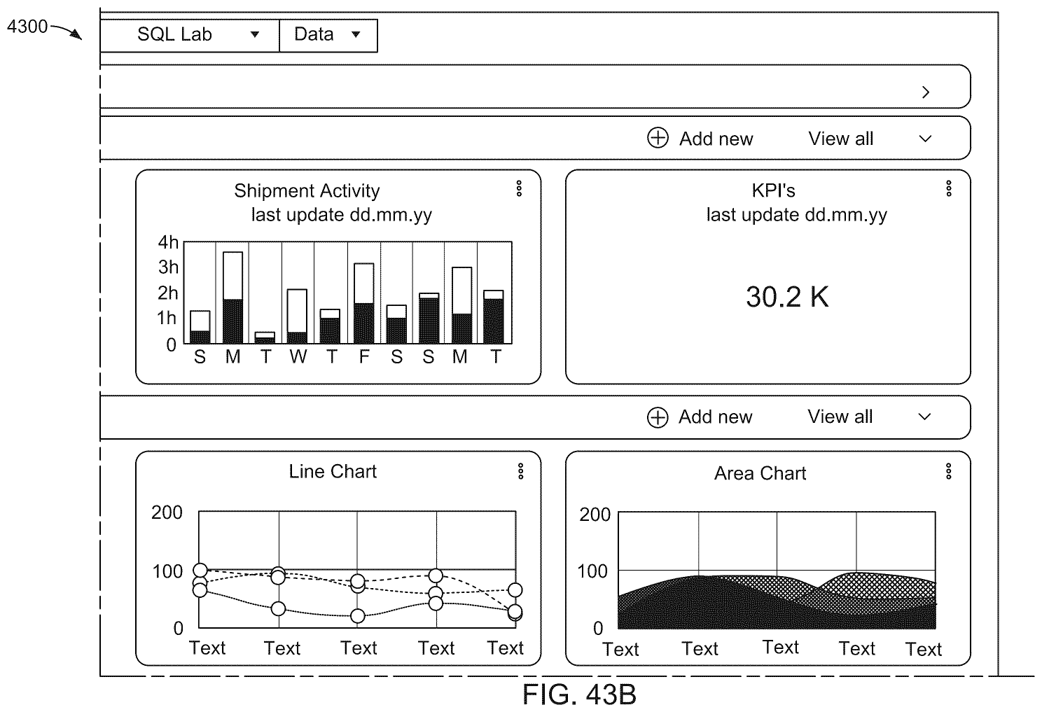

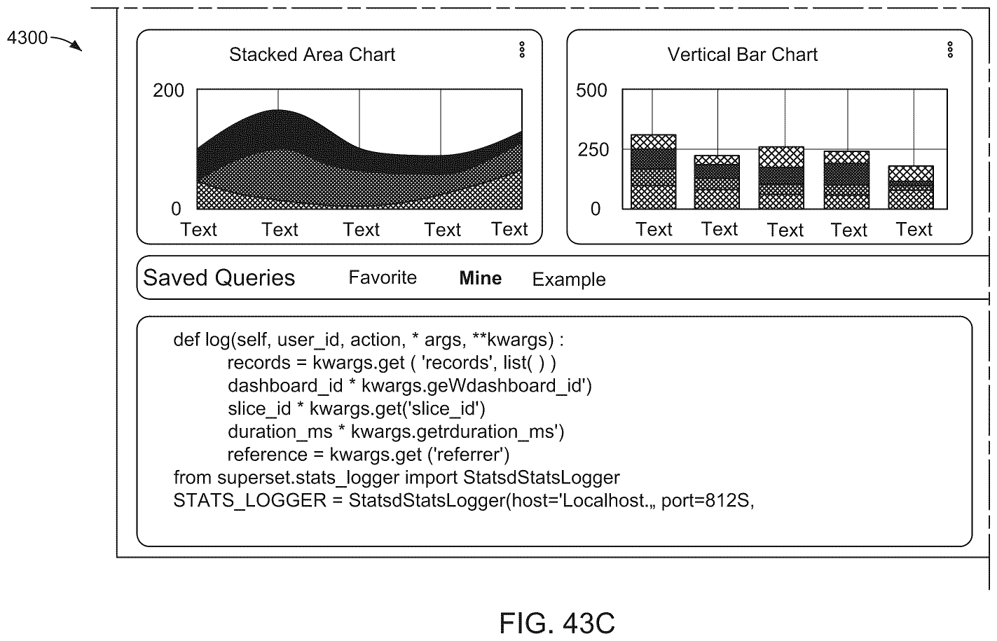

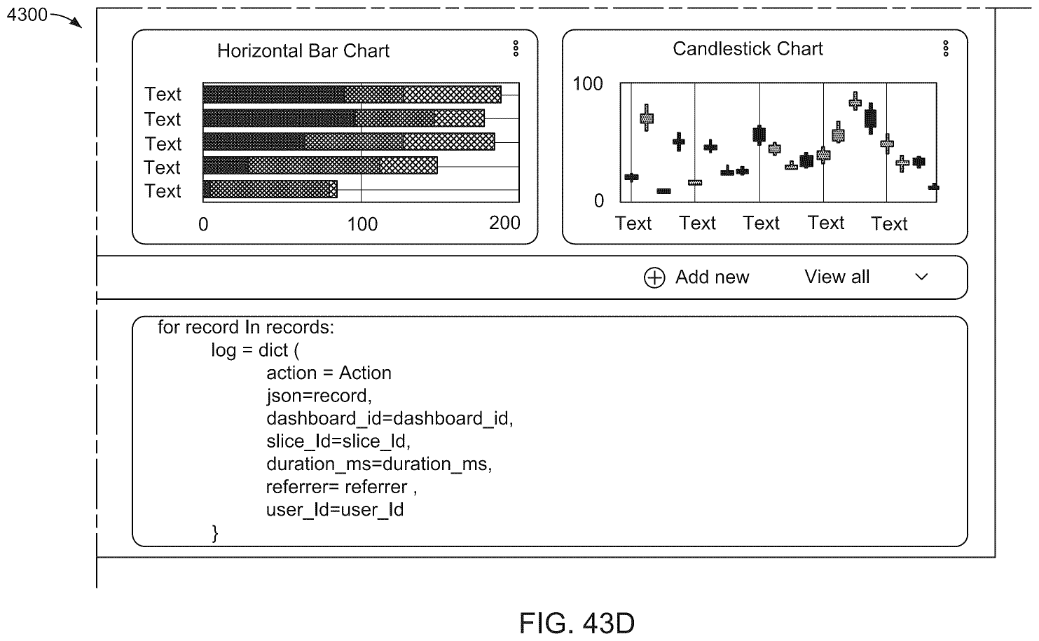

Referencing FIG. 42, an illustration 4200 depicts a schematic view of a DT of a physical supply chain, including a number of nodes and connections therebetween. Referencing FIG. 43, an example illustration, divided into FIGS. 43A to 43D, depicts an example dashboard with information about the performance of a physical supply chain 104 determined utilizing a supply chain model 6010 and supply chain execution values 6016. In certain embodiments, a dashboard such as depicted in the illustration 4300 may be provided to a runtime interface 6028. The example elements of the dashboard illustrate certain example capabilities of embodiments herein, and are non-limiting.

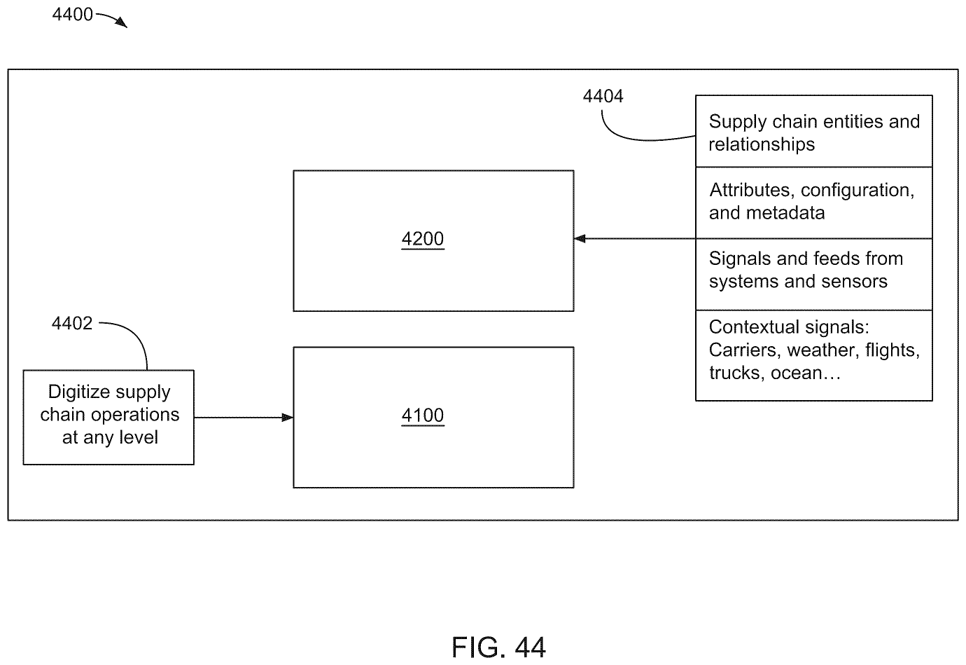

Referencing FIG. 44, an illustration 4400 depicts a schematic view of features of a dashboard and/or runtime interface 6028. The example illustration 4400 includes an illustration 4200 depicting aspects 4404 such as entities and relationships, attributes and configuration information for the entities, signals and feeds from systems and sensors (e.g., as supply chain execution values 6016), and/or contextual signals. The example illustration 4400 includes an illustration 4100 depicting digitized 4402 supply chain operations at a selected level.

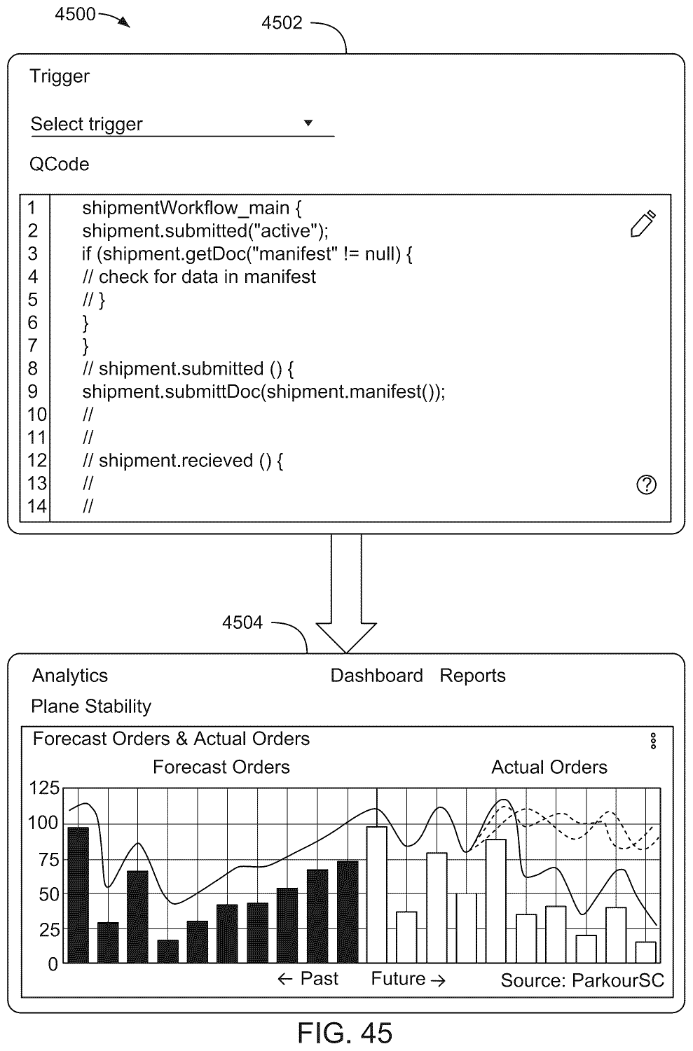

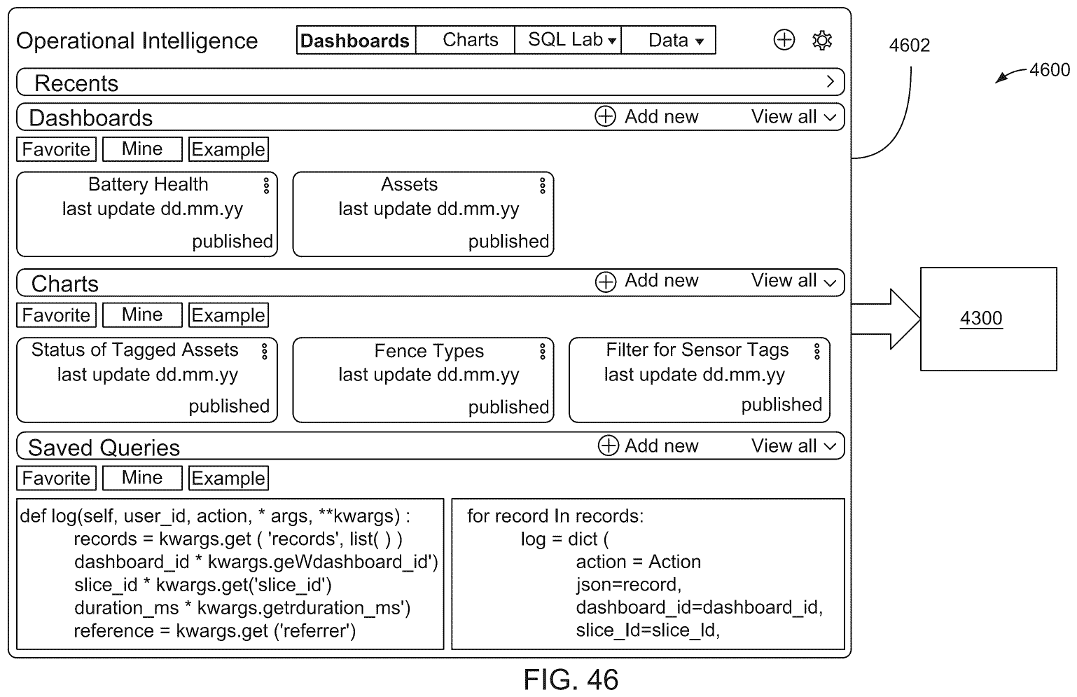

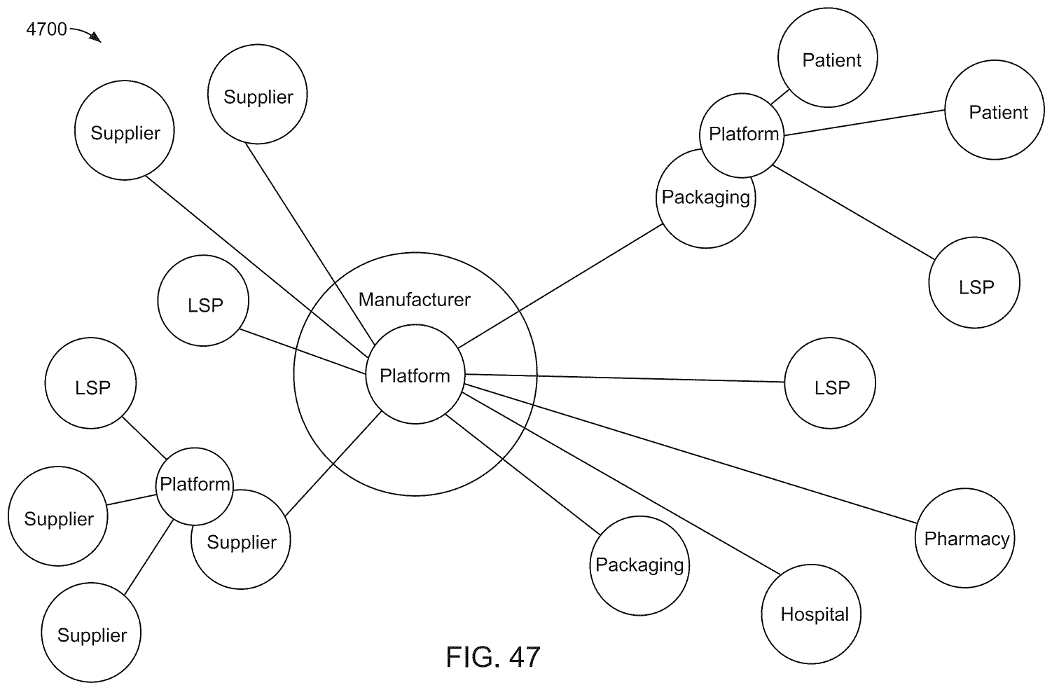

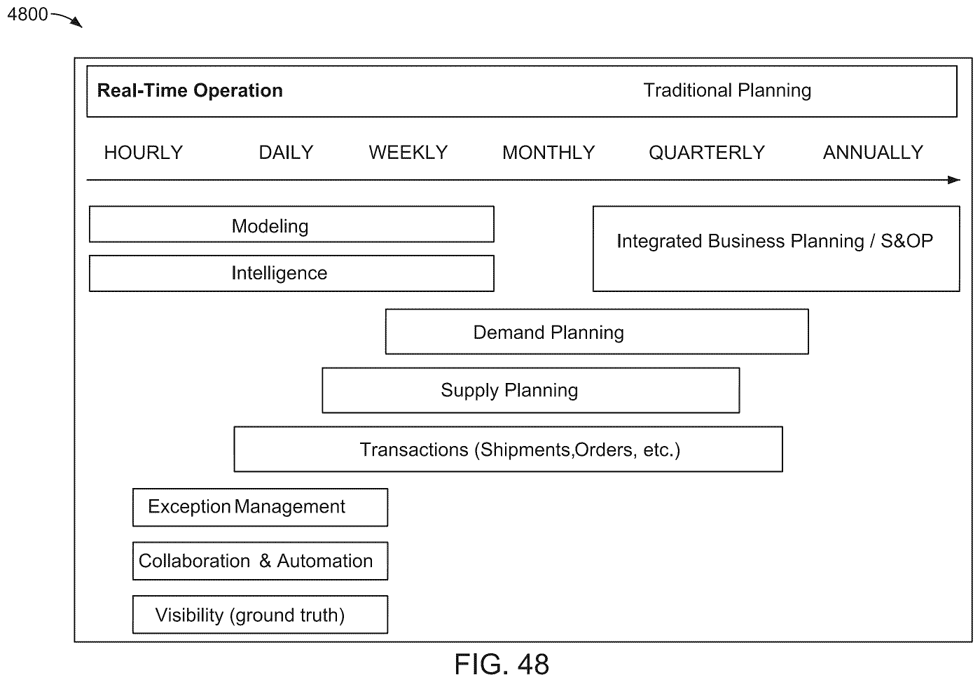

Referencing FIG. 45, an example illustration 4500 includes aspects of a dashboard, for example on a runtime interface 6028, with a first portion 4502 including a supply chain response action 6022 builder (e.g., allowing for the selection of triggers and response actions) and a second portion 4502 including an analytics view (e.g., a selected report, for example provided by a behavior of an entity (e.g., reference FIG. 6) and/or provided as a supply chain response action 6022). Referencing FIG. 46, an example illustration 4600 includes aspects of a dashboard, or example on a runtime interface 6028, with a first portion 4602 including an operational intelligence component, which may be embodied in whole or part by a supply chain management component 6020, that allows for user operations such as a dashboard builder, a chart builder, and/or a query engine, and the illustration 4300 depicting example dashboard elements. Referencing FIG. 47, an example illustration 4700 includes an example network of DTs, for example wherein the supply chain model 6010 is a DT that includes the network of DTs, and where different users (e.g., a manufacturer, supplier, etc.) may be able to view and/or interact with relevant portions of the network of DTs. Referencing FIG. 48, an example illustration 4800 includes a schematic depiction of available functions of an example supply chain command platform 102, for example selectively provided to a build interface 6004 or a runtime interface 6028, allowing for planning operations for the physical supply chain 104, and/or allowing for runtime operations, monitoring, and responding to events.

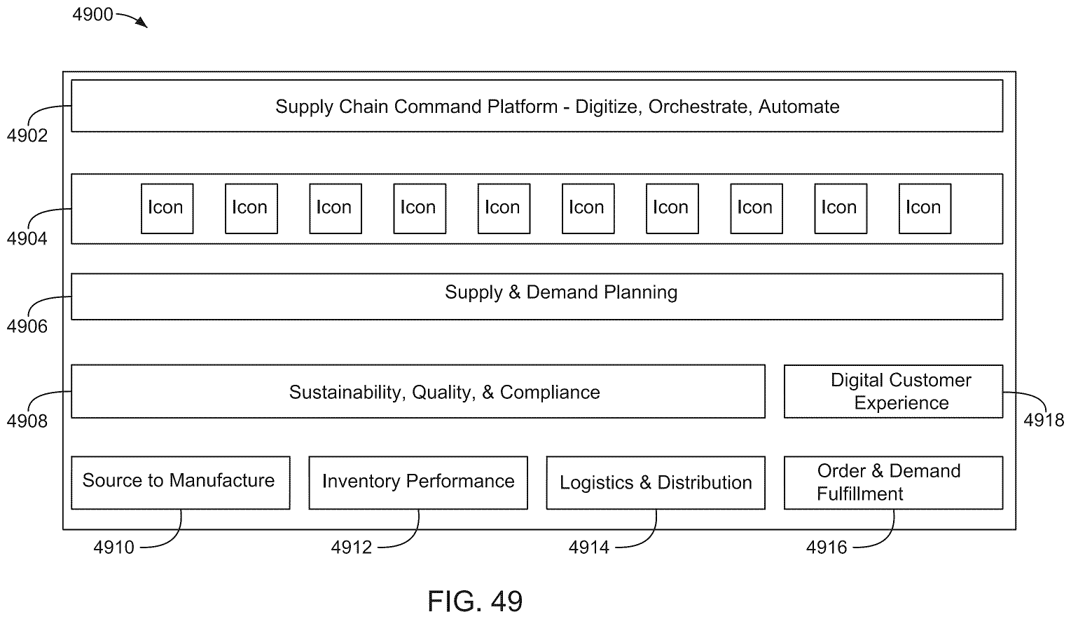

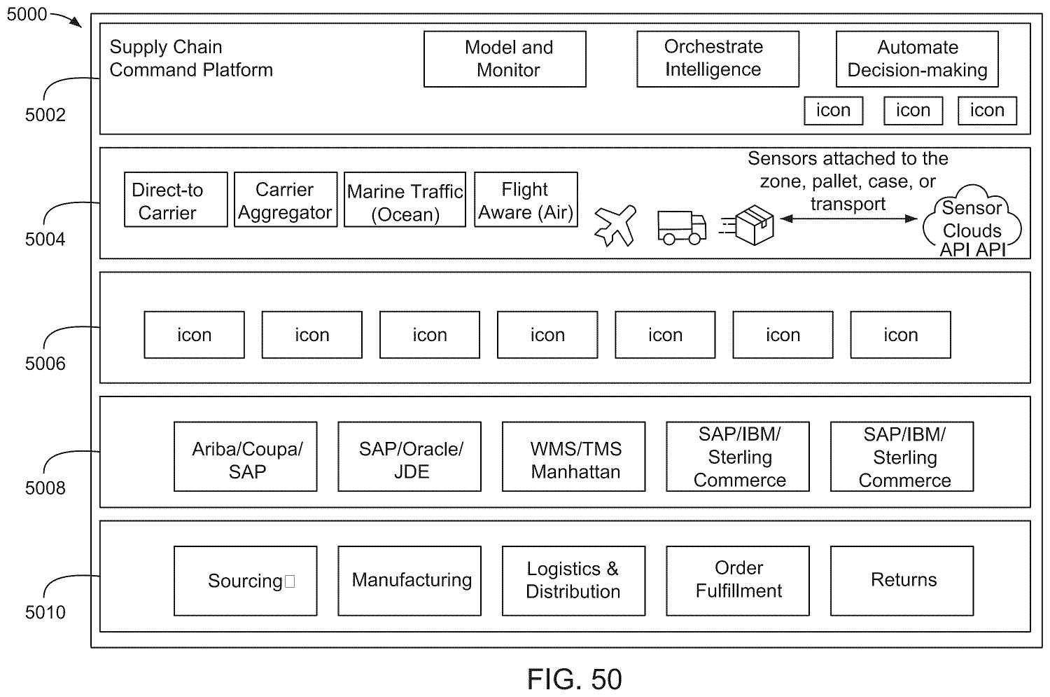

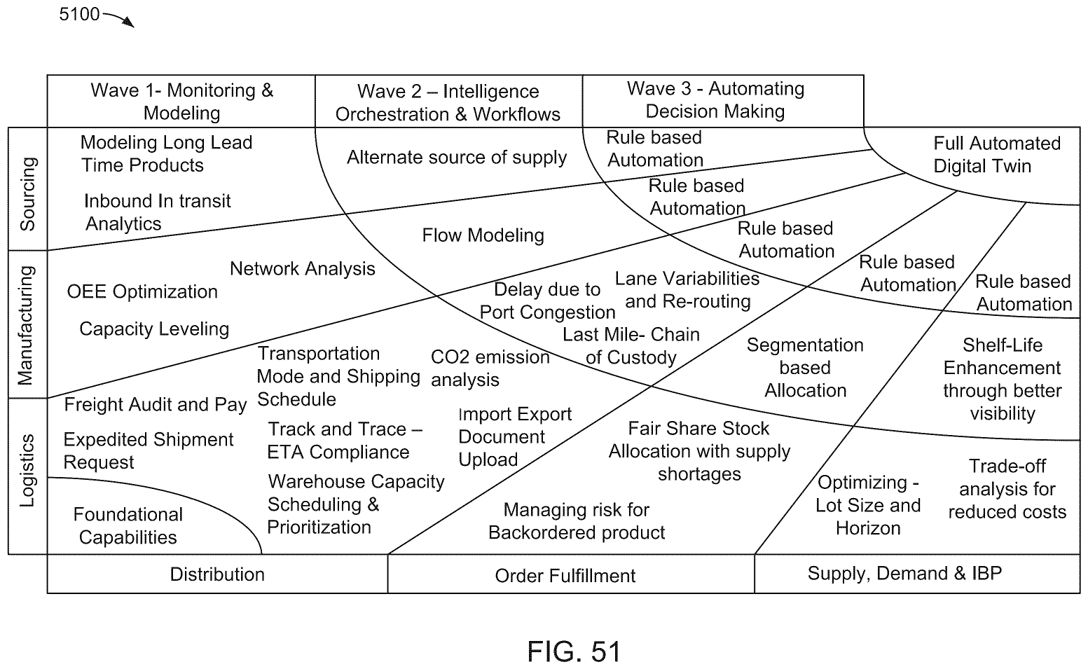

Referencing FIG. 49, an example illustration 4900 schematically depicts capabilities of a supply chain command platform 102, including a platform layer 4902, entity layer 4904, supply and demand planning layer 4906, a layer 4908 to support sustainability, quality, and compliance, source to manufacture tracking 4910, inventory performance tracking 4912, logistics and distribution support 4914, order and demand fulfillment tracking 4916, and digital customer experience management 4918. The example illustration 4900 depicts a functional view of a supply chain command platform 102, illustrating functions that may be of interest to certain users. In certain embodiments, functions of the illustration 4900 may be performed by embodiments of a supply chain command platform 102 set forth in the present disclosure. Referencing FIG. 50, an example illustration 5000 schematically depicts capabilities of a supply chain command platform 5002, which may be embodied in whole or part by a supply chain command platform 102, with a data layer 5004 that provides supply chain execution values 6016, an entity layer 5006, a planning layer 5008, and a functional operations layer 5010. The example illustration 5000 depicts a functional view of a supply chain command platform 5002, illustrating functions that may be of interest to certain users. Referencing FIG. 51, an illustration 5100 schematically depicts a capability matrix for a supply chain command platform 102, separated into modeling and monitoring capabilities, intelligence orchestration and workflow capabilities, and automated decision making capabilities. In certain embodiments, a supply chain command platform 102 may be configured to provide any one or more, or all, of the capabilities depicted on the illustration 5100. The illustration 5100 depicts the matrix with an actor dimension (e.g., logistics, manufacturing, and sourcing) and an action dimension (e.g., distribution, order fulfillment, and supply, demand, and integrated business planning (IBP)).

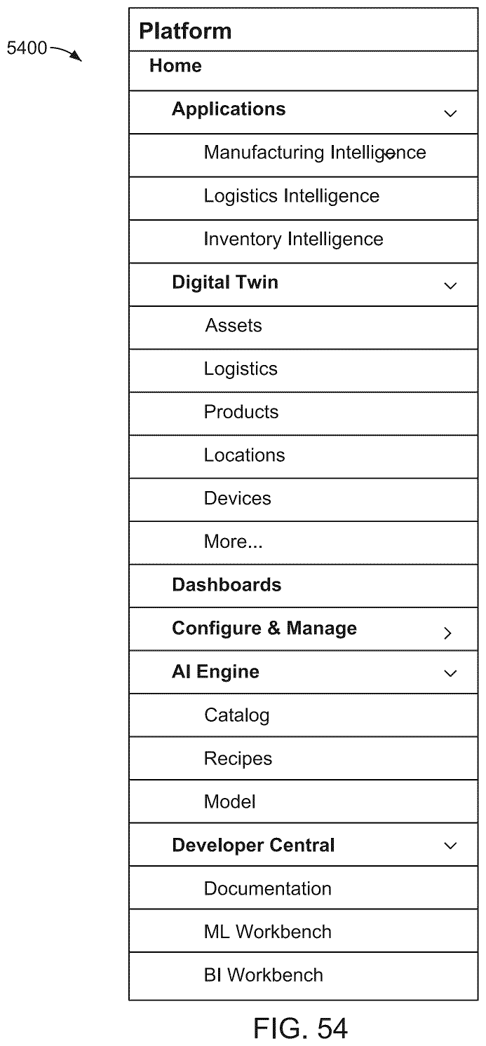

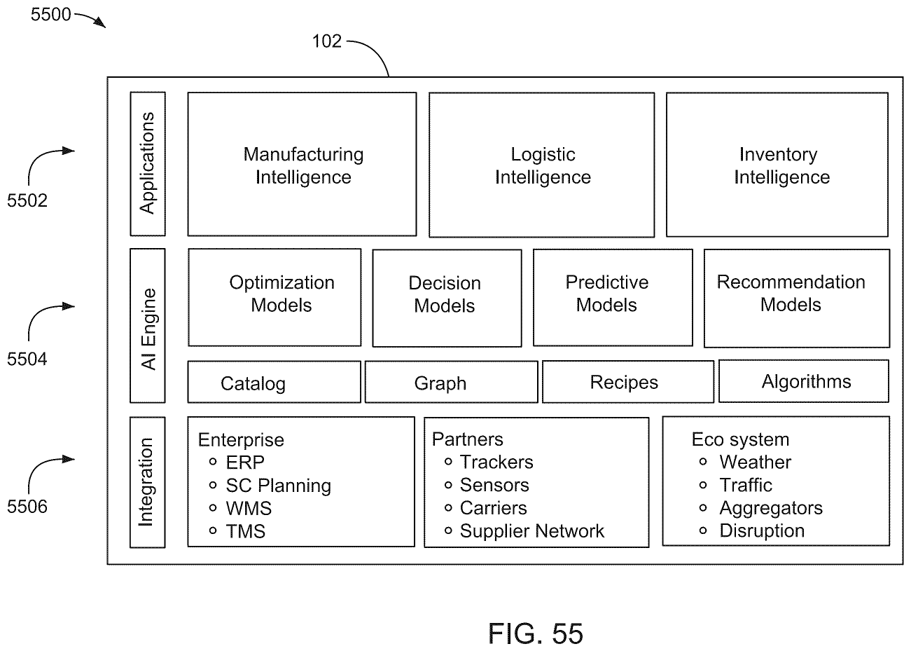

Referencing FIG. 54, an example menu 5400, for example provided to a build interface 6004 and/or runtime interface 6028, is schematically depicted. Referencing FIG. 55, an example illustration 5500 of a supply chain command platform 102 is schematically depicted. The example supply chain command platform 102 is logically organized into an application layer 5502, for example providing manufacturing intelligence, logistical intelligence, and inventory intelligence capabilities, an AI engine layer 5504 providing capabilities for iterative improvement and/or optimization, decision models, predictive models, recommendation models, and operations to implement a catalog, graphs or visualizations, recipes, and/or algorithms. The example supply chain command platform 102 includes an integration layer, for example setting up connections to ingest supply chain execution values 6016. The illustration 5500 depicts a functional view of a supply chain command platform 102, illustrating functions that may be of interest to certain users.

The figures and descriptions following describe a number of example embodiments of a supply chain command platform 102 having a number of components and/or managers configured to perform selected operations of the supply chain command platform 102. In certain embodiments, aspects of the supply chain command platform 102 and/or the components or managers thereof, may be embodied in whole or part by one or more systems set forth preceding. Certain aspects of the present disclosure are set forth as procedures to perform selected operations, which may be performed, in whole or part, by the supply chain command platform 102 and/or components and/or managers thereof.

Referencing FIG. 56, an example system 6000 includes a supply chain command platform 102 configured to build a supply chain model 6010. A supply chain model 6010, as utilized herein, includes a model of at least a relevant portion of a physical supply chain 104, allowing for various operations such as monitoring the performance of the physical supply chain 104, determining when off-nominal conditions are likely to affect the performance of the physical supply chain 104, quickly and/or automatically determine the consequences of off-nominal conditions for the physical supply chain 104, and quickly and/or automatically perform mitigating or corrective actions that preserve the performance of the physical supply chain 104, and/or minimize negative consequences of the off-nominal conditions to the physical supply chain 104.

The example supply chain command platform 102 includes an interface manager 6002 configured to implement a build interface 6004, and to build a visual model 6008 in response to user operations on the build interface 6004. For example, a build interface 6004 may be implemented on a user device, through a web portal, through a mobile application, as a proprietary application, as a cloud serviced application, or the like. The visual model 6008 includes the schematic depiction of the supply chain model 6010 as seen by the user, allowing the user to see and adjust attributes, relationships, and/or related code aspects, of objects and/or links making up the supply chain model 6010, as well as allowing the user to add or remove objects or links from the visual model 6008.

The example supply chain command platform 102 includes a supply chain model creation component 6006 configured to determine a supply chain model 6010 in response to the visual model 6008. For example, the supply chain model creation component 6006 may parse the visual model 6008, compile code elements, configure execution parameters, manage memory allocations, or the like, to convert the visual model 6008 into an executable supply chain model 6010.

The example supply chain command platform 102 includes a supply chain model execution component 6012 configured to operate the supply chain model 6010 as a digital twin (DT) of at least a portion of a physical supply chain 104, for example the portions of the physical supply chain 104 that are relevant to the user, an entity or organization associated with the user, a particular product, a manufacturing facility, a manufacturing line, and/or any other organizational element having an associated supply chain. The DT can model any aspects of the supply chain, including for example supply of resources, goods, pre-cursor materials, etc., shipping of materials at the end points (e.g., from a supplier, to a final consumer) and/or between stages within the supply chain, hold times and/or processing of materials, a condition of the materials throughout the supply chain (e.g., conditions experienced such as temperatures, humidity levels, aging, shelf life management, etc.), inventory levels, supply considerations, demand considerations, requirements for any aspect of the supply chain (e.g., certifications, verifications, storage requirements, etc., which may be determined from regulations, industry standards, user-defined requirements, and/or policies set by the user and/or an organization associated with the user, etc.). In certain embodiments, the DT can model business considerations, for example including storage levels and capacity at facilities, inventory management strategies, product and/or market segmentation effects (e.g., on manufacturing lines, demand considerations, pricing considerations, providing sufficient materials for various later stages in the supply chain, etc.), logistical limitations or effects within the supply chain (e.g., the availability of shipping providers, the effect of adjusting purchasing volumes, limitations of manufacturing lines, and/or effects of changing these, including dynamic or transient effects, effects from an absolute change, and/or effects based on the rate of change), lead times for changes, and/or physical models (e.g., a temperature model for a shipment or product). An example supply chain model 6010 and/or DT can include modeling, estimation, and/or consideration of any aspect of the physical supply chain 104 as set forth throughout the present disclosure.

The example supply chain model execution component 6012 interprets supply chain execution values 6016, for example during runtime operations (e.g., while executing the supply chain model 6010 or DT), and provides a notification to a user of the supply chain command platform 102 in response to a comparison of the supply chain model 6010 and the supply chain execution values 6016. In certain embodiments, for example where notifications are provided to the build interface 6004 and/or runtime interface 6028, the supply chain model execution component 6012 provides a notification to the user by providing the notification to the interface manager 6002, that provides the notification to the user (e.g., highlighting an aspect of the visual model 6008, providing a notification icon, sending the notification through a messaging facility of the platform 102, etc.). In certain embodiments, the supply chain model execution component 6012 provides a notification to the user by sending a text, e-mail, using a messaging application, etc. to provide the notification to the user. In certain embodiments, the notification 6014 notifies the user of one or more of: detected events, a difference between the physical supply chain 104 performance and expected performance, a confirmation that the physical supply chain 104 is operating properly, an imminent event, an emerging event, the triggering of additional checks (e.g., where soft signals, external data, contextual data, etc. are utilized to perform enhanced operations to detect events), and/or any changes to the physical supply chain 104, visual model 6008, and/or supply chain model 6010.

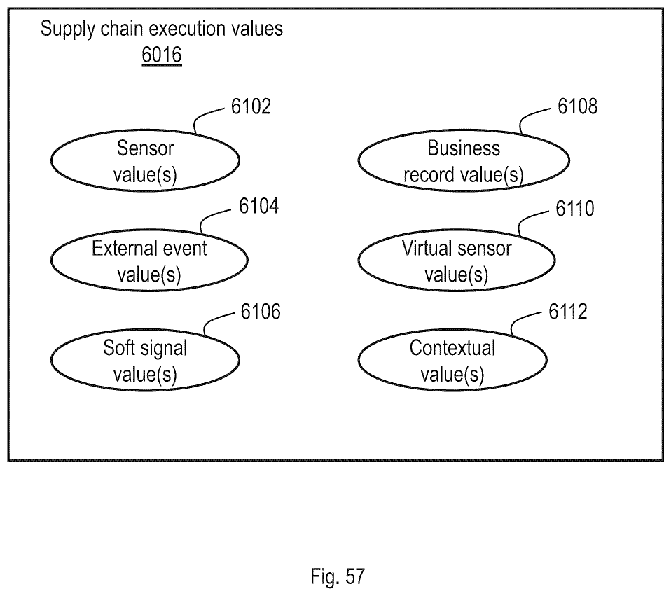

Example and non-limiting supply chain execution values 6016 include any information available about the physical supply chain 104 that is accessible to the platform 102 during runtime operations, including for example any feedback data 206 (e.g., reference FIGS. 2 and 18 and the related description). Referencing FIG. 57, example and non-limiting supply chain execution values 6016 include any one or more of the following: sensor values 6102 (e.g., data provided by any sensor to provide feedback about an aspect of the supply chain, such as temperatures, status of a component (e.g., a door position sensor), pressures, humidity, acceleration, etc.); external event values 6104 (e.g., weather information, relevant news, social media posts and/or trends, information from a proprietary database (e.g., an industry news description, monitoring of shippers or shipping facilities, information from a proprietary detection algorithm to determine events, trends, etc. that may be relevant to the supply chain, etc.), crowd sourced information (e.g., at a site soliciting crowd based information about events or conditions that may be relevant to the supply chain), and/or subscription service information (e.g., similar list to proprietary database information, but potentially packaged or processed to highlight particular events or information, and/or based on 3^{rd} party analysis); soft signal values 6106 (e.g., information tending to indicate that a supply chain relevant event has occurred, but that is not determinative on its own, for example an event that is correlated with a supply chain disruption such as news about a potential pandemic, weather events that may affect energy prices or shipping options, political disruptions in an important jurisdiction for supply of materials, and/or stock price movements in certain sectors that may indicate a change relevant to the supply chain such as demand indicators, disruptive events, changes in the capital environment, etc.); business record values (e.g., shipping records, manufacturing records, inventory records, invoices, purchase orders, transaction information, confirmation or verification information, inspection information, pricing information, customer feedback, operator feedback, etc.); a virtual sensor value 6110 (e.g., any value determined based on other values in the system, which can include models of physical conditions, event or status values determined based on other values, which includes modeled values, inferred values, simulated values, derived values, etc.); and/or a contextual value 6112 (e.g., any value that may affect the evaluation of other values, for example correlated values where condition A affects the interpretation of condition B). In certain embodiments, the supply chain execution values 6016 may be utilized detect events, to confirm proper operation, to determine the severity or impact of an event, to trigger additional checks (e.g., a detected event that triggers gathering or utilizing additional information to perform a further check for another event), to adjust thresholds or detection processing for any event detection within the platform 102, to detect imminent events that have not occurred yet, to determine the sensitivity of any event detection (e.g., which may be utilized to determine adjust an estimated signal/noise contribution of parameters utilized to detect the event, to estimate the severity of the event, to parse competing aspects of an event with other events, etc.), to determine emerging issues (e.g., issues that have not occurred, and may not be imminent, but are becoming more likely due to other factors), to adjust a response level to an event (e.g., a graduated response, a bucket of various discrete responses, etc.), and/or to determine a confidence value associated with an event detection (e.g., a confidence that the event detection is correct, that underlying data used to detect the event is correct, and/or to provide a confidence/uncertainty curve for utilization in a technique like a Monte Carlo analysis, a Bayesian analysis, or the like). Without limitation to any other aspect of the present disclosure, the supply chain execution values 6016 may be utilized in any operations to execute the supply chain model 6010, to execute commands 6024 to respond to detected events, to operation virtual sensors, and/or to determine notification parameters for events, changes to the physical supply chain 104 and/or supply chain model 6010, and/or confirmation of proper operation of the physical supply chain 104. It will be seen that certain types of information could be considered to fit into more than one of the example categories of supply chain execution values 6016, which may further depend upon how the specific information is utilized within the supply chain model 6010. The example categories are non-limiting examples to illustrate the types of information available as supply chain execution values 6016, and the specific categorization of particular information is not important to particular embodiments. Any information that is accessible to the platform 102 (e.g., that can be converted into digital information and at least intermittently communicated to the platform 102) and utilized to perform any operations set forth throughout the present disclosure is contemplated herein as a potential supply chain execution value 6016 for embodiments herein.

An example supply chain model creation component 6006 determines the supply chain model 6010 in response to a number of linked entities representing at least a portion of the physical supply chain 104. For example, the linked entities may be objects (e.g., reference FIGS. 3, 4, 25, 28, 29, 30, 31A, 32, 35, 36, and the related descriptions), wherein each one of the linked entities includes a behavior value (e.g., including any behaviors referenced throughout the present disclosure). The example links between the entities each include a relationship value (e.g., reference FIGS. 3, 15, 16, 26, 28, 30, 32, 35, 36, and the related descriptions). The links/relationship values between entities/objects allow for passing information between entities, application of dependencies between entities, state transitions of the model/DT operations between process steps (e.g., for a process entity), or the like. The utilization of entities/objects allows for modeling of discrete objects (e.g., a single physical unit, a confirmation value, a state determination value, etc.), process objects (e.g., a workflow or sequence of operations), logical objects (e.g., non-physical or conceptual objects, state information, status information, monitoring entities, etc.), and/or physical objects (e.g., equipment, facilities, etc.) herein. In certain embodiments, an entity may be categorized in a combination of these, for example a discrete logical entity, a process logical entity, a discrete physical entity, or a logical discrete entity. In certain embodiments, an entity utilized to build the supply chain model 6010 may be considered as a DT for the associated portion of the physical supply chain 104, for example with the high level DT embodied by the supply chain model 6010 is itself a group of DTs represented by each object or entity. Further, the group of DTs forming the high level DT may be further organized, for example into interacting layers (e.g., reference FIG. 36 and the related description). Throughout the present disclosure, descriptions referencing an entity, object, or DT should be understood to be independent of the specific terminology, for example a description referencing an entity should be understood to apply to embodiments where the entity is additionally or alternatively considered to be an object or a DT.

Referencing FIG. 6, an example schematic 600 depicts a number of behaviors 408 that may be present in embodiments of the present disclosure. Example behaviors 408 can encompass any determinations, actions, delay periods, models, etc. associated with the related entity. Without limitation to any other aspect of the present disclosure, example and non-limiting behaviors 408 include: a physical model 606 (e.g., modeling the specific physical behavior of the entity and/or goods within the entity, for example a temperature model; manufacturing line production including production rates, costs, quality and/or defect rates; aging of products (e.g., including tracking the shelf life, hold time, differential aging based on experienced conditions, etc.), etc.); a logical model 618 (e.g., hold times, delay periods, process operations performed by the entity, etc.); a data provision value 610 (e.g., data to be determined by the entity, and/or provided by the entity to another entity and/or available to the supply chain model 6010, etc.); and/or a data collection value 608 (e.g., data requested by the entity, to be made available to the entity, etc.). Without limitation to any other aspect of the present disclosure, example and non-limiting behaviors 408 include: an event detection value 602 (e.g., events to be detected by the entity, to be communicated to the entity upon detection, which may include imminent and/or emerging events, and which may include contributions from the entity to event detection performed by another entity or the supply chain model 6010); an event response value 604 (e.g., automated response of the entity to detected events, including any type of response set forth throughout the present disclosure, and/or responses which may be suggested to a user of the platform 102 for approval and/or confirmation); a notification value 612 (e.g., where the entity participates in providing the notification, determining attributes for the notification (e.g., providing a target user, messaging address, etc. for a notification, which may depend upon the operating conditions of the physical supply chain 104 and/or specific entity); an alert value 614 (e.g., a type of notification configured for more rapid and/or prominent communication to a user, for example using an elevated messaging aspect, provided to an alert address, including a differential amount of information relative to an otherwise similar notification (e.g., excluding non-essential information, providing additional relevant details, including response links to access the platform 102 and/or authorize actions, etc.); and/or a reporting value 616 (e.g., a type of notification that includes detailed or configured information about the entity, a detected event, historical performance, etc.).

In certain embodiments, a coding level of an entity may be varied, for example to allow for a range of entity behavior capabilities and/or accessibility. Example coding levels include: an entity provided as a coded modeling element (e.g., the implementing code for the entity is fully accessible to the user, and/or may be created entirely by the user, or by the user starting with a template entity and/or template behavior); an entity provided as a low coding element (e.g., the implementing code for the entity is provided as a part of a template entity or behavior, where the code may be accessible to the user or partially accessible to the user, where the code or portions thereof may be visible to the user but not editable, and/or where the user creates a useful entity by providing attributes and/or properties of the entity, and/or by selectively editing the code for the entity); and/or an entity provided as a black box element (e.g., the implementing code for the entity is hidden from the user, which may have interface parameters (e.g., parameters to be supplied when interacting with the entity, return parameter descriptions from the entity, display parameters accessible for the entity on the runtime interface 6028, etc.). The coding level selected may be varied across the entities (e.g., a supply chain model 6010 having some entities that are coded elements, some that are low coding elements, and/or some that are black box elements), varied according to the user (e.g., an entity that appears on the build interface 6004 as a coded element for a first user, and as a black box element for a second user), varied according to an organization associated with the user (e.g., a user associated with a particular facility may see an entity(ies) associated with that particular facility as a coded element, but other entities may appear as a black box element, or hidden completely from the user), and/or varied according to a role of the user (e.g., setting roles for the user such as a manager, purchasing personnel, marketing personnel, technical contributor, system administrator, risk management personnel, etc., and scheduling the coding levels for entities based on the role of the user).

The utilization of scheduled coding levels for entities provides a number of benefits for embodiments herein—for example coding levels may be selected for increased security (e.g., hiding or disabling code editing for users that do not have a need to see the entity code), increased efficiency (e.g., hiding or disabling code editing for users that would not understand the code, allowing them to focus on aspects of the entities and/or the supply chain model 6010 that are relevant to the specific user), and/or increased capability (e.g., reducing the coding sophistication required for users having a particular skill set relevant to managing the supply chain, for example an expert in marketing, capital expenditure, a technical aspect such as a physical model related to the entity, etc., which allows those users to directly access the platform 102 on the build interface 6004 and/or runtime interface 6028, allowing such users to more directly apply their expertise, and/or ensure their expertise is properly reflected in system models, event detection, response behavior, etc., without overwhelming the user with irrelevant coding considerations and/or introducing a risk that the user will inadvertently disturb another aspect of an entity or the supply chain model 6010). In certain embodiments, a first user can set the coding levels applied to other users—for example an owner of a proprietary model (e.g., a technical physical model such as a temperature model, a model that would expose proprietary aspects of a manufacturing line, etc.) can expose the model to make it available to other users without exposing how the model operates. In certain embodiments, a given coding level for an entity may include aspects of any or all of the coding levels described, for example with one behavior (or portion thereof) operating as a low coding element, and another behavior (or portion thereof, and/or a different portion of the first behavior) operating as a black box element. The disclosed coding levels are provided to illustrate aspects and capabilities of embodiments herein, and the specific terminology utilized to describe the coding level of an entity or behavior thereof is not limiting.

The example selection and/or scheduling of coding levels are described in the context of entities and/or behaviors of entities. Without limitation to any other aspect of the present disclosure, the selection, scheduling, and ability to vary coding levels as described preceding may be applied to any coded aspects of the visual model 6008 and/or supply chain model 6010, including without limitation to links between entities, relationship values, and/or (where applicable) aspects of the visual model 6008 and/or supply chain model 6010 that are not objects, links, entities, or relationships, such as global algorithms (e.g., aspects of the supply chain model 6010 that operate independently of a specific entity or relationship, any aspect utilizing data that is visible globally, etc.); code modules (e.g., modules that may be configured to perform common functions (e.g., mathematical functions, automation of common operations such as providing notifications, etc.); processing operations such as statistical analysis, compression, data management (e.g., data storage, data life cycle management, expiration of data, etc.), etc.; anomaly detection operations (e.g., common operations to detect anomalous and/or suspect data (e.g., due to: a sensor fault value; saturation of a sensor; missing, incomplete, or incorrect business records; and/or conflicting data) within a data stream, to detect fault values for a sensor, etc.)); services made available to entities within the supply chain model 6010 (e.g., services provided by any engine, manager, service, application, etc., accessible to the platform 102 and which may be utilized during build time and/or run time operations of the platform 102); elements of a catalog 506 (e.g., reference FIGS. 5, 12, 13, 20 and the related descriptions); and/or functions (e.g., any processing element that accepts one or more inputs and provides a scheduled return output or outputs, which may be provided on the build interface 6004 as an available function, module, or service that can be utilized with any entity, relationship, behavior, etc.; and/or which may be provided on the runtime interface 6028, for example to allow users to perform specific analysis operations, to simplify notifications to other users, etc.). The benefits to embodiments of the present disclosure related to selection and/or scheduling of coding levels for entities and/or behaviors also apply to the selection and/or scheduling of coding levels for other coded aspects of the visual model 6008 and/or supply chain model 6010, including for example enhanced security management, efficiency of exercising the build interface 6004 and/or runtime interface 6028, improved risk management, protection of intellectual property, and/or enhanced capability of the platform 102.

An example system 6000 includes the interface manager 6002 providing a catalog (e.g., reference FIGS. 5, 12, 13, 20 and the related descriptions) of pre-configured elements to the build interface 6004. For example, the interface manager 6002 may expose the catalog 506 to the build interface 6004 in a catalog tab, in a catalog menu, in an alternate selection menu (e.g., on a menu provided with a right-click operation, shift-click operation, etc.), or the like. The example interface manager 6002 further inserts at least one of the pre-configured elements into the visual model 6008 in response to user operations on the build interface 6004—for example the where the user performs a drag-and-drop operation of an icon representing the pre-configured element (e.g., from a catalog menu or area, into the active area of the visual model 6008), selection of the pre-configured element from a menu, and/or selection of the pre-configured element from a list (e.g., a list provided in response to a search operation performed by the user, a suggested list based on what the user is doing, based on other elements present in the visual model 6008, and/or based on historical operations by the user such as elements previously utilized by the user). The example catalog 506 of pre-configured elements includes a catalog of entities, relationships, and/or behaviors. In certain embodiments, the catalog 506 of pre-configured elements may include one or more elements such as: a global algorithm, a code module, a service, or a function. The catalog 506 of pre-configured elements can include elements that are ready to use, that are constructed with default properties and/or attributes, and/or elements that require some user entries or selections (e.g., properties, attributes, calibrations, ranges for values, names for the element and/or properties thereof, etc.) before they are usable in the visual model 6008. In certain embodiments, some aspects of the element may be optional, and other aspects of the element may be required. In certain embodiments, operations to include a pre-configured element can include graphical operations (e.g., dragging end points of a link to the related entities, positioning an entity on the visual model 6008, etc.), text based operations (e.g., typing into fields associated with the element, such as properties, attributes, connected entities for a link, etc.), and/or selection operations (e.g., where the interface manager 6002 provides prompts to the user to enter or accept values for one or more aspects of the element). In certain embodiments, one or more aspects of a pre-configured element are populated for the user, for example labeling an element based on user preferences, defined behavior from an organization associated with the user, defined behavior from another user (e.g., a manager or administrator), based on the type of physical supply chain 104 being modeled, etc. In certain embodiments, the utilization of a catalog 506 of pre-configured elements provides for a number of benefits to the platform 102, for example: providing for consistent model construction and performance; avoiding repetition creating commonly used modeling elements; allowing users to re-use complex elements that have been created previously; allowing users to configure the experience of other users (e.g., the creator of the catalog element can configure: which aspects of the catalog element are optional or required; selection and/or scheduling the coding level of the element or aspects thereof; formatting of data related to the element; ensuring that appropriate fields, documentation, or comments related to the element are utilized, etc.); and/or providing differential capability (e.g., by sharing distinct versions of the catalog 506 and/or pre-configured elements thereof) on the platform 102 to different users, organizations, user roles, etc.

An example supply chain model creation component 6006 determines the supply chain model 6010 in response to elements inserted from the catalog 506, for example updating the supply chain model 6010 in response to changes to the visual model 6008.

An example supply chain model creation component 6006 stores a model element of the visual model 6008 to a catalog 506 of pre-configured elements in response to user operations on the build interface 6004, for example allowing the user to save a configured element from the visual model 6008 for future use in the catalog 506. The ability of the user to store elements as a pre-configured element in the catalog 506 may be limited to users having appropriate permissions, and/or may be limited to a particular scope. For example, a user may have permissions (e.g., identified from an authorization value associated with the user) to store a catalog element that is visible only in a catalog 506 for that user creating the element to be stored. In certain embodiments, permissions to store elements in the catalog 506 may be limited to specified users, users have a certain role, users associated with a particular organization, and/or users within a hierarchy of users associated with the platform 102. In certain embodiments, a pre-configured element may be stored to a global catalog 506 (e.g., a catalog 506 for the platform 102 available to all users), a topically determined catalog 506 (e.g., a catalog 506 configured for a particular type of physical supply chain 104, utilized to model certain types of supply chains, and/or utilized to model supply chains having certain aspects such as utilization of ports, railways, facilities in particular jurisdictions, etc.), and/or users having access to a particular version of the platform 102 and/or build interface 6004. In certain embodiments, operations to store a model element of the visual model 6008 to the catalog 506 include operations to define the selection and/or schedule of the coding level for the element (or portions thereof), a selection of properties/attributes for the element (e.g., default values, required or optional values, which properties/attributes should be included with the catalog 506 version which may be distinct from the element on the visual model 6008, for example to remove properties/attributes that are not generally applicable for the element, and/or to add properties/attributes that are not included with the element but may be useful for a generalized version of the element; and/or which may include a schedule of the properties/attributes depending upon the subsequent user accessing the stored element in a catalog 506), and/or a selection of the scope of the stored element of the catalog 506 (e.g., a user may have permissions to share the element to an organization, but may keep the element local, for example while testing the element). In certain embodiments, operations to store a model element of the visual model 6008 to the catalog 506 include operations to define (or select) a catalog name for the element, to define (or select) a catalog icon for the element, to define (or select) keywords or tags for the element (e.g., to facilitate finding the element using a search operation), and/or to define (or select) a storage scheme for the element (e.g., the coding levels associated with the element, the scope of the element, etc.). Without limitation to any other aspect of the present disclosure, any operations of the user to store a catalog element, including defining or selecting a storage scheme for the element, include the interface manager 6002 and/or supply chain model creation component 6006 limiting and/or configuring the operations in response to an authorization value associated with the user performing the user operations to store the catalog element.

Again referencing FIG. 56, an example system 6000 for rapidly detecting off-nominal events 6018 occurring in the operation of a physical supply chain 104 is schematically depicted. The example system 6000 includes the supply chain model execution component 6012 configured to operate the supply chain model 6010 as a DT of at least a portion of the physical supply chain 104, and determining an off-nominal event value 6018 in response to comparing the supply chain model 6010 and the supply chain execution value(s) 6016. For example, a result of the supply chain model 6010 utilizing feedback values 206 of the supply chain execution values 6016 may indicate that an off-nominal event 6018 has occurred, or that the supply chain model 6010 indicates that the off-nominal event 6018 has occurred. In another example, a predicted value from the supply chain model 6010 may not match a feedback value 206 of the supply chain execution values 6016, where the off-nominal event 6018 is determined according to that mis-match of the predicted versus observed values. In certain embodiments, an off-nominal event value 6018 includes a present condition (e.g., a shipment delay, supply disruption, cost exceedance, etc.) of the physical supply chain 104 that is off-nominal. Additionally or alternatively, an off-nominal event value 6018 includes a predicted condition (e.g., no exceedance has occurred yet, but the supply chain model 6010 is predicting that an exceedance will occur based on the present conditions of the physical supply chain 104), a past condition (e.g., a risk, non-compliance, or exceedance condition occurred, which may not have visibly disrupted the physical supply chain 104, but the condition is of a type that a user wants to tag and analyze the event), an imminent condition (e.g., conditions within the physical supply chain 104 are on a trajectory to result in a risk, non-compliance, exceedance, etc., for example based on reducing inventory, rising temperature, reduced operating margin, etc.), and/or an emerging condition (e.g., similar to an imminent condition, possibly with a different time horizon, uncertainty on the potential development of the condition, based on a rate of change of an operating margin as opposed to an absolute value of the margin, etc.).

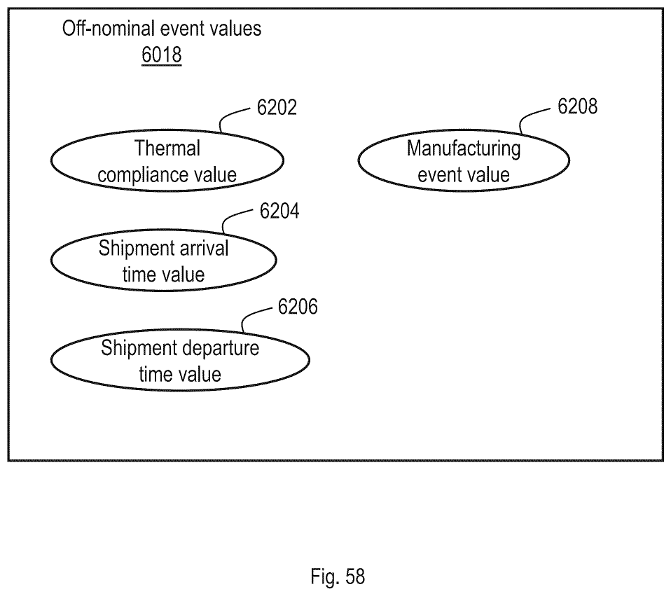

An example off-nominal event value 6018 includes a thermal compliance value 6202 (e.g., reference FIG. 58), for example determining that a product, storage unit, vehicle compartment, or other aspect of the physical supply chain 104 has exceeded a thermal compliance (e.g., a temperature outside of a defined range, an area under a selected time/temperature trajectory, a thermally based exceedance of a modeled process, such as an integrated chemical reaction, bacterial growth model, etc.), is on a trajectory having a risk that the thermal compliance will be exceeded based on estimated nominal operations (e.g., ordinary delays and/or temperature management throughout the progression within the physical supply chain 104 may result in an exceedance), and/or is on a trajectory having a risk that thermal compliance will be exceeded based on estimated current operations (e.g., estimated actual delays and/or temperature management throughout the progression within the physical supply chain 104 may result in an exceedance, for example based on observed performance of the physical supply chain 104, a sensor value 6102, a business record value 6108, a virtual sensor value 6110 (e.g., a temperature model), external events 6104 (e.g., weather, traffic, political disruption, labor disruption, etc.), soft signal values 6106, a contextual value 6112, etc.). In certain embodiments thermal compliance may be based on actual thermal requirements (e.g., exceeding the thermal compliance will exceed the requirements), and/or based on a selected operating margin (e.g., exceeding the thermal compliance will result in a reduction of a thermal margin below a predetermined threshold level). An example supply chain model execution component 6012 interprets the thermal compliance value in response to a supply chain execution value 6016 such as: a weather event (e.g., weather affecting the temperature model itself, weather likely to cause a shipment delay or other disruption of the physical supply chain 104, etc.), a temperature sensor event (e.g., based on the temperature indicated, a fault condition of the temperature sensor, a loss of communication with the temperature sensor, etc.), a shipment tracking event (e.g., confirming that a shipment has occurred, determining that a shipment is delayed, determining an expected arrival time for the shipment, etc.), and/or a milestone event (e.g., a target condition of the physical supply chain 104 at any point in the process, based on time, stage progression, acceptable conditions, etc., for example to determine that goods flowing through the physical supply chain 104 are progressing at an acceptable rate and in an acceptable condition).

An example off-nominal event value 6018 includes a shipment arrival time value 6204 (e.g., reference FIG. 58), for example determining that a shipment is not expected to arrive on time, is at risk to arrive late, and/or at risk to not arrive at all. In certain embodiments, the shipment arrival time value 6204 is itself a non-compliant event, for example where the shipment is provided to a final customer of the physical supply chain 104. In certain embodiments, the shipment arrival time value 6204 may cause a disruption, or introduce a risk of disruption, to an aspect of the physical supply chain 104, for example a shipment of raw materials or pre-cursor goods to a manufacturing line, a replenishment of an inventory in the physical supply chain 104, etc. An example supply chain model execution component 6012 interprets the shipment arrival time value 6204 in response to a supply chain execution value 6016 such as a weather event (e.g., a weather event likely to cause a shipment delay), an enterprise order lifecycle event (e.g., events related to any aspect of the order fulfilling process related to the shipment, including for example an order intake or fulfilling process, a manufacturing event, an inventory event, a shipper related event, a quality issue, return events related to the shipment that may indicate a quality issue or fulfillment issue related to the shipment, and/or an event related to an order processing system); a carrier event; a shipment tracking event; and/or a milestone event.

An example off-nominal event value 6018 includes a shipment departure time value 6206 (e.g., reference FIG. 58), for example determining that a shipment is not expected to depart on time, is at risk to depart late, and/or at risk to not depart at all. In certain embodiments, the shipment departure time value 6206 is likely to create a risk of a direct non-compliant event, for example where the shipment is destined to a final customer of the physical supply chain 104. In certain embodiments, the shipment departure time value 6206 may cause a disruption, or introduce a risk of disruption, to an aspect of the physical supply chain 104. An example supply chain model execution component 6012 interprets the shipment departure time value 6206 in response to a supply chain execution value 6016 such as a warehouse event (e.g., warehouse inventory, loading performance, throughput, etc. is in a condition to put the shipment departure at risk), a product lifecycle event (e.g., product quality issues, product shelf-life, product version management, product expiration, product recalls or investigations, etc., that are in a condition to put the shipment departure at risk), a manufacturing event (e.g., a related manufacturing line capacity, quality issue, on-hand inventory, shutdown, delay, etc., that is in a condition to put the shipment departure at risk), and/or a personnel event (e.g., limited personnel capacity with regard to any relevant aspect of the physical supply chain 104, including at least a warehouse, manufacturing line, shipper, etc., such as a labor shortage, external event that may affect personnel availability (e.g., a pandemic, weather event, slowdown, strike, etc.), in a condition to put the shipment departure at risk).

An example off-nominal event value 6018 includes a manufacturing event value 6208 (e.g., reference FIG. 58), for example related to available inventory, capacity, quality, or the like, that is in a condition to put an aspect of the physical supply chain 104 at risk. For example, manufacturing event values 6208 may include events that are likely to cause a missed shipment, production delay, inventory reduction below a threshold, product shelf-life issue, or the like, may cause a disruption in the physical supply chain 104. An example supply chain model execution component 6012 interprets the manufacturing event value 6208 in response to a supply chain execution value 6016 such as a supply event (e.g., a supply of raw materials and/or pre-cursor goods to a relevant manufacturing line or facility), a demand change event (e.g., an observed or predicted change in demand for goods dependent upon a manufacturing line, for example that may cause excess inventory, non-productive utilization of the manufacturing line, and/or a shortage in other goods that utilize, at least in part, the manufacturing line or competing resources), a manufacturing line event (e.g., a capacity issue, a quality issue, on-hand inventory, shutdown, delay, etc., of the manufacturing line that is in a condition to put an aspect of the physical supply chain 104 at risk), and/or a personnel event.

Without limitation to any other aspect of the present disclosure, example and non-limiting off-nominal event values 6018 include events such as: a shipping event (e.g., a delay or cancellation, shipping conditions such as time, temperatures, acceleration, etc.), an inventory event (e.g., an inventory within the physical supply chain 104 exceeds a threshold, falls below a threshold, is outside of a predetermined range, and/or an exceedance is imminent or emerging), a regulatory event (e.g., a government action affecting manufacturing, storage requirements, shipping availability, acceptable product criteria and/or packaging requirements, etc.), a manufacturing event, and/or an infrastructure event (e.g., a road, port, rail, airport, bridge, power loss, water loss, etc., that is in a condition to put an aspect of the physical supply chain 104 at risk).

An example supply chain model execution component 6012 provides a notification 6014 to a user in response to the off-nominal event value 6018. For example, the notification 6014 may include any one or more aspects such as: a description of the event; data related to the event (e.g., data utilized to determine the existence of the event, an estimated severity and/or impact of the event, and/or aspects of the physical supply chain 104 affected by the event); an indication of whether the event is directly detected, inferred, imminent, emerging, etc.; contact information for other users (or other personnel) having information about the event, responsibility for aspects of the physical supply chain 104 that are involved in the event and/or likely to be affected by the event; a description of uncertainties related to the event (e.g., a description of parameters having uncertainty related to them, where the parameters are utilized to detect the event, and/or to estimate a severity or impact of the event); and/or an indication of one or more supply chain response actions 6022 (e.g., actions that have been taken, pending actions and/or the responsible party for approving and/or implementing the action, a request for approval of an action, a request to confirm an action, etc.). In certain embodiments, the supply chain response actions 6022 are implemented by providing one or more commands 6024, which may include communications, ordering operations, notifications, or the like, including any operations for the supply chain response actions 6022 as set forth throughout the present disclosure. The content, target user, and notification method of any notifications 6014 may be selected and/or configured by a user interacting with the build interface 6004, and/or adjusted by a user interacting with the runtime interface 6028. In certain embodiments, providing notifications 6014 may be a supply chain response action 6022, and/or may form a part of a supply chain response action 6022. In certain embodiments, a notification 6014 may be characterized as an alert, and/or may be provided in parallel with providing one or more alerts.

Again referencing FIG. 56, an example system 6000 for providing a rapid and/or automated response to an off-nominal event 6018 occurring in the operation of a physical supply chain 104 is schematically depicted. The example system 6000 includes a supply chain management component 6020 configured to perform a supply chain response action 6022 in response to the off-nominal event value 6018.

An example supply chain management component 6020 performs the supply chain response action 6022 in response to an off-nominal event value 6018, including a manufacturing event value, by adjusting manufacturing parameters of a manufacturing line. Example and non-limiting manufacturing parameters of a manufacturing line that may be adjusted include parameters such as: a product mix for manufactured goods (e.g., to preserve utilization of the manufacturing line, to adjust an inventory level in the physical supply chain 104, to build up inventory to mitigate the impact of the event, to produce a substitute product, to match another limitation in the physical supply chain 104 such as available raw materials and/or pre-cursor goods, etc.); a product quantity for manufactured goods (e.g., to alleviate or prevent an inventory build-up, to build-up an inventory, and/or to match a limitation in the physical supply chain 104 imposed by the event); and/or a product sequencing for manufactured goods (e.g., to re-order a manufacturing sequence, manipulate inventory levels, preserve utilization of the manufacturing line and/or another aspect of the physical supply chain 104 such as shipping or storage utilization, and/or to match a limitation in the physical supply chain 104 imposed by the event).

An example supply chain management component 6020 performs the supply chain response action 6022 in response to a manufacturing event value including a manufacturing productivity value (e.g., a value related to utilization of the manufacturing line, including producing goods that are likely to preserve value throughout the physical supply chain 104, produce the best mix of goods for profitability, and/or reduce a rate of change in the manufacturing line such as power requirements, personnel requirements, raw material and/or pre-cursor good consumption, etc.). In certain embodiments, the off-nominal event value 6018 includes the manufacturing productivity value, which may include a description of the manufacturing productivity value, and the supply chain management component 6020 repeats the supply chain response action 6022, thereby iteratively improving the manufacturing productivity value. Example and non-limiting manufacturing productivity values include one or more parameters such as: a manufacturing line utilization value, a manufacturing line profitability value, or a manufacturing line production value.

In certain embodiments, the off-nominal event value 6018 includes an indication that the manufacturing productivity value has not converged (e.g., improvements are still occurring at a threshold rate, at greater than a predetermined improvement margin, the supply chain response action 6022 has not been performed a threshold number of times yet, and/or the supply chain response action 6022 has not been performed for a threshold period of time, etc.). In certain embodiments, convergence of the manufacturing productivity value is determined in a manner to ensure that the supply chain response action 6022 is performed periodically, is performed after specific events (e.g., after a fiscal year or fiscal quarter occurs; in response to changes in the supply chain model 6010; in response to changes in the physical supply chain 104; and/or in response to external data such as price changes in raw materials, pre-cursor goods, power inputs, and/or water inputs, changes in demand estimations, and/or detection of a regulatory event), and/or in response to specified throughput levels of the manufacturing line (e.g., based on utilization of equipment of the manufacturing line, fiscal value of goods produced, quantity of goods produced, etc.). An example supply chain management component 6020 interprets a product segmentation risk and/or a quality risk, in response to the off-nominal event 6018, and/or in response to the planned supply chain response action 6022, and adjusts the supply chain response action 6022 to reduce the product segmentation and/or quality risk. For example, adjusting the manufacturing parameters may result in over-utilization of resources within the manufacturing line (e.g., testing or inspection resources, exceeding capacity for equipment, increasing maintenance requirements for equipment, etc.), which can be accounted for in the supply chain response action 6022 to minimize such risks, and/or utilized in the overall benefit model to ensure that these risks are accounted for. In the example, repeated operations of the supply chain response action 6022 and convergence criteria for the manufacturing productivity value provide for iterative improvements and/or optimization of the manufacturing line operations.

In certain embodiments, appropriate repeated operations of the supply chain response action 6022 and convergence criteria may be applied to any aspect of the physical supply chain 104 to provide for iterative improvement and/or optimization of any aspect of the physical supply chain 104 (e.g., warehouse management, shipping selections, packaging selections for goods, etc.). Without limitation to any other aspect of the present disclosure, convergence criteria may be selected to maximize utilization, maximize profitability, promote robustness (e.g., based on the number and likelihood of potential disruptions, the impact and/or severity of disruptions, and/or the cost or magnitude of response behaviors to mitigate and/or avoid impact to the physical supply chain 104 in response to potential disruptions).

In certain embodiments, the supply chain model 6010 includes at least one event response rule (e.g., as defined by a user building the model, and/or implemented by a rules engine (reference FIG. 20 and the related description), and the supply chain management component 6020 performs the supply chain response action 6022 in response to the at least one event response rule. In certain embodiments, an example supply chain response action 6022 includes providing a recommendation to adjust the at least one event response rule, for example based on a model of responses to off-nominal events 6018, and/or based on historical performance of supply chain response actions 6022 to off-nominal events 6018 (e.g., comparing performance of convergence criteria as modeled or observed for various options for, and/or within an available operating space for, supply chain response action 6022). In certain embodiments, example supply chain response action 6022 include one or more operations such as: adjusting a shipping parameter (e.g., shipping methods, shipping group size, packaging, shipping providers, shipping lead times, etc.); adjusting a target inventory level (e.g., at a manufacturing line, warehouse, or other storage facility); adjusting a manufacturing parameter; adjusting an advertised capability value (e.g., where advertising in this context includes, without limitation, allowed ordering levels, business-to-business communications of capacity, ranges utilized within the supply chain model 6010, etc.); and/or adjusting a product order value (e.g., a quantity of products, a version of products, a product unit size selection, a lead time for ordering products, a supplier and/or mix of suppliers for the product, etc.).

Again referencing FIG. 56, an example system 6000 for modifying a visual model 6008 and/or supply chain model 6010, including providing modifications in response to off-nominal events 6018, supply chain response actions 6022, and/or changes in a physical supply chain 104, and further including providing modifications at build time or during runtime, is schematically depicted. The system 6000 includes the supply chain model execution component 6012 configured to determine a supply chain performance value 6026 in response to a comparison of the supply chain model 6010 and the physical supply chain execution value(s) 6016, where the interface manager 6002 provides the supply chain performance value 6026 to the build interface 6004, to the runtime interface 6028, and/or to a user of the supply chain command platform 102 (e.g., providing a notification separate from the interfaces 6004, 6028, such as a separate text message, e-mail, application based notification, and/or in a messaging location available to the user). The example system 6000 further includes the interface manager 6002 configured to update the visual model 6008 in response to further user operation on the build interface 6004, where the supply chain model creation component 6006 updates the supply chain model 6010 in response to the updated visual model 6008, and where the supply chain model execution component 6012 determines the supply chain performance value 6026 in response a comparison of the updated supply chain model 6010 and supply chain execution value(s) 6016. In certain embodiments, the system 6000 allows for changes to the models 6008, 6010 during runtime operations, for example continuously executing the supply chain model 6010 in response to the update. In certain embodiments, an example system 6000 allows for a tentative model update, for example operating both a previous version of the supply chain model 6010 and the updated supply chain model 6010, until the user confirms to switch the model, and/or until the supply chain model execution component 6012 confirms that the updated supply chain model 6010 provides an acceptable match to the physical supply chain 104, and/or provides an improved match to the physical supply chain 104 relative to the previous version of the supply chain model 6010. In certain embodiments, for example and without limitation, where updates to the supply chain model 6010 are performed in response to a known change (e.g., a real change in the physical supply chain 104, and/or changes implemented as a supply chain response action 6022), the supply chain model execution component 6012 may immediately switch operations to the updated supply chain model 6010. The example system allows for rapid adjustments to the supply chain model 6010, including leveraging updated insights, performance analysis, and performance benefits to the physical supply chain 104 from the adjusted supply chain model 6010.

An example supply chain performance value 6026 includes an off-nominal event value 6018. Without limitation to any other aspects of the present disclosure, example and non-limiting off-nominal event values 6018 include a shipping event, an inventory event, a regulatory event, a manufacturing event, and/or an infrastructure event. An example supply chain performance value 6026 includes a manufacturing productivity value. An example supply chain performance value 6026 includes a thermal compliance value, a shipment arrival time value, a shipment departure time value, and/or a manufacturing event value. In certain embodiments, the supply chain performance value 6026 includes a representation of performance against convergence criteria for iterative improvements, including an convergence criteria as set forth throughout the present disclosure.

An example supply chain management component 6020 performs a supply chain response action 6022 in response to the supply chain performance value 6026, and the interface manager 6002 updates the visual model 6008 further in response to the supply chain response action 6022 (e.g., providing a user with immediate visibility to resulting changes in the physical supply chain 104 and/or visual model 6008 implemented by the supply chain response action 6022). An example interface manager 6002 updates the visual model 6008 further in response to user operations to confirm and/or accept the updated visual model 6008. In certain embodiments, the interface manager 6002 provides a visual cue to updates in the visual model 6008, for example with highlights, a change list, positioning an icon next to changes aspects on the build interface 6004, or the like. In certain embodiments, the supply chain model creation component 6006 updates the supply chain model 6010 in response to user operations to confirm and/or approve the updates to the visual model 6008.

An example supply chain management component 6020 performs a supply chain response action 6022 in response to the supply chain performance value 6026, and the supply chain creation component 6006 updates the supply chain model 6010 further in response to the supply chain response action 6022 (e.g., to begin immediate implementation of updates to the supply chain model 6010, while the changes are otherwise confirmed). In certain embodiments, the interface manager 6002 further provides a notification 6014 to a user, and/or updates the visual model 6008, for example in parallel with the implemented changes to the supply chain model 6010.

An example interface manager 6002 provides a model update notification 6014 to the build interface 6004, the runtime interface 6028, or a user of the supply chain command platform 102. In certain embodiments, the model update notification 6014 may be provided to another user (e.g., compared to a first user that implements, approves, or confirms an update to the supply chain model 6010 and/or visual model 6008).

Again referencing FIG. 56, an example system for modeling and/or operating a physical supply chain 104 utilizes a layered DT architecture to implement the supply chain model 6010. The example system 6000 includes the supply chain model creation component 6006 configured to determine the supply chain model 6010 in response to the visual model 6008, and the supply chain model execution component 6012 that operates the supply chain model 6010 as a layered DT of at least a portion of a physical supply chain. An example supply chain model 6010 as a layered DT includes a process layer (e.g., performing workflows, tracking of operations, etc.) and a discrete layer (e.g., modeling specific devices, facilities, equipment, decisions, state determinations, etc.). An example supply chain model 6010 as a layered DT includes the process layer as a process logical layer and the discrete layer divided into a discrete logical layer (e.g., modeling discrete operations such as a shipping operation) and a discrete physical layer (e.g., modeling discrete components, facilities, providing physical parameter detection, etc.). An example supply chain model 6010 includes a hierarchy, with higher layers providing commands to the lower layers, and with lower layers providing feedback (e.g., confirmation of command execution, status indicators, data values, event values, and/or any supply chain execution values 6016) to the higher layers. An example supply chain model 6010 includes a hierarchy, in order from lowest to highest, of the discrete physical layer, the discrete logical layer, and the process logical layer (e.g., reference FIG. 36 and the related description).

An example layered DT includes a number of nodes, each node having a link to at least one other node. An example layered DT includes each node as an entity, and each link as a relationship. An example layered DT includes each entity having at least one behavior.

Again referencing FIG. 56, an example system 6000 for modeling a physical supply chain 104 using an object/link class paradigm is schematically depicted. The example system 6000 includes a supply chain model 6010 as a DT of at least a portion of the physical supply chain 104, where the DT includes a number of objects interrelated by a number of links (e.g., reference FIGS. 3, 15, 16, 26, 28, 30, 32, 35, 36 and the related descriptions). In certain embodiments, each one of the objects comprises an entity having at least one behavior. In certain embodiments, each one of the links includes a relationship between two of the entities. In certain embodiments, each one of the objects includes a coded object, a low coding object, and/or a black box object. In certain embodiments, the interface manager 6002 exposes a catalog 506 of template objects to a user of the supply chain command platform 102. In certain embodiments, the interface manager 6002 inserts an object from the catalog 506 into the visual model 6008 in response to user operations on the build interface 6004, for example in response to a drag-and-drop operation and/or a menu selection operation. In certain embodiments, the interface manager 6002 stores an object from the visual model 6008 into the catalog 506 in response to user operations on the build interface 6004, which may include operations as set forth herein to configure the stored object for general use in the catalog 506.

Again referencing FIG. 56, an example system 6000 using DT type selection as a modeling scheme to model a physical supply chain 104 is schematically depicted. The example system 6000 includes the supply chain model execution component 6012 configured to operate the supply chain model 6010 as a number of DTs, each DT modeling at least a portion of the physical supply chain 104. In the example, each DT includes one or more objects each having a behavior, and each object having a link to at least one other object of the DT. The example system 6000 includes each DT having a DT type selected from: a physical discrete DT, a logical discrete DT, a discrete process DT, or a logical process DT (e.g., reference FIG. 35 and the related description). An example physical discrete DT includes a model of a location, a model of a facility, a model of an asset, a model of a vehicle, and/or a model of a physical device. An example logical process DT includes a model of a route. An example model of a shipment includes a logical discrete DT or a logical process DT. An example model of an order includes a logical discrete DT or a logical process DT. An example model of an organization includes a logical discrete DT or a logical process DT.

Again referencing FIG. 56, an example system 6000 for integrating a live DT model for a physical supply chain 104 with real-time data and a responsive API to operate and/or monitor the physical supply chain 104 is schematically depicted. The example system 6000 includes the interface manager 6002 configured to implement a build interface 6004, the build interface 6004 at least partially including an API configured to interact with a computing device external to the platform 102. In certain embodiments, the interface manager 6002 builds a visual model 6008 in response to user operations on the build interface 6004, including operations utilizing the API. In certain embodiments, the supply chain model creation component 6006 determines the supply chain model 6010 in response to the visual model 6008, and/or directly in response to operations on the build interface 6004 (e.g., where a visual model 6008 is not needed or desired, and/or where the visual model 6008 is built or managed elsewhere, for example on an external device exercising the API and/or build interface 6004). An example supply chain execution value 6016 includes a physical supply chain execution value, and/or a physical state of a component (or aspect) of the physical supply chain. An example supply chain model execution component 6012 updates the visual model 6008 and/or supply chain model 6010 in response to an off-nominal event value 6018, a supply chain response action 6022, and/or a change in the physical supply chain 104.

An example interface manager 6002 provides a notification 6014 to a user of the supply chain command platform in response to the off-nominal event value 6018, and determines a mitigation approval and/or a mitigation confirmation in response to user operations on a runtime interface 6028 of the supply chain command platform. In certain embodiments, the runtime interface 6028 is operated, at least in part, using the API. An example supply chain model execution component 6012 updates at least one of the visual model 6008 and/or the supply chain model 6010 further in response to the mitigation approval and/or the mitigation confirmation.

An example interface manager 6002 implements a scenario builder on the runtime interface 6028, and updates the visual model 6008 in response to user operations on the scenario builder. An example runtime interface 6028 operates utilizing the API, and an example supply chain model creation component 6006 updates the supply chain model 6010 in response to user operations on the scenario builder (e.g., where the visual model 6008 is not needed or desired, and/or where the visual model 6008 is built or managed elsewhere). An example scenario builder allows the user to compare operations based on different visual models 6008, and/or visual models 6008 having distinct configurations (e.g., distinct calibrations, attributes, properties, or the like). An example scenario builder utilizes actual, simulated, and/or estimated supply chain execution values 6016 to compare outcomes of the scenarios, for example based on convergence criteria, supply chain performance values 6026, or the like. An example supply chain model creation component 6006 updates the supply chain model 6010 in response to the updated visual model 6008, and wherein the supply chain model execution component 6012 is further configured to continue operations utilizing the updated supply chain model 6010. An example supply chain model creation component 6006 updates the supply chain model 6010 in response to user operations on the scenario builder, and wherein the supply chain model execution component 6012 is further configured to continue operations utilizing the updated supply chain model 6010.

Example and non-limiting off-nominal events 6018 include one or more of a sensor detected off-nominal event and/or a change in a physical aspect of the physical supply chain 104. An example off-nominal event 6018 includes a change in an external aspect including one or more of: an input to the physical supply chain 104, a recipient of an output of the physical supply chain 104, an aspect that interacts with the physical supply chain 104, and/or an aspect that indicates a condition relevant to the physical supply chain 104. An example off-nominal event 6018 includes one or more events selected from: a shipping event, an inventory event, a regulatory event, a manufacturing event, and/or an infrastructure event. An example off-nominal event 6018 includes a manufacturing productivity value. An example off-nominal event 6018 includes one or more events selected from: a thermal compliance value, a shipment arrival time value, a shipment departure time value, and/or a manufacturing event value.

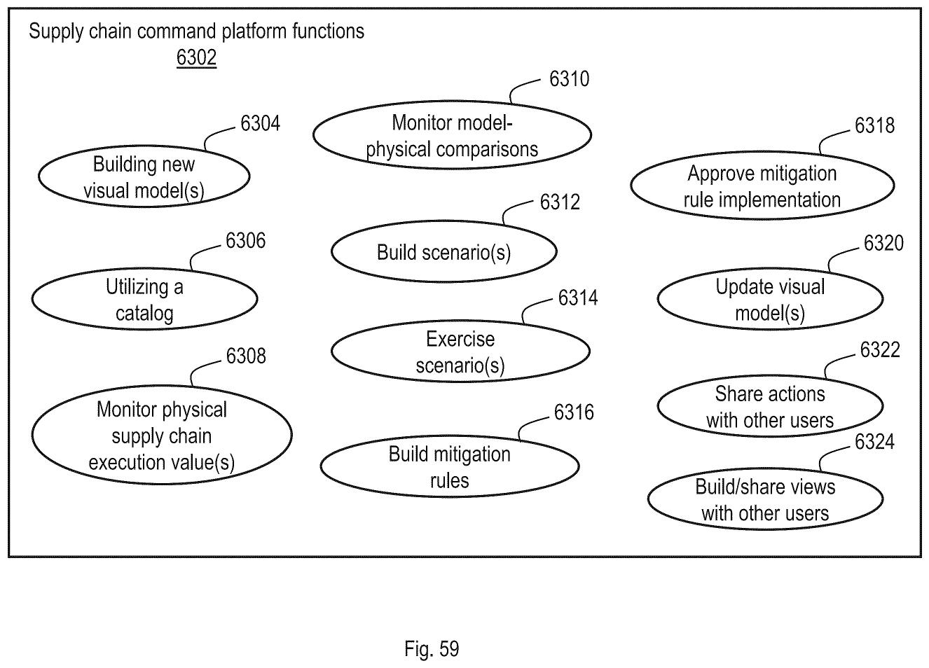

An example interface manager 6002 provides scheduled access to a user to one or more functions on the supply chain command platform 102. Without limitation to any other aspect of the present disclosure, a number of example functions on the supply chain command platform 102 are depicted in FIG. 59. Example and non-limiting supply chain command platform functions 6302 includes one or more function such as: building a new visual model for a physical supply chain 6304; utilizing a catalog 6306 to build or update one of the visual model or a new visual model; monitoring at least one physical supply chain execution value 6308; monitoring a result of the comparison of the supply chain model and the at least one physical supply chain execution value 6310; building a scenario for the physical supply chain 6312; exercising a scenario for the physical supply chain 6314; building mitigation rules for the physical supply chain 6316 (e.g., as supply chain response actions 6022); approving the implementation of mitigation rules for the physical supply chain 6318; updating the visual model 6320; sharing any one or more of the foregoing with another user 6322 of the supply chain command platform; and/or sharing a view of any one or more of the foregoing with another user 6324 of the supply chain command platform. An example interface manager 6002 provides the scheduled access in response to one or more of: an identity of the user; an associated organization with the user; a role of the user; and/or permissions associated with the user. An example system 6000 includes the scheduled access including access to a view of the visual model 6008. In some aspects, the techniques described herein relate to a system, wherein the scheduled access further includes access to a view of the visual model.

The description following includes schematic flow descriptions of various procedures operations of the present disclosure. The procedures and/or operations thereof may be performed by any systems, platforms, engines, components, managers, or elements thereof as set forth in the preceding disclosure. Example operations are non-limiting, for example operations may be omitted in whole or part, and/or rearranged in whole or part.

An example procedure for building a supply chain model includes an operation to implement a build interface, and to build a visual model in response user operations on the build interface. The example procedure includes an operation to determine a supply chain model in response to the visual model, and to operate the supply chain model as a DT of a physical supply chain. The example procedure includes an operation to interpret physical supply chain execution values, and to provide a notification to a user in response to a comparison of the supply chain model to the physical supply chain execution values. In certain embodiments, the procedure includes an operation to provide a catalog of pre-configured elements to the build interface, and to insert at least one of the pre-configured elements into the visual model in response to user operations on the build interface. In certain embodiments, the procedure includes an operation to determine the supply chain model in response to a number of linked entities representing at least a portion of the physical supply chain. In certain embodiments, the procedure includes an operation to store a model element of the visual model to a catalog of pre-configured elements.

An example procedure for rapid detection of off-nominal events for a supply chain includes an operation to implement a build interface, and to build a visual model in response to user operations on the build interface. The example procedure includes an operation to determine a supply chain model in response to the visual model, and to operate the supply chain model as a DT of a physical supply chain. The example procedure includes an operation to interpret physical supply chain execution values, and to determine an off-nominal event value in response to a comparison of the supply chain model to the physical supply chain execution values. In certain embodiments, the procedure includes an operation to provide a notification and/or an alert to a user of the supply chain command platform in response to the off-nominal event value.

An example procedure for rapid and/or automated response to off-nominal events for a supply chain includes an operation to implement a build interface, and to build a visual model in response to user operations on the build interface. The example procedure includes an operation to determine a supply chain model in response to the visual model, and to operate the supply chain model as a DT of a physical supply chain. The example procedure includes an operation to interpret physical supply chain execution values, and to determine an off-nominal event value in response to a comparison of the supply chain model to the physical supply chain execution values. The example procedure includes an operation to perform a supply chain response action in response to the off-nominal event value. In certain embodiments, the procedure includes an operation to determine the off-nominal event value as a manufacturing event value, and to perform the supply chain response action by adjusting manufacturing parameters of a manufacturing line. In certain embodiments, the procedure includes an operation to determine interpret a product segmentation risk and/or a quality risk, and to adjust the manufacturing parameters in response to the product segmentation risk and/or the quality risk.

An example procedure for runtime monitoring model modification for a supply chain includes an operation to implement a build interface, and to build a visual model in response to user operations on the build interface. The example procedure includes an operation to determine a supply chain model in response to the visual model, and to operate the supply chain model as a DT of a physical supply chain. The example procedure includes an operation to interpret physical supply chain execution values, and to determine a supply chain performance value in response to a comparison of the supply chain model to the physical supply chain execution values. The example procedure further includes an operation to provide the supply chain performance value to a user, and to update the visual model and/or the supply chain model in response to user operations on the build interface. The example procedure further includes an operation to determine the supply chain performance value in response to a comparison of the updated supply chain model and the physical supply chain execution parameters. In certain embodiments, the procedure includes an operation to perform a supply chain response action in response to the supply chain performance value. In certain embodiments, the procedure includes an operation to update the visual model in response to the supply chain response action. In certain embodiments, the procedure includes an operation to update the supply chain model in response to the supply chain response action. In certain embodiments, the procedure includes an operation to provide a model update notification to the build interface and/or to a user of a supply chain command platform.

An example procedure for modeling and/or operating a physical supply chain with a layered DT architecture includes an operation to implement a build interface, and to build a visual model in response to user operation on the build interface. The example procedure further includes an operation to determine a supply chain model in response to the visual model, and to operate the supply chain model as a layered DT of a physical supply chain, to interpret physical supply chain execution values, and to provide a notification to a user of a supply chain command platform in response to a comparison of the supply chain model and the physical supply chain execution values.

An example procedure for modeling a physical supply chain with a model using an object/link paradigm includes an operation to implement a build interface, and to build a visual model in response to user operations on the build interface. The example procedure further includes an operation to determine a supply chain model in response to the visual model, and to operate the supply chain model as a DT of the physical supply chain, where the DT includes a number of object interrelated by links. The example procedure includes an operation to interpret physical supply chain execution parameters, and to provide a notification to a user of a supply chain command platform in response to a comparison of the physical supply chain execution values and the supply chain model. In certain embodiments, the procedure includes an operation to expose a catalog of template objects to a user of the supply chain command platform. In certain embodiments, the procedure includes an operation to insert an object form the catalog into the visual model in response to operations of a user on the build interface. In certain embodiments, the procedure includes an operation to store an object from the visual model into the catalog of template objects.

An example procedure for utilizing a DT type selection for modeling a physical supply chain includes an operation to implement a build interface, and to build a visual model in response to user operations on the build interface. The example procedure includes an operation to determine a supply chain model in response to the visual model, and to operate the supply chain model as a number of DTs, each modeling at least a portion of the physical supply chain. The example procedure includes an operation to interpret physical supply chain execution values, and to provide a notification to a user of a supply chain command platform in response to a comparison of the supply chain model and the physical supply chain execution values.

An example procedure for integrating a live DT with real-time data and a responsive API to operate a physical supply chain includes an operation to implement a build interface, the build interface at least partially including an API, and to build a visual model in response to user operations on the build interface. The example procedure includes an operation to determine a supply chain model in response to the visual model, and to operate the supply chain model as a DT of at least a portion of the physical supply chain. The example procedure includes an operation to interpret physical supply chain execution values, and to provide a notification to the build interface in response to a comparison of the supply chain model and the physical supply chain execution values. In certain embodiments, the procedure includes an operation to determine an off-nominal event in response to the comparison. In certain embodiments, the procedure includes an operation to update the visual model and/or the supply chain model in response to the off-nominal event value. In certain embodiments, the procedure includes an operation to provide a notification to a user of a supply chain command platform in response to the off-nominal event value. In certain embodiments, the procedure includes an operation to determine a mitigation approval and/or mitigation confirmation in response to user operations on a runtime interface, and to update the visual model and/or the supply chain model in response to the mitigation approval and/or mitigation confirmation. In certain embodiments, the procedure includes an operation to implement a scenario builder on the runtime interface and to update the visual model in response to user operations on the scenario builder. In certain embodiments, the procedure includes an operation to update the supply chain model in response to the updated visual model, and to continue operations utilizing the updated supply chain model. In certain embodiments, the procedure includes an operation to provide scheduled access to a user to one or more functions on a supply chain command platform. Example functions of the supply chain command platform include one or more of: building a new visual model for a supply chain; utilizing a catalog to build or update a visual model or a new visual model; monitoring at least one physical supply chain execution value; monitoring a result of the comparison of the supply chain model and the physical supply chain execution values; building a scenario for the physical supply chain; exercising a scenario for the physical supply chain; building mitigation rules for the physical supply chain; approving the implementation of mitigation rules for the physical supply chain; updating the visual model; sharing any one or more of the foregoing with another user; or sharing a view of any one or more of the foregoing with another user. In certain embodiments, the procedure includes an operation to share a view with another user by sharing a version of a model, sharing a model at a particular zoom and/or location value, and/or sharing a model with some features hidden (e.g., attributes, entities, links, code aspects, etc.), sharing a model with some features having read-only access. In certain embodiments, the procedure includes an operation to share a report, a notification, an alert, a scenario, a mitigating activity rule, and/or a view of any one or more of the foregoing with another user on a supply chain command platform. In certain embodiments, the procedure includes an operation to provide scheduled access to a user in response to an identify of the user, an associated organization with the user, a role of the user, and/or permissions associated with the user. In certain embodiments, the procedure includes an operation to provide the scheduled access by including access to a view of the visual model.

The methods and systems described herein may be deployed in part or in whole through a machine having a computer, computing device, processor, circuit, component (e.g., supply chain model component), manager (e.g., interface manager), engine (e.g., graph engine, rules engine, etc.), service, and/or server that is configured and/or structured to perform one or more operations described throughout the present disclosure. Such devices may be embodied, at least in part, as devices configured to execute computer readable instructions, program codes, instructions, and/or includes hardware configured to functionally execute one or more operations of the methods and systems herein. In certain embodiments, such devices may include any hardware aspects such as processors, memory, network communication resources, I/O devices, display devices, sensors, actuators, hardware elements configured to respond to certain detected events, ambient conditions, and/or operating conditions to perform one or more operations of the device, logic circuits, or the like. Such devices are depicted in many examples in the present disclosure as a single device, but the devices may be distributed, in whole or part, across different hardware elements, and in certain embodiments the hardware embodying such devices may vary according to the operating condition (e.g., in some embodiments a portion of an interface manager may be installed on a user device during operations, where the location of the interface manager may depend upon which user and/or user device is engaging with the platform) and/or the operations being performed (e.g., operations to build a supply chain model may utilize a different arrangement of hardware elements for an interface manager than operations to monitor a physical supply chain).

The terms computer, computing device, processor, circuit, various components, manager, engine, service, and/or server, (“computing device”) as utilized herein, should be understood broadly. An example computing device includes a computer of any type, capable to access instructions stored in communication thereto such as upon a non-transient computer readable medium, whereupon the computer performs operations of the computing device upon executing the instructions. In certain embodiments, such instructions themselves comprise a computing device. Additionally or alternatively, a computing device may be a separate hardware device, one or more computing resources distributed across hardware devices, and/or may include such aspects as logical circuits, embedded circuits, sensors, actuators, input and/or output devices, network and/or communication resources, memory resources of any type, processing resources of any type, and/or hardware devices configured to be responsive to determined conditions to functionally execute one or more operations of systems and methods herein.

Network and/or communication resources include, without limitation, local area network, wide area network, wireless, internet, or any other known communication resources and protocols. Example and non-limiting hardware and/or computing devices include, without limitation, a general-purpose computer, a server, an embedded computer, a mobile device, a virtual machine, and/or an emulated computing device. A computing device may be a distributed resource included as an aspect of several devices, included as an interoperable set of resources to perform described functions of the computing device, such that the distributed resources function together to perform the operations of the computing device. In certain embodiments, each computing device may be on separate hardware, and/or one or more hardware devices may include aspects of more than one computing device, for example as separately executable instructions stored on the device, and/or as logically partitioned aspects of a set of executable instructions, with some aspects comprising a part of one of a first computing device, and some aspects comprising a part of another of the computing devices.

A computing device may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer readable instructions on a server, client, firewall, gateway, hub, router, or other such computer and/or networking hardware. The computer readable instructions may be associated with a server that may include a file server, print server, domain server, internet server, intranet server and other variants such as secondary server, host server, distributed server and the like. The server may include one or more of memories, processors, computer readable transitory and/or non-transitory media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, and the like. Additionally, this coupling and/or connection may facilitate remote execution of instructions across the network. The networking of some or all of these devices may facilitate parallel processing of program code, instructions, and/or programs at one or more locations without deviating from the scope of the disclosure. In addition, all the devices attached to the server through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods, program code, instructions, and/or programs may be associated with a client that may include a file client, print client, domain client, internet client, intranet client and other variants such as secondary client, host client, distributed client and the like. The client may include one or more of memories, processors, computer readable transitory and/or non-transitory media, storage media, ports (physical and virtual), communication devices, and interfaces capable of accessing other clients, servers, machines, and devices through a wired or a wireless medium, and the like. The methods, program code, instructions, and/or programs as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers, and the like. Additionally, this coupling and/or connection may facilitate remote execution of methods, program code, instructions, and/or programs across the network. The networking of some or all of these devices may facilitate parallel processing of methods, program code, instructions, and/or programs at one or more locations without deviating from the scope of the disclosure. In addition, all the devices attached to the client through an interface may include at least one storage medium capable of storing methods, program code, instructions, and/or programs. A central repository may provide program instructions to be executed on different devices. In this implementation, the remote repository may act as a storage medium for methods, program code, instructions, and/or programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules, and/or components as known in the art. The computing and/or non-computing device(s) associated with the network infrastructure may include, apart from other components, a storage medium such as flash memory, buffer, stack, RAM, ROM and the like. The methods, program code, instructions, and/or programs described herein and elsewhere may be executed by one or more of the network infrastructural elements.

The methods, program code, instructions, and/or programs described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like.

The methods, program code, instructions, and/or programs described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute methods, program code, instructions, and/or programs stored thereon. Alternatively, the mobile devices may be configured to execute instructions in collaboration with other devices. The mobile devices may communicate with base stations interfaced with servers and configured to execute methods, program code, instructions, and/or programs. The mobile devices may communicate on a peer-to-peer network, mesh network, or other communications network. The methods, program code, instructions, and/or programs may be stored on the storage medium associated with the server and executed by a computing device embedded within the server. The base station may include a computing device and a storage medium. The storage device may store methods, program code, instructions, and/or programs executed by the computing devices associated with the base station.

The methods, program code, instructions, and/or programs may be stored and/or accessed on machine readable transitory and/or non-transitory media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

Certain operations described herein include interpreting, receiving, and/or determining one or more values, parameters, inputs, data, or other information (“receiving data”). Operations to receive data include, without limitation: receiving data via a user input; receiving data over a network of any type; reading a data value from a memory location in communication with the receiving device; utilizing a default value as a received data value; estimating, calculating, or deriving a data value based on other information available to the receiving device; and/or updating any of these in response to a later received data value. In certain embodiments, a data value may be received by a first operation, and later updated by a second operation, as part of the receiving a data value. For example, when communications are down, intermittent, or interrupted, a first receiving operation may be performed, and when communications are restored an updated receiving operation may be performed.

Certain logical groupings of operations herein, for example methods or procedures of the current disclosure, are provided to illustrate aspects of the present disclosure. Operations described herein are schematically described and/or depicted, and operations may be combined, divided, re-ordered, added, or removed in a manner consistent with the disclosure herein. It is understood that the context of an operational description may require an ordering for one or more operations, and/or an order for one or more operations may be explicitly disclosed, but the order of operations should be understood broadly, where any equivalent grouping of operations to provide an equivalent outcome of operations is specifically contemplated herein. For example, if a value is used in one operational step, the determining of the value may be required before that operational step in certain contexts (e.g., where the time delay of data for an operation to achieve a certain effect is important), but may not be required before that operation step in other contexts (e.g. where usage of the value from a previous execution cycle of the operations would be sufficient for those purposes). Accordingly, in certain embodiments an order of operations and grouping of operations as described is explicitly contemplated herein, and in certain embodiments re-ordering, subdivision, and/or different grouping of operations is explicitly contemplated herein.

The methods and systems described herein may transform physical and/or or intangible items from one state to another. The methods and systems described herein may also transform data representing physical and/or intangible items from one state to another.

The methods and/or processes described above, and steps thereof, may be realized in hardware, program code, instructions, and/or programs or any combination of hardware and methods, program code, instructions, and/or programs suitable for a particular application. The hardware may include a dedicated computing device or specific computing device, a particular aspect or component of a specific computing device, and/or an arrangement of hardware components and/or logical circuits to perform one or more of the operations of a method and/or system. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and computer readable instructions, or any other machine capable of executing program instructions.

Thus, in one aspect, each method described above, and combinations thereof, may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or computer readable instructions described above. All such permutations and combinations are intended to fall within the scope of the present disclosure.

1. A system, comprising:
a supply chain command platform, comprising:
an interface manager configured to implement a build interface, and to build a visual model in response to user operations on the build interface;
a supply chain model creation component configured to determine a supply chain model in response to the visual model; and
a supply chain model execution component configured to operate the supply chain model as a digital twin of at least a portion of a physical supply chain, to interpret at least one physical supply chain execution value, and to provide a notification to a user of the supply chain command platform in response to a comparison of the supply chain model and the at least one physical supply chain execution value.

2. The system of claim 1, wherein the supply chain model creation component is further configured to determine the supply chain model in response to a plurality of linked entities representing the at least a portion of the physical supply chain, wherein each one of the plurality of linked entities comprises a behavior value, and wherein links between the entities each comprise a relationship value.

3. The system of claim 2, wherein the behavior value for at least one of the linked entities comprises at least one behavior value selected from: a physical model, a logical model, a data provision value, or a data collection value.

4. The system of claim 2, wherein the behavior value for at least one of the linked entities comprises at least one behavior value selected from: an event detection value, an event response value, a notification value, an alert value, or a reporting value.

5. The system of claim 2, wherein at least one of the plurality of linked entities comprises a coded modeling element.

6. The system of claim 2, wherein at least one of the plurality of linked entities comprises a low coding element.

7. The system of claim 1, wherein the interface manager is further configured to provide a catalog of pre-configured elements to the build interface, and to insert at least one of the pre-configured elements into the visual model in response to the user operations on the build interface.

8. The system of claim 7, wherein the interface manager is further configured to insert the at least one of the pre-configured elements into the visual model in response to a drag-and-drop operation.

9. The system of claim 7, wherein the interface manager is further configured to insert the at least one of the pre-configured elements into the visual model in response to a menu selection operation.

10. The system of claim 7, wherein at least one of the pre-configured elements comprises a coded modeling element.

11. The system of claim 7, wherein at least one of the pre-configured elements comprises a low coding modeling element.

12. The system of claim 7, wherein at least one of the pre-configured elements comprises a black box modeling element.

13. The system of claim 7, wherein the supply chain model creation component is further configured to determine the supply chain model in response to a plurality of linked entities representing the at least a portion of the physical supply chain, wherein at least one of the pre-configured elements comprises an entity, and wherein the supply chain model creation component is further configured to insert the entity into the visual model in response to the user operations comprising selecting the entity.

14. The system of claim 7, wherein the supply chain model creation component is further configured to determine the supply chain model in response to a plurality of linked entities representing the at least a portion of the physical supply chain, wherein at least one of the pre-configured elements comprises a relationship value, and wherein the supply chain model creation component is further configured to insert the relationship value into the visual model in response to the user operations comprising selecting the relationship value and a relationship position.

15. The system of claim 7, wherein the supply chain model creation component is further configured to determine the supply chain model in response to a plurality of linked entities representing the at least a portion of the physical supply chain, wherein at least one of the pre-configured elements comprises a behavior value, and wherein the supply chain model creation component is further configured to associate the behavior value with at least one of the plurality of linked entities in response to the user operations comprising selecting the behavior value and at least one of the plurality of linked entities.

16. The system of claim 1, wherein the supply chain model creation component is further configured to store a model element of the visual model to a catalog of pre-configured elements in response to the user operations.

17. The system of claim 16, wherein the stored model element comprises at least one of: an entity, a behavior value, or a relationship value.

18. The system of claim 17, wherein the supply chain model creation component is further configured to store the model element in a storage scheme comprising one of: a coded modeling element, a low coding modeling element, or a black box modeling element.

19. The system of claim 18, wherein the supply chain model creation component is further configured to select the storage scheme in response to the user operations.

20. The system of claim 19, wherein the supply chain model creation component is further configured to select the storage scheme further in response to an authorization value associated with a user performing the user operations.

21-98. (canceled)
